(19) United States
(12) Patent Application Publication
(10) Pub. No.: US 2012/0239706 A1
(43) Pub. Date: Sep. 20, 2012

(54) COMPUTER-FACILITATED PARALLEL INFORMATION ALIGNMENT AND ANALYSIS

(75) Inventor: Shannon I. Steinfadt, Los Alamos, NM (US)

(73) Assignee: Los Alamos National Security, LLC, Los Alamos, NM (US)

(21) Appl. No.: 13/423,085

(22) Filed: Mar. 16, 2012

Related U.S. Application Data
(60) Provisional application No. 61/454,466, filed on Mar. 18, 2011.

(51) Int. Cl. G06F 7/00; G06F 17/30

(52) U.S. Cl. 707/803; 707/E17.044

(57) ABSTRACT

Described herein, Smith-Waterman using Associative Massive Parallelism (SWAMP) extends the single, highest scoring subsequence alignment the traditional Smith-Waterman algorithm and variations return to discover the top k highest scoring non-overlapping, non-intersecting subalignments in parallel. Embodiments provided herein provide synergistic work, accelerating the high quality of alignments, in addition to providing multiple subsequence discovery that is handled in an automated fashion within the algorithm. SWAMP and SWAMP+ (and related algorithms such as are described herein) are parallel algorithms that are designed to run in an accelerated manner, inter alia, on single-instruction, multiple-data (SIMD) machines. Not only is the alignment/matching process accelerated for the single, highest matching alignment, in embodiments the algorithm can analyze deeper into the sequences for additional high-quality alignments. Envisioned uses include bioinformatics, for instance for nucleic acid or amino acid sequence alignments, as well as alignments of other data strings or other packets or lines of information.

### CROSS REFERENCE TO RELATED APPLICATIONS

This application claims priority to and the benefit of U.S. Patent Application No. 61/454,466, filed on Mar. 18, 2011, which is incorporated herein by reference.

### ACKNOWLEDGMENT OF GOVERNMENT SUPPORT

The United States government has rights in this invention pursuant to Contract No. DE-AC52-06NA25396 between the United States Department of Energy and Los Alamos National Security, LLC for the operation of Los Alamos National Laboratory.

### FIELD

The technologies disclosed herein relate to data searching, and more particularly in certain embodiments, to database searches, data comparisons, and alignments, in particular to genetic sequence database searching and nucleic acid and amino acid alignments.

### COMPUTER PROGRAM LISTINGS

This application includes computer program listings submitted electronically via the United States Patent and Trademark Office's electronic filing system (EFS-Web) as ASCII text files. The submitted computer program listings listed below are hereby incorporated herein by reference.

| Name | Date of Creation | Size |
|---|---|---|
| swamp_asc.txt | Mar. 13, 2012 | 3 KB |
| swamp_vars_h.txt | Mar. 13, 2012 | 3 KB |
| extract_parameters_asc.txt | Mar. 13, 2012 | 2 KB |
| check_size_asc.txt | Mar. 13, 2012 | 2 KB |
| onit_arrays_asc.txt | Mar. 13, 2012 | 3 KB |
| casb_matrix_calc_asc.txt | Mar. 13, 2012 | 3 KB |
| print_array_cols_asc.txt | Mar. 13, 2012 | 1 KB |
| print_PE_vals_asc.txt | Mar. 13, 2012 | 1 KB |
| asc_h.txt | Mar. 13, 2012 | 12 KB |
| swamp_h.txt | Mar. 13, 2012 | 1 KB |
| swampm2m_cn.txt | Mar. 13, 2012 | 13 KB |

The computer program listings appendix ASC code listings for implementation of the SWAMP and SWAMP+ algorithms. The associative ASC code implementing the SWAMP algorithm consists of multiple files, one for each function that is defined, according to the ASC emulator requirements. The following ASC files are linked into program “swamp.asc”: “swamp_vars.h” (local variables), “extract_parameters.asc” (convert parallel input values into scalar variables), “check_size.asc” (swap the sequences, if necessary), “initialize_arrays.asc” (distribute S2 to each PE), “casb_matrix_calc.asc” (computation of staggered matrix), “print_array_cols.asc” (print matrix columns) and “print_PE_vals.asc” (print matrix values).

The associate ASC code implementing the SWAMP+ algorithm consists of ASC code for an implementation of the SWAMP+ algorithm on the ClearSpeed CSX 620 hardware in the Cⁿ language. The ClearSpeed SWAMP+ code comprises the following files: “swamp.h” (header file for ClearSpeed implementation of SWAMP+), “swampm2m.c” (multiple-to-multiple local alignment of sequences), and “asc.h” (ASC library). The “swamp_asc.txt” and “swamp_h.txt” files refer to the other files without the “.txt” suffix and with the “_asc” or “_h” characters used as the suffix instead (e.g., “.asc” and “.h”).

### BACKGROUND

Living organisms are essentially made of proteins. Proteins and nucleic acids (DNA and RNA) are the main components of the biochemical processes of life. DNA's primary purpose is to encode to the information needed for the building of proteins. In humans, nearly everything is composed of or due to the action of proteins. Fifty to sixty percent of the dry mass of a cell is protein. The importance of proteins, and their underlying genetic encoding in DNA, underscores the significance of their study.

To study gene function and regulation, nucleic acids or their corresponding proteins are sequenced. One of several techniques, such as shotgun sequencing, sequencing by hybridization, or gel electrophoresis is used to read the strand (Guinand, ISThmus 2000 Conference on Research and Development for the Information Society, Poznan, Poland, 2000). Once the target protein/DNA/RNA is reassembled, the string can be used for analysis. One type of analysis is sequence alignment. It compares the new query string to already known and recorded sequences (Id.). Comparing (aligning) sequences is an attempt to determine common ancestry or common functionality (D'Antonio, Proceedings of the 8th annual conference on Innovation and Technology in Computer Science Education, 35(3):211-214, 2003). This analysis uses the fact that evolution is a conservative process (Nicholas et al., “Sequence Analysis Tutorials: A Tutorial on Searching Sequence Databases and Sequence Scoring Methods,” Pittsburg Supercomputing Center (1998)). As Crick stated, “once ‘information’ has passed into a protein it cannot get out again” (Waterman, Introduction to Computational Biology. Boca Raton, Fla.: Chapman and Hall/CRC Press, 1995).

This is a powerful tool, making sequence alignment the most common operation used in computational molecular biology (Guinand, ISThmus 2000 Conference on Research and Development for the Information Society, Poznan, Poland, 2000).

Now that much of the actual process of sequencing is automated (i.e. the gene chips in microarrays), a huge amount of quantitative information is being generated. As a result, the gene and protein databases such as GenBank and Swiss-Prot are nearly doubling in size each year. New databases of sequences are growing as well. In order to use sequence alignment as a sorting tool and obtain qualitative results from the exponentially growing databases, it is more important than ever to have effective, efficient sequence alignment analysis algorithms.

There have many efforts to develop techniques in high performance architectures, especially in newly emerging many-core architectures. These include Intel's SIMD instruction sets (Wozniak, Comput Appl in the Biosciences (CABIOS),13(2):145-150, 1997; Farrar, Bioinformatics, 23:156-161, 2007), Cell/BEs (Rudnicki et al., Fundamenta Informaticae, 96:181-194, 2009; Aji et al., Proceedings of the 5th conference on Computing frontiers Ischia, Italy: ACM, 2008, pp. 13-22; Farrar 2008; Rognes and Seberg, Bioinformatics, 16:699-706, 2000; Sachdeva et al., in In Proc. of the 6th IEEE International Workshop on High Performance Computational Biology, 2007; Szalkowski et al., Research Notes, 1: 107, 2008), GPUs (Manayski and Valle, BMC Bioinformatics, 9(Suppl 2): S10, 2008; Jung, BMC Bioinformatics 10(Suppl 7):A3, 2009; Ligowski and Rudnicki, in Proceedings of the 2009 IEEE International Symposium on Parallel Distributed Processing: IEEE Computer Society, pp. 1-8, 2009; Liu et al., BMC Research Notes, 2:73, 2009; Liu et al., BMC Research Notes, 3:93, 2010; Ligowski, et al., GPU Computing Gems, Emerald Edition, Morgan Kaufmann, pp. 155-157, 2011), and FPGA's (Li et al., BMC Bioinformatics, 8:185, 2007; Nawaz et al., Field-Programmable Technology (FPT), Beijing, pp. 454-459, 2010). The focus of most of this body of parallel work is to obtain a high cell updates per second (CUPS) value, a measure of the throughput. Throughput is important when scanning the fast growing, large sequence databases. There have been many clever optimizations, from striping computations with a given stride and “lazy-F loop” evaluation (Farrar, 2008) to further architecture specific optimization, for instance by Rudnicki et al. for the Cell/BE (Fundamenta Informaticae, 96:181-194, 2009).

### SUMMARY

Many of the parallel algorithms cited above only return the maximum score computed by Smith-Waterman technique. If above a certain threshold, that sequence or set of sequences with a high score are marked and a full (often sequential) Smith-Waterman alignment is run which includes the actual traceback and the best (i.e. highest scoring) alignment of the two sequences is determined. This is one place where the SWAMP+ approach is useful. The SWAMP+ approach maintains the full sensitivity of Smith-Waterman.

Thus, provided herein are methods, implemented at least in part by a computing system, which involve (but are not limited to) receiving sequences S1 and S2, respective of the sequences representing an information sequence comprising a string of at least two characters; initializing in parallel memory a 2-D matrix wherein respective of the columns in the matrix stores characters corresponding to an anti-diagonal of a S-W matrix formed from sequences S1 and S2; computing in parallel D, I, and C for the S-W matrix values of the 2-D matrix; conducting traceback in the resultant 2-D matrix from a highest computed value, to produce a first alignment between characters in sequences S1 and S2; masking out the characters in the traceback; and repeating at least the computing and conducting traceback steps at least one time, to produce at least one additional alignment between S1 and S2 that does not overlap or intersect with the first alignment. In various embodiments, the sequences S1 and S2 are nucleic acid sequences or amino acid sequences; however, in other embodiments they are sequences of other characters, such as letters (that are not necessarily intended to represent nucleic acids or amino acids), numbers, words, symbols, and so forth.

Other methods provided herein, implemented at least in part by a computing system, include computing in parallel deletion values (D values), insertion values (I values), and match values (C values) for a 2-D matrix stored in a parallel memory of the computing system, respective of the columns in the 2-D matrix storing characters corresponding to an anti-diagonal of a Smith-Waterman (S-W) matrix formed from sequences S1 and S2, respective of the sequences S1 and S2 representing information sequences comprising strings of at least two characters; conducting a traceback of the 2-D matrix starting from a highest computed C value, to produce a first alignment between characters in the sequences S1 and S2; masking out one or more characters in the sequences S1 and S2 based on the first alignment; and repeating the computing and the conducting a traceback at least one time, to produce at least one additional alignment between the sequences S1 and S2, the first alignment and the at least one additional alignment being non-overlapping, non-intersecting alignments.

Still other methods provided herein, implemented at least in part by a computing system, include: initializing in a parallel memory of the computing system a 2-D matrix wherein respective of the columns in the 2-D matrix store characters corresponding to an anti-diagonal of a Smith-Waterman (S-W) matrix formed from sequences S1 and S2 representing information sequences comprising a string of at least two characters, the initializing comprising shifting, in parallel, data from a copy of the S2 sequence stored in the parallel memory to columns of the 2-D matrix such that the columns store anti-diagonals of the S-W matrix, the contents of the copy of the S2 sequence being shifted between shiftings of the copy of the S2 sequence into the columns of the 2-D matrix; computing in parallel deletion values (D values), insertion values (I values), and match values (C values) for the 2-D matrix; and conducting a traceback analysis of the 2-D matrix starting from a highest computed C value, to produce an alignment between characters in the sequences S1 and S2.

Optionally, the results of any of the methods provided herein can be output (e.g., displayed on a screen or other readout, or printed, or provided in another visual or audible format, either directly or indirectly) and stored on computer-readable storage media. In some examples, a result of at least one of the first alignment and the at least one additional alignment makes up at least a portion of the output.

Also provided are one or more computer-readable storage media storing computer program instructions for causing a computer system programmed thereby to perform a method described or illustrated herein.

Yet a further embodiment provides a system, such as a computer system, comprising (but not limited to) a processor; and one or more storage media storing instructions for causing the processor to perform a method as described or illustrated herein.

Also provided is a system (such as a computer system) comprising (but not limited to) a plurality of PEs (processing elements); and a memory containing instructions for causing the system to perform a method as described or illustrated herein. For instance, in some instances the computing is performed by the plurality of PEs. Optionally, such plurality of PEs is in a single physical component/piece of hardware. In other examples of such embodiment, the PEs are in two or more physical components within a single computing device; and such plurality of PEs in some embodiments are located in multiple computing devices in communication with each other.

Further provided is a computer system comprising a plurality of processing elements (PEs) respective of the processing elements having local memory, the local memories collectively defining a parallel memory; a PE interconnection network connecting the plurality of processing elements; one or more computer-readable storing media storing instruction for causing the computer system to execute a method, the method comprising: initializing in the parallel memory a 2-D matrix wherein respective of the columns in the 2-D matrix stores characters corresponding to an anti-diagonal of a Smith-Waterman (S-W) matrix formed from sequences S1 and S2, respective of the sequences S1 and S2 representing information sequences comprising strings of at least two characters; using the plurality of PEs, computing in parallel deletion values (D values), insertion values (I values), and match values (C values) for the 2-D matrix; conducting a traceback of the 2-D matrix from a highest computed C value, to produce a first alignment between characters in the sequences S1 and S2; masking out characters in the sequences S1 and S2 based on the first alignment; repeating the initializing, the computing and the conducting traceback at least one time, to produce at least one additional alignment between sequences S1 and S2 that does not overlap or intersect with the first alignment; and masking out the characters of the sequences S1 and S2 included in additional subsequent alignments to the one or more excluded characters prior to repeating the computing and the conducting a traceback.

Described herein is also a method implemented at least in part by a computing system, the method comprising: computing in parallel deletion values (D values), insertion values (I values) and match values (C values) for a plurality of blocks of a 2-D matrix storing characters corresponding to portions of anti-diagonal of a Smith-Waterman (S-W) matrix formed from sequences S1 and S2, respective of the sequences S1 and S2 representing information sequences comprising strings of at least two characters; wherein the blocks are arranged in a 2-D block matrix; wherein the computing in parallel is performed by one or more processing cores of a computing system, the processing cores arranged logically adjacent to one another in a left-to-right manner; wherein respective of the processing cores are configured to compute in parallel the D, I and C values for one block at a time, and, upon completing the computing for one of the blocks, passing the computed D, I and C values for the upper-most column of the block processed by the respective core to the processor to the respective processor's logical right for use in processing the lowest column in the block stored in the processor to the respective processor's logical right, and using the computed values in the lowest row of the respective core for processing its upper row when processing the next block; wherein respective of the blocks successively process blocks belonging to a column of the 2-D matrix in a top-to-bottom manner; and wherein the blocks are processed one anti-diagonal of the 2-D block matrix at a time in order from the upper left to the lower right of the 2-D block matrix, the blocks belonging to an anti-diagonal of the 2-D block matrix being processed simultaneously by the one or more processing cores; and conducting a traceback analysis of the 2-D matrix starting from a highest computed C value, to produce a first alignment between characters in the sequences S1 and S2.

Also included is a parallel computer system comprising: a means for computing in parallel deletion values (D values), insertion values (I values), and match values (C values) for a 2-D matrix stored in a parallel memory of the computing system, respective of the columns in the 2-D matrix storing characters corresponding to an anti-diagonal of a Smith-Waterman (S-W) matrix formed from sequences S1 and S2, respective of the sequences S1 and S2 representing information sequences comprising strings of at least two characters; a means for conducting a traceback of the 2-D matrix starting from a highest computed C value, to produce a first alignment between characters in the sequences S1 and S2; a means for masking out one or more characters in the sequences S1 and S2 based on the first alignment; and a means for repeating the computing and the conducting a traceback at least one time, to produce at least one additional alignment between the sequences S1 and S2, the first alignment and the at least one additional alignment being non-overlapping, non-intersecting alignments.

In various embodiments, the computing is performed by a GPU, the GPU operating as an emulator for the plurality of PEs. In various embodiments, the computing is carried out in lockstep manner.

As described herein, a variety of other features and advantages can be incorporated into the technologies as desired.

The foregoing and other objects, features, and advantages of the disclosed technologies will become more apparent from the following detailed description, which proceeds with reference to the accompanying figures.

### BRIEF DESCRIPTION OF THE DRAWINGS

FIG. 1 illustrates an example of the sequential Smith-Waterman matrix. The dependencies of cell (3, 2) are shown with arrows. While the calculated C values for the entire matrix are given, the shaded anti-diagonal (where all i+j values are equal) shows one wavefront or logical parallel act since they can be computed concurrently. Affine gap penalties are used in this example as well as in the parallel code that produces the top alignment and other top scoring alignments.

FIG. 2 illustrates a Smith-Waterman matrix with traceback and resulting alignment.

FIG. 3 is a high-level view of a representative ASC model of parallel computation.

FIG. 4 illustrates mapping the “shifted” data on to the ASC model. An S2[$] column stores one full anti-diagonal from the original matrix. The number of PEs (processing units)>m and the unused (idle) PEs are grayed out. If the number of PEs<m, the PEs are virtualized and one PE will process [m/# PEs] worth of work. The PE Interconnection Network is omitted from the illustration for simplicity.

FIG. 5 shows (i+j=4) an iteration of the m+n loop to shift S2. This loop stores anti-diagonals in single variables of the ASC array S2[$] so that they can be processed in parallel.

FIG. 6 is a graph illustrating reduction in the number of operations through further parallelization of the SWAMP algorithm.

FIG. 7 is a graph illustrating actual and predicted performance measurements using ASCs performance monitor. Predictions were obtained using linear regression and the least squares method and are shown with a dashed line.

FIG. 8 graphically illustrates SWAMP+ variations where three alignments are produced in both a) and b) and two alignments are produced in c).

FIG. 9 shows a detail of one streaming multiprocessor (SM). On CUDA-enabled NVIDIA hardware, a varied number of SMs exist for massively parallel processing. Each SM contains eight streaming processor (SP) cores, two special function units (SFUs), instruction and constant caches, a multithreaded instruction unit, and a shared memory. One example organization is the NVIDIA Tesla T10 with 30 SMs for a total of 240 SPs.

FIG. 10 is a photograph of the CSX 620 PCI-X Accelerator Board.

FIG. 11 is a schematic diagram illustrating the ClearSpeed CSX processor organization.

FIG. 12 is a graph illustrating an average number of calculation cycles over 30 runs using SWAMP+ on a ClearSpeed CSX processor. The graph is broken down into each subalignment. There were eight outliers in over 4500 runs; each was an order of magnitude larger than the cycle counts for the rest of the runs. That is what pulled the calculation cycle count averages up, as seen in the graph. It does show that the number of parallel computations is roughly the same, regardless of sequence size. Lower is better.

FIG. 13 is a graph illustrating average cycle counts using SWAMP+ on a ClearSpeed CSX processor, with the top eight outliers removed. The error bars show the computation cycle counts in the same order of magnitude as the rest of the readings.

FIG. 14 is a graph illustrating Cell Updates Per Second (CUPS) for matrix computation on a ClearSpeed CSX processor; higher is better.

FIG. 15 is a graph illustrating the average number of traceback cycles over 30 runs using SWAMP+ on a ClearSpeed CSX processor. The longest alignment is the first alignment. Therefore, the first traceback in all runs with 1 to 5 alignments returned has a higher cycle count than any of the subsequent alignments.

FIG. 16 is a graph comparing number of cycle counts for computation and traceback on a ClearSpeed CSX processor.

FIG. 17 illustrates that across multiple node's main memory, JumboMem allows an entire cluster's memory to look like local memory with no additional hardware, no recompilation, and no root account access.

FIG. 18 is a graph illustrating that Cell Updates Per Second (CUPS) running the SWAMP algorithm using JumboMem does experience some performance degradation, but not as much as if it had to page to disk.

FIG. 19 is a graph illustrating that the execution time grows consistently even as JumboMem begins to use other nodes' memory. Note the logarithmic scales, since as input string size doubles, the calculations and memory requirements quadruple

FIG. 20 illustrates a wavefront of wavefronts approach used in some of the described embodiments, merging a hierarchy of parallelism, first within a single core, and then across multiple cores.

FIG. 21 illustrates a generalized example of a first exemplary computing environment in which the described techniques can be implemented. Instead of a single processor or CPU, there are many processing elements (PEs —2110A-N) that perform the same arithmetic and logic operations of a CPU in parallel. Respective of the PE has its own memory (2120A-N).

FIG. 22 is a conceptual view of a second exemplary parallel computing environment 2200 comprising a serial computing environment 2205 and a parallel computing environment 2280.

FIG. 23 is a flow chart of a first exemplary method of aligning sequences according to the SWAMP+ algorithm.

FIG. 24 is a flow chart of an exemplary embodiment of aligning sequences to produce a single alignment using the SWAMP algorithm.

FIG. 25 is a flow chart illustrating a second method of aligning sequences according to the SWAMP+ algorithm.

FIG. 26 is a flow chart illustrating an exemplary method of aligning sequences with parallel initialization of a parallel memory.

### DETAILED DESCRIPTION

This disclosure addresses one of the most often used tools in bioinformatics, sequence alignment. The increasing growth and complexity of high-performance computing as well as the stellar data growth in the bioinformatics field are motivating factors. An associative algorithm for performing quality sequence alignments more efficiently and faster is disclosed. SWAMP+ or the extended Smith-Waterman using Associative Massive Parallelism as described herein is a suite of parallel algorithms designed and implemented for the ASC associative SIMD computing model. The theoretical parallel speedup for the algorithm is optimal, and can reduce the compute time for a single pairwise alignment of nucleic acids from O(mn) to O(m+n), where m and n are a length of the input sequences. When m=n, the running time becomes O(n) with a very small constant.

Described herein is the Smith-Waterman using Associative Massive Parallelism (SWAMP) algorithm, which extends the single, highest scoring subsequence alignment the traditional Smith-Waterman algorithm and variations return to discover the top k highest scoring non-overlapping, non-intersecting subalignments in parallel with a compute time equivalent to O(m+n)*k where m and n are the length of the sequences being aligned.

Using the capabilities of ASC, innovative new algorithms that are extensions of the SWAMP algorithm increase the information returned by the alignment algorithms without decreasing the accuracy of those alignments. Known as SWAMP+, these algorithms provide a parallelized approach extending traditional pairwise sequence alignment. They are useful for in-depth exploration of sequences, including research in expressed sequence tags, regulatory regions, and evolutionary relationships.

Although the SWAMP suite of algorithms was designed for the associative computing platform, they have been implemented herein on the ClearSpeed CSX 620 parallel SIMD accelerator to obtain realistic metrics. The performance for the compute intensive matrix calculation displayed a speedup of roughly 96 using ClearSpeed's 96 processing elements, thus verifying the possibility of achieving the theoretical speedup mentioned above.

### Section 1

### Overview of Several Embodiments

Provided herein in a first embodiment is a method, implemented at least in part by a computing system, the method comprising: computing in parallel deletion values (D values), insertion values (I values), and match values (C values) for a 2-D matrix stored in a parallel memory of the computing system, respective of the columns in the 2-D matrix storing characters corresponding to an anti-diagonal of a Smith-Waterman (S-W) matrix formed from sequences S1 and S2, respective of the sequences S1 and S2 representing information sequences comprising strings of at least two characters; conducting a traceback of the 2-D matrix starting from a highest computed C value, to produce a first alignment between characters in the sequences S1 and S2; masking out one or more characters in the sequences S1 and S2 based on the first alignment; and repeating the computing and the conducting a traceback at least one time, to produce at least one additional alignment between the sequences S1 and S2, the first alignment and the at least one additional alignment being non-overlapping, non-intersecting alignments.

In various embodiments, the method further comprises initializing the parallel memory with the 2-D matrix, the initializing comprising shifting in parallel, data from a copy of the S2 sequence stored in the parallel memory to a column of the 2-D matrix such that the column stores an anti-diagonal of the S-W matrix. The initializing can further comprise performing the shifting for one or more columns of the 2-D matrix, the contents of the copy of the S2 sequence stored in the parallel memory being shifted between shiftings of the copy of the S2 sequence into columns of the 2-D matrix.

In some embodiments, the masking out one or more characters comprises resetting all characters in the S1 and S2 sequences included in the first alignment to one or more excluded characters. The one or more excluded characters can be “Z,” “O” or both. In various embodiments, the method can further comprise masking out the one or more characters of the sequences S1 and S2 included in additional alignments to one or more excluded characters prior to repeating the computing and the conducting a traceback.

In still other embodiments, the conducting a traceback comprises marking characters of the sequences S1 and S2 as characters to be masked. In various embodiments, the at least one additional alignments comprises k or fewer alignments, wherein k is a subsequent alignment count, a highest computed C value in respective of the at least one alignments being not less than a highest computed C value from the first alignment multiplied by a maximum degradation factor.

In yet other embodiments, the method further comprises, for respective of one or more alignments of the first alignment and the at least one additional alignments: computing in parallel the D, I and C values for the 2-D matrix, wherein the 2-D matrix has been reinitialized such that respective of the columns of the 2-D matrix store characters corresponding to an anti-diagonal of the Smith-Waterman (S-W) matrix, but with the characters of the sequences S1 and S2 associated with the respective alignment reset to one or more excluded characters; conducting a traceback of the 2-D matrix starting from a highest computed C value, to produce a first subsequent alignment between characters in the sequences S1 and S2; masking out the characters in the S2 sequence based on the first subsequent alignment; and repeating the computing and the conducting a traceback at least one time to produce at least one additional subsequent alignment between sequences S1 and S2, the first subsequent alignment and the at least one additional subsequent alignments being non-overlapping, non-intersecting alignments. The method can further comprise masking out the characters of the sequences S1 and S2 included in additional subsequent alignments to one or more excluded characters prior to repeating the computing and the conducting a traceback.

In some embodiments, the computing in parallel is carried out simultaneously in a plurality of processing elements (PEs), respective of the PEs corresponding to one row in the 2-D matrix. The PEs can be components of a Single Instruction, Multiple Data (SIMD) computing system or an emulation thereof comprising an associative search function, a maximum/minimum search function and a responder selection/detection function, and a PE interconnect network.

In various embodiments, the D values, the I values, and the C values for the 2-D matrix are calculated using Equations 1-4 described herein. In some embodiments, the computing in parallel is carried out simultaneously in a plurality of separate processing elements (PEs), respective of the PEs corresponding to one row in the 2-D matrix.

In yet other embodiments, the computing in parallel the D, I and C values comprises computing in parallel the D, I and C values for a column of the 2-D matrix at least in part on the D, I and C values previously computed in parallel for one or more other columns of the 2-D matrix, and the columns of the 2-D matrix being processed sequentially.

In some embodiments, the method can further comprise storing a result of at least one of the first alignment and the at least one additional alignment on one or more computer-readable media, or outputting a result of at least one of the first alignment and the at least one additional alignment at an output device of the computing system.

Also provided is one or more computer-readable storage media storing computer-executable instructions for causing a computer system to perform the method of claim 1.

Provided herein in a second embodiment is a method, implemented at least in part by a computing system, the method comprising: initializing in a parallel memory of the computing system a 2-D matrix wherein respective of the columns in the 2-D matrix store characters corresponding to an anti-diagonal of a Smith-Waterman (S-W) matrix formed from sequences S1 and S2 representing information sequences comprising a string of at least two characters, the initializing comprising shifting, in parallel, data from a copy of the S2 sequence stored in the parallel memory to columns of the 2-D matrix such that the columns store anti-diagonals of the S-W matrix, the contents of the copy of the S2 sequence being shifted between shiftings of the copy of the S2 sequence into the columns of the 2-D matrix; computing in parallel deletion values (D values), insertion values (I values), and match values (C values) for the 2-D matrix; and conducting a traceback analysis of the 2-D matrix starting from a highest computed C value, to produce an alignment between characters in the sequences S1 and S2.

In some embodiments, upon completion of the initializing, the 2-D matrix stores m+n+1 anti-diagonals of the S-W matrix, wherein m and n are the number of characters in the S1 and S2 sequences, respectively, and the anti-diagonals are arranged in the 2-D matrix in an order that the anti-diagonals are arranged in the S-W matrix, from the upper left of the S-W matrix to the lower right of the 2-D matrix.

Provided herein in a third embodiment is a method, implemented at least in part by a computing system, the method comprising: computing in parallel deletion values (D values), insertion values (I values) and match values (C values) for a plurality of blocks of a 2-D matrix storing characters corresponding to portions of anti-diagonal of a Smith-Waterman (S-W) matrix formed from sequences S1 and S2, respective of the sequences S1 and S2 representing information sequences comprising strings of at least two characters; wherein the blocks are arranged in a 2-D block matrix; wherein the computing in parallel is performed by one or more processing cores of a computing system, the processing cores arranged logically adjacent to one another in a left-to-right manner; wherein respective of the processing cores are configured to compute in parallel the D, I and C values for one block at a time, and, upon completing the computing for one of the blocks, passing the computed D, I and C values for the upper-most column of the respective core to the processor to the respective processor's logical right for use as seed values, and using the computed values in the lowest row of the respective core as seed values for processing its upper row when processing the next block; wherein respective of the blocks successively process blocks belonging to a column of the 2-D matrix in a top-to-bottom manner; and wherein the blocks are processed one anti-diagonal of the 2-D block matrix at a time in order from the upper left to the lower right of the 2-D block matrix, the blocks belonging to an anti-diagonal of the 2-D block matrix being processed simultaneously by the one or more processing cores; and conducting a traceback analysis of the 2-D matrix starting from a highest computed C value, to produce a first alignment between characters in the sequences S1 and S2.

Also provided herein is a first computer system comprising: a plurality of processing elements (PEs) respective of the plurality of processing elements having local memory, the local memories collectively defining a parallel memory; a PE interconnection network connecting the plurality of processing elements; one or more computer-readable storage media storing instruction for causing the computer system to execute a method, the method comprising: initializing in the parallel memory a 2-D matrix wherein respective of the columns in the 2-D matrix stores characters corresponding to an anti-diagonal of a Smith-Waterman (S-W) matrix formed from sequences S1 and S2, respective of the sequences S1 and S2 representing information sequences comprising strings of at least two characters; using the plurality of PEs, computing in parallel deletion values (D values), insertion values (I values), and match values (C values) for the 2-D matrix; conducting a traceback of the 2-D matrix from a highest computed C value, to produce a first alignment between characters in the sequences S1 and S2; masking out characters in the sequences S1 and S2 based on the first alignment; repeating the initializing, the computing and the conducting traceback at least one time, to produce at least one additional alignment between sequences S1 and S2 that does not overlap or intersect with the first alignment; and masking out the characters of the sequences S1 and S2 included in additional subsequent alignments to one or more excluded characters prior to repeating the computing and the conducting a traceback.

Also provided herein is a second computing system comprising: a means for computing in parallel deletion values (D values), insertion values (I values), and match values (C values) for a 2-D matrix stored in a parallel memory of the computing system, respective of the columns in the 2-D matrix storing characters corresponding to an anti-diagonal of a Smith-Waterman (S-W) matrix formed from sequences S1 and S2, respective of the sequences S1 and S2 representing information sequences comprising strings of at least two characters; a means for conducting a traceback of the 2-D matrix starting from a highest computed C value, to produce a first alignment between characters in the sequences S1 and S2; a means for masking out one or more characters in the sequences S1 and S2 based on the first alignment; and a means for repeating the computing and the conducting a traceback at least one time, to produce at least one additional alignment between the sequences S1 and S2, the first alignment and the at least one additional alignment being non-overlapping, non-intersecting alignments.

### Overview of Several Additional Embodiments

Provided herein in a first additional embodiment is a method, implemented at least in part by a computing system, the method comprising: receiving sequences S1 and S2, each representing an information sequence comprising a string of at least two characters; initializing in parallel memory a 2-D matrix wherein each column in the matrix stores characters corresponding to an anti-diagonal of a S-W matrix formed from sequences S1 and S2; computing in parallel D, I, and C for the S-W matrix values of the 2-D matrix; conducting traceback in the resultant 2-D matrix from the highest computed value, to produce a first alignment between characters in sequences S1 and S2; masking out the characters in the traceback; and repeating at least the computing and conducting traceback steps at least one time, to produce at least one additional alignment between S1 and S2 that does not overlap or intersect with the first alignment.

In various additional embodiments, initializing in parallel memory the 2-D matrix comprises shifting data within parallel memory so that S-W matrix anti-diagonals are translated into columns in the 2-D matrix.

Masking out can be carried out using various techniques. In some examples, masking out comprises resetting characters in S1, S2 or both S1 and S2 that were part of the traceback to an excluded character (e.g., a character that does not appear in S1 or S2), thus ensuring those characters will not be matched in subsequent calculations. In alternative examples, masking comprises adding an information bit to the characters in S1, S2 or both S1 and S2 that were part of the traceback, thus ensuring those characters will not be matched in subsequent calculations. This additional embodiment maintains the original starting information of the characters in S1 and S2. In either of these types of masking off examples, if characters in both S1 and S2 are masked, the masking change to the characters in S1 is optionally different from the change to the characters in S2, thus ensuring that the masked off characters do not serve to provide a new “match” during a subsequent round of alignment.

In further additional embodiments of the provided method, the parallel computations are carried out simultaneously in a plurality of separate processing elements (PEs), each corresponding to one row in the 2-D matrix. By way of non-limiting example, in some instances the separate PEs are components of a Single Instruction, Multiple Data (SIMD) device or an emulation thereof comprising an associative search function, a maximum/minimum search function, a responder selection/detection function, and a PE interconnect network function.

In various additional embodiments, the D, I, and C for the S-W matrix values are calculated using Equations 1-4 or equivalents thereof.

In various additional embodiments, computing in parallel D, I, and C for the S-W matrix values of the 2-D matrix comprises lockstep computing column values in the 2-D matrix. For instance, all of the calculations for a first column (corresponding to a first anti-diagonal) in the matrix are computed in lockstep/simultaneously, then the values for the second column (anti-diagonal) are calculated simultaneously, and so forth.

Optionally, the results of any of the methods provided herein can be outputted. For instance, in some examples of the provided methods the method further comprises outputting a result of the first alignment, at least one additional alignment, or both.

Also provided are one or more computer-readable storage media having encoded thereon computer program instructions for causing a computer system programmed thereby to perform a method described or illustrated herein.

Yet a further additional embodiment provides a system, such as a computer system, comprising (but not limited to) a processor; and one or more storage media storing instructions for causing the processor to perform a method as described or illustrated herein.

Also provided is a system (such as a computer system) comprising (but not limited to) a plurality of PEs (processing elements); and a memory containing instructions for causing the system to perform a method as described or illustrated herein. For instance, in some instances the computing is performed by the plurality of PEs. Optionally, such plurality of PEs is in a single physical component/piece of hardware. In other examples of such additional embodiment, the PEs are in two or more physical components within a single computing device; and such plurality of PEs in some additional embodiments are locate in multiple computing devices in communication with each other.

In various additional embodiments, the computing is performed by a GPU, the GPU operating as an emulator for the plurality of PEs. In various additional embodiments, the computing is carried out in lockstep manner.

### Section 2

### Pairwise Sequence Alignment

Pairwise sequence alignment is a one-to-one analysis between two of sequences (strings). It takes as input a query string and a second sequence, outputting an alignment of the base pairs (characters) of both strings. A strong alignment between two sequences indicates sequence similarity. Similarity between a novel sequence and a studied sequence or gene reveals clues about the evolution, structure, and function of the novel sequence via the characterized sequence or gene. In the future, sequence alignment could be used to establish an individual's likelihood for a given disease, phenotype, trait, or medication resistance.

The goal of sequence alignment is to align the bases (characters) between the strings. This alignment is the best estimate of the actual evolutionary history of substitutions, mutations, insertions, and deletions of the bases (characters). (Best here refers to the best alignment according to a specific evolutionary model used. This model is determined by the scoring weights of the dynamic programming alignment algorithms, discussed in the scoring section below.) When trying to determine common functionality or properties that have been conserved over time between two sequences (sometimes genes), sequence alignment assumes that the two sample donors are homologous, descended from a common ancestor. Regardless of the homology assumption, this is still a very relevant type of analysis. For instance, sequences of homologous genes in mice and humans are 85% similar on average (Huang, Chapter 3: Bio-Sequence Comparison and Alignment, ser. Curr Top Comp Mol Biol. Cambridge, Mass.: The MIT Press, 2002), allowing for valid sequence analysis.

An example of an “exact” alignment of two strings, S1 and S2, can consist of substitution mutations, deletion gaps, and insertion gaps known as indels. The terms are defined with regard to transforming string S1 into string S2: a substitution is a letter in S1 being replaced by a letter of S2, a mutation is when S1ᵢ≠S2ⱼ, a deletion gap character appears in S1 but does not appear in S2, and for an insertion gap, the letters of S2 do not exist S1 (Huang, Chapter 3: Bio-Sequence Comparison and Alignment, ser. Curr Top Comp Mol Biol. Cambridge, Mass.: The MIT Press, 2002). The following example contains thirteen matches, an insertion gap of length one, a deletion gap of length two, and one mismatch.

AGCTA-CGTACACTACC
AGCTATCGTAC--TAGC

There are exact and approximate algorithms for sequence alignment. Exact algorithms are guaranteed to find the highest scoring alignment. The two most well-known are Needleman-Wunch (J Mol Biol, 48(3):443-453, 1970) and Smith-Waterman (J Mol Biol, 147(1):195-197, 1981). Proposed in 1970, the Needleman-Wunsch algorithm attempts to globally align one entire sequence against another using dynamic programming (J Mol Biol, 48(3):443-453, 1970). A variation by Smith and Waterman allows for local alignment (Smith and Waterman, J Mol Biol, 147(1):195-197, 1981). A minor adjustment by Gotoh (J Mol Biol, 162(3), 705-708, 1982) greatly improved the running time from O(m² n) to O(mn) where m and n are the sequence sizes being compared. It is this algorithm that is often referred to as the Smith-Waterman algorithm (Huang and Miller, Adv. Appl. Math., 12(3):337-357, 1991; Camerson and Williams, IEEE/ACM Transactions on Comput Biol Bioinfor, 4(3):349-364, 2007; Frey, “The use of the smith-waterman algorithm in melodic song identification,” Master's Thesis, Kent State University, 2008).

Both of these well-known sequence alignment algorithms compare two sequences against each other. If the two string sizes are of size m and n respectively, then the running time is proportional to the product of their size, or O(mn). When the two strings are of equal size, the resulting algorithm can be considered an O(n²) algorithm.

These dynamic programming algorithms are rigorous in that they will find the single best alignment. The drawback to these powerful methods is that they are time consuming and that they only return a single result. In this context, heuristic algorithms have gained popularity for performing local sequence alignment quickly while revealing multiple regions of local similarity. Approximate algorithms include BLAST (Altschul et al., J Mol Biol, 215(3):403-410, 1990), Gapped BLAST (Altschul et al., Nuc Acids Res, 25(17):3389-3402, 1997), and FASTA (Pearson and Lipman, PNAS U.S.A., 85(8):2444-2448, 1988). Empirically, BLAST is 10-50 times faster than the Smith-Waterman algorithm (Craven, “Heuristic Methods for Sequence Database Searching,” lecture slides, BMI/CS 576, University of Wisconsin-Madison).

The approximate algorithms were designed for speed because of the exact algorithms' high running time. The trade-off for speed is a loss of accuracy or sensitivity through a pruning of the search space. While the heuristic methods are valuable, they may fail to report hits or report false positives that the Smith-Waterman algorithm would not. Thus, there may be higher scoring subsequences that can be aligned but are missed due to the nature of the approximations.

Often times a heuristic approach can be used as a sorting tool, finding a small number of sequences of interest out of thousands or millions that reside in a database. Then an exact algorithm can be applied to the small number of key sequences for in-depth, rigorous alignment. As a result, parallel exact sequence alignment with a reasonably large speedup over their sequential counterparts is highly desirable.

The high sensitivity and the fact that there are no additional constraints including the size and placement of gaps on an alignment (as with the approximate algorithms), make the exact algorithms useful tools. Their high running time and memory usage is the prohibitive factor in their use. This is where parallelization can be effective, especially with the dynamic programming techniques used in the Smith-Waterman algorithm. Any improvements to an exact algorithm can also be incorporated into the more complex approximation algorithms where there is limited use of the Smith-Waterman algorithm, such as in Gapped BLAST and FASTA which use the Smith-Waterman algorithm in a limited manner.

The Needleman-Wunch (N-W) algorithm is first described, followed by the full details of the Smith-Waterman algorithm.

### Needleman-Wunch

Needleman and Wunch (J Mol Biol, 48(3):443-453, 1970), along with Sellers (SIAM J Appl Math, 26(4):787-793, 1974) independently proposed a dynamic programming algorithm that performs a global sequence alignment between two sequences. Given two sequences S1 and S2, lists of ordered characters, a global alignment will align the entire length of both sequences.

It has a running time proportional to the product of the lengths of S1 and S2. Assuming |S1|=m and |S2|=n, then the running time is O(mn) with a similar space requirement. A linear-space algorithm (Hirschberg, Communications of the ACM, 18(6):341-343, 1975) was developed where no gap-opening penalties are incurred for the N-W, but this is not generally applicable. Due to the fact that the original N-W algorithm did not include a gap-insertion penalty, the linear-space algorithm developed was relevant to that earlier algorithm. The paradigm generally followed is the use of affine gap penalties, that the cost of inserting a gap incurs a fairly high penalty, while the continuation penalty of adding on to an already opened gap is small. This tends to yield alignments that have fewer, but longer running gaps versus many small gaps. This is a better fit with the biological model of gene replication, where contiguous segments of a gene are replicated, but in a different location on its homologous gene.

N-W is a global alignment that will find an alignment that has the highest number of exact substitutions (the base C in string S1 matches with base C in string S2) over the entire length of the two strings. Think of the strings as sliding windows to each other, moving past one another looking for positioning of the strings that will obtain the most number of matches between the two. The added complexity is that gaps can be inserted into both strings, trying to maximize the number of exact matches between the characters of the two strings. The focus is on aligning the entire string of S1 and S2.

### Smith-Waterman Sequence Alignment

The Smith-Waterman algorithm (S-W) differs from the N-W algorithm in that it performs local sequence alignments. Local alignment does not require entire sequences to be positioned against one another. Instead it tries to find local regions of similarity, or sub-sequence homology, aligning those highly conserved regions between the two sequences. Since it is not concerned with an alignment that stretches across the entire length the strings, a local alignment can begin and end anywhere within the two sequences.

The Smith-Waterman (J Mol Biol, 147(1):195-197, 1981)/Gotoh (J Mol Biol, 162(3), 705-708, 1982) algorithm is a dynamic programming algorithm that performs local sequence alignment on two strings of data, S1 and S2. The size of these strings is m and n, respectively, as stated previously.

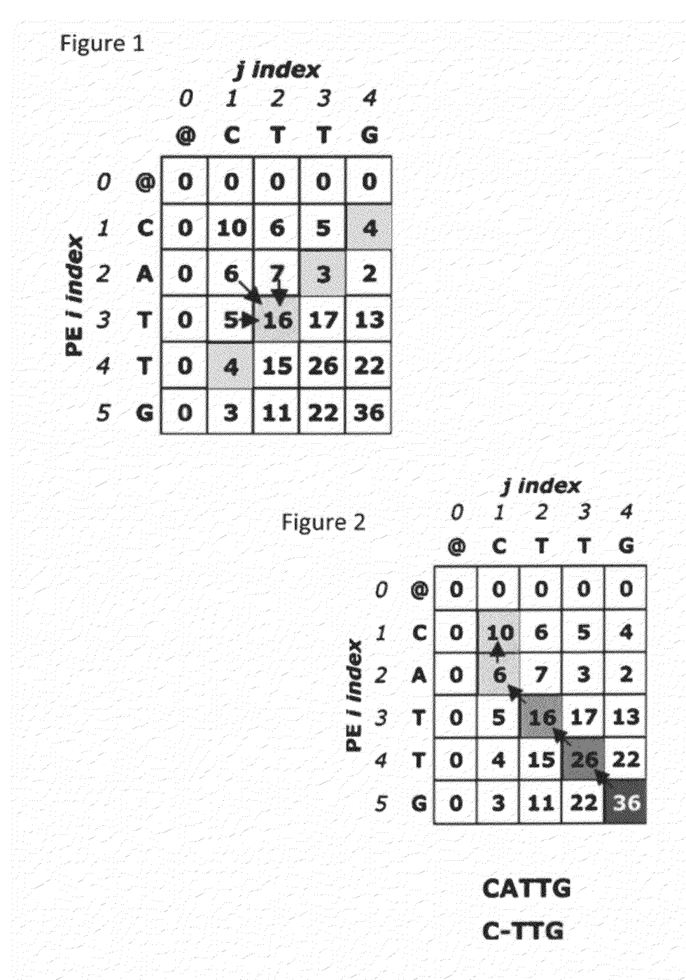

The dynamic programming approach uses a table or matrix to preserve values and avoid recomputation. This method creates data dependencies among the different values. A matrix entry cannot be computed without prior computation of its north, west and northwestern neighbors as seen in FIG. 1. Equations 1-4 (below) describe the recursive relationships between the computations.

The Smith-Waterman algorithm, and thus the SWAMP and SWAMP+ algorithms, allow for insertion and deletions of base pairs, referred to as indels. To find the best scoring alignment with all possible indels and alignments is computationally and memory intensive, therefore a good candidate for parallelization.

As outlined in Gotoh (J Mol Biol, 162(3), 705-708, 1982), several values are computed for every possible combination of deletions (D), insertions (I) and matches (C). For a deletion with affine gap penalties, Equation 1 computes the current cell's value using the north neighbor's values for a match (C_{i-1,j}) minus the cost to open up a new gap σ. The other value used from the north neighbor is D_{i-1,j}, the cost of an already opened gap from the north. From those, the gap extension penalty (g) is subtracted.

$$max \{ \begin{matrix}{C}_{i - 1 , j} - σ \\ {D}_{i - 1 , j}\end{matrix} \} - g \qquad ( 1 )$$

An insertion is similar in Equation 2, using the western neighbors match (C) and an existing open gap (I) values, subtracting the cost to extend a gap.

$$max \{ \begin{matrix}{I}_{i , j - 1} - σ \\ {D}_{i , j - 1}\end{matrix} \} - g \qquad ( 2 )$$

To compute a match where a character from both sequences is aligned, values for C are computed, where the actual base pairs, (i.e. T=?G) are compared in Equation 3.

$$d ( S {1}_{i} , S {2}_{j} ) = \{ \begin{matrix}match\_cost & if S {1}_{i} = S {2}_{j} \\ miss\_cost & if S {1}_{i} \neq S {2}_{j}\end{matrix} \qquad ( 3 )$$

This value is then combined with the overall score of the northwest neighbor, and the maximum value from D_{i,j}, I_{i,j}, C_{i,j} and zero becomes the new final score for that cell (Equation 4).

$${C}_{i , j} \vert = max \{ \begin{matrix}\begin{matrix}\begin{matrix}{D}_{i , j} \\ {I}_{i , j}\end{matrix} \\ {C}_{i - 1 , j - 1} + d ( S {1}_{i} , S {2}_{j} )\end{matrix} \\ 0\end{matrix} \} \qquad ( 4 )$$

Once the matrix has been fully computed the second, distinct part of the S-W algorithm performs a traceback. Starting with the maximum value in the matrix, the algorithm will backtrack based on which of the three values (C, D, or I) was used to compute the maximum final C value. The backtracking stops when a zero is reached. Below is an example of a completed matrix in FIG. 2, showing the traceback and the corresponding local alignment.

### Scoring

While there are an infinite number of possible alignments between two strings once gaps are introduced, the best alignment will have two characteristics that represent the biological model of the transmission of genetic materials. The alignment should contain the highest number of likely substitutions and a minimum number of gap openings (where a gap lengthening is preferred to another gap opening). The closer the alignment is to these characteristics, the higher its metric is. Hence the use of affine gap penalties, where it costs more to open a gap (subtracting a+g) versus extending a gap (subtract g only) in Equations 1 and 2.

For the similarity scores of d(S1ᵢ, S2j) in Equation 3, DNA and RNA usually have a direct miss and match score.

One example of the scoring parameter settings (Huang, Chapter 3: Bio-Sequence Comparison and Alignment, ser. Curr Top Comp Mol Biol. Cambridge, Mass.: The MIT Press, 2002) for DNA would be:
match: 10
mismatch: −20
a (gap insert): −40
g (gap extend): −2

These affine gap settings help limit the number of gap openings, tending to group the gaps together by setting the open gap penalty (a) higher than the gap extension (g) cost.

For amino acids, the similarity scores are generally stored as a table. These scores are used to assess the sequence likeness and are the most important source of previous knowledge (Nicholas et al., “Sequence Analysis Tutorials: A Tutorial on Search Sequence Databases and Sequence Scoring Methods,” Pittsburg Supercomputing Center). In working with proteins for sequence alignment, the PAM and Blosum similarity matrices are widely used (Id.):
These matrices incorporate many observations of which amino acids have replaced each other while the proteins were evolving in different species but still maintaining the same biochemical and physiological functions. They rescue us from the ignorance of having to assume that all amino acid changes are equally likely and equally harmful. Different similarity matrices are appropriate for different degrees of evolutionary divergence. Any matrix is most likely to find good matches with other sequences that have diverged from your query sequence to the extent for which the matrix is suited. Similar matrices are available, if not widely used, for DNA. The DNA matrices can incorporate knowledge about differential rates of transitions and transversions in the same way that some substitutions are judged more favorable than others in protein similarity matrices.

The PAM matrices are based on global alignments of closely related proteins, while the BLOSUM family of matrices is based on local alignments (NCBI, “The PAM and BLOSUM amino acid substitution matrices, The Statistics of Sequence Similarity Scores”). The higher the number in the PAM matrices, the more divergence there is (i.e., used for more distant relatives). The lower the number in the BLOSUM matrices, the more divergence there is. If the sequences are closely related, then a BLOSUM matrix (BLOSUM 80) with a higher number or a PAM matrix (PAM 1) with a lower number should be used. For aligning protein sequences (i.e., amino acid residues), the above-mentioned substitution tables such as the PAM250 and the BLOSUM62, are letter-dependent. Possible values to be used with a substitution table are 10 and 2 for σ and g respectively (Huang, Chapter 3: Bio-Sequence Comparison and Alignment, ser. Curr Top Comp Mol Biol. Cambridge, Mass.: The MIT Press, 2002).

### Opportunities for Parallelization

The sequential version of the Smith-Waterman algorithm has been adapted and significantly modified for the parallel ASC model, called Smith-Waterman using Associative Massive Parallelism or SWAMP. Extensions and expansions to associative algorithm are called SWAMP+. Part of the parallelization for SWAMP and SWAMP+ stems from the fact that the values along the anti-diagonal are independent. These north, west and northwest neighbors' values can be retrieved and processed concurrently in a wavefront approach. The term wavefront is used to describe the minor diagonals. One minor diagonal is highlighted in gray in FIG. 1. The data dependencies shown in the above recursive equations limit the level of achievable parallelism but using a wavefront approach will still speed up this useful algorithm.

A wavefront approach implemented by Wozniak (Comput Appl in the Biosciences (CABIOS), 13(2):145-150, 1997) on the Sun Ultra SPARC uses specialized SIMD-like video instructions. Wozniak used the SIMD registers to store the values parallel to the minor diagonal, reporting a two-fold speedup over a traditional implementation on the same machine.

Following Wozniak's example, a similar way to parallelize code is to use the Streaming SIMD Extension (SSE) set for the x86 architecture. Designed by Intel, the vector-like operations complete a single operation/instruction on a small number of values (usually four, eight or sixteen) at a time. Many AMD and Intel chips support the various versions of SSE, and Intel has continued developing this technology with the Advanced Vector Extensions (AVX) for their modern chipsets.

Rognes and Seeberg (Bioinformatics (Oxford, England), 16(8):699-706, 2000) use the Intel Pentium processor with SSE's predecessor, MMX SIMD instructions for their implementation. The approach that developed out of the work of Rognes and Seeberg (Bioinformatics, 16(8):699-706, 2000) for ParAlign does not use the wavefront approach (Rognes, Nuc Acids Res, 29(7):1647-52, 2001; Saebo et al., Nuc Acids Res, 33(suppl 2):W535-W539, 2005). Instead, they align the SIMD registers parallel to the query sequence, computing eight values at a time, using a pre-computed query-specific score matrix.

The way they layout the SIMD registers, the north neighbor dependency could remove up to one third of the potential speedup gained from the SSE parallel “vector” calculations. To overcome this, they incorporate SWAT-like optimizations (see, Swat documentation available on-line at the “Laboratory of Phil Green” website). With large affine gap penalties, the northern neighbor will be zero most of the time. If this is true, the program can skip computing the value of the north neighbor, referred to as the “lazy F evaluation” by Farrar (Bioinformatics, 23(2):156-161, 2007). Rognes and Seeberg are able to reduce the number of calculations of Equation 1 to speedup their algorithm by skipping it when it is below a certain threshold. A six-fold speedup was reported in (Rognes and Seeberg, Bioinformatics, 16(8):699-706, 2000) using 8-way vectors via the MMX/SSE instructions and the SWAT-like extensions.

In the SSE work done by Farrar (Bioinformatics, 23(2):156-161, 2007), a striped or strided pattern of access is used to line up the SIMD registers parallel to the query registers. Doing so avoids any overlapping dependencies. Again incorporating the SWAT-like optimizations (Farrar, Bioinformatics 23(2):156-161, 2007) achieves a 2-8 time speedup over Wozniak (CABIOS 13(2):145-150, 1997) and Rognes and Seeberg (Bioinformatics (Oxford, England), 16(8):699-706, 2000) SIMD implementations. The block substitution matrices and efficient and clever inner loop with the northern (F) conditional moved outside of that inner loop are important optimizations. The strided memory pattern access of the sixteen, 8-bit elements for processing improves the memory access time as well, contributing to the overall speedup.

Farrar (Sequence Analysis, 2008) extended his work for a Cell Processor manufactured by Sony, Toshiba and IBM. This Cell Processor has one main core and eight minor cores. The Cell Broadband Engine was the development platform for several more Smith-Waterman implementations including SWPS3 by Szalkowski, et. al (BMC Res Notes 1(107), 2008) and CBESW by Wirawan, et. al (BMC Bioinformatics 9 (377) 2008) both using Farrar's striping approach. Rudnicki, et. al. (Fund Inform. 96, 181-194, 2009) used the PS3 to develop a method that used parallelization over multiple databases sequences.

Rognes (BMC Bioinformatics 12 (221), 2011) developed a multi-threaded approach called SWIPE that processes multiple database sequences in parallel. The focus was to use a SIMD approach on “ordinary CPUs.” This investigation using coarse-grained parallelism split the work using multiple database sequences in parallel is similar to the graphics processor units (GPU)-based tools described in the CUDASW by Liu, et al. (BMC Res Notes 2(73), 2009) and Ligowski and Rudnicki (Eight Annual International Workshop on High Performance Computational Biology, Rome, 2009). There has been other implementations of GPU work with CUDASW++2.0 by Liu, et. al. (BMC Res Notes 3(93), 2010) and Ligowski, et. al (GPU Computing Gems, Emerald Edition, Morgan Kaufmann, 155-157, 2011).

The earlier approaches take advantage of small-scale vector parallelization (8, 16 or 32-way parallelism) and the GPU implementations generally focus on aligning multiple sequences in parallel. SWAMP is geared towards larger, massive SIMD parallelization. The theoretical peak speedup for the calculations is a factor of m, which is optimal. A 96-fold speedup for the ClearSpeed implementation using 96 processing elements, confirming the theoretical speedup. The associative model of computation that is the basis for the SWAMP development is discussed below.

The increasing growth and complexity of high-performance computing as well as the stellar data growth in the bioinformatics field stand as posts guiding this work. The march is towards increasing processor counts, each processor with an increasing number of compute cores and often associated with accelerator hardware. The bi-annual Top500 listing of the most powerful computers in the world stands as proof of this. With hundreds of thousands of cores, many using accelerators, massive parallelism is a top tier fact in high-performance computing.

This research addresses one of the most often used tools in bioinformatics, sequence alignment. While the application focus is sequence alignment, the technologies disclosed herein are applicable to other problems in other fields. The parallel optimizations and techniques presented here for a Smith-Waterman-like sequence alignment can be applied to algorithms that use dynamic programming with a wavefront approach. One example is a parallel benchmark called Sweep3D, a neutron transport model. This work can also be extended to other applications, including better search engines utilizing more flexible approximate string matching.

An associative algorithm for performing quality sequence alignments more efficiently and faster is at the center of this discussion. SWAMP (Smith-Waterman using Massive Associative Parallelism) is the parallel algorithm developed for the massively parallel associative computing or ASC model. The ASC model is suited for algorithm development for many reasons, including the fast searching capabilities and fast maximum finding, utilized in this work. The theoretical speedup for the algorithm is reduced from O(mn) to O(m+n), where m and n are the length of the input sequences. When |m|=|n|, the running time becomes O(n) with a very small constant of two. The parallel associative model is introduced and explored in Section 3. The design and ASC implementation of SWAMP are covered in Section 4.

Using the capabilities of ASC, innovative new algorithms can increase the information returned by the alignment algorithms without decreasing the accuracy of those alignments. Called SWAMP+, these new extensions have been designed, implemented, and successfully tested as described herein. These algorithms are a highly sensitive parallelized approach extending traditional pairwise sequence alignment. They are useful for in-depth exploration of sequences, including research in expressed sequence tags, regulatory regions, and evolutionary relationships. These new algorithms are presented in Section 5.

Although the SWAMP suite of algorithms was designed for the associative computing platform, these algorithms have been implemented on the ClearSpeed CSX 620 processor to obtain realistic metrics, as presented in Section 7. The performance for the compute intensive matrix calculations displayed a parallel speedup up to 96 using ClearSpeed's 96 processing elements, thus verifying the possibility of achieving the theoretical speedup mentioned above.

Additional parallel hardware implementations and a cluster-based approach were explored, to test out the memory-intensive Smith-Waterman across multiple nodes within a cluster. This work utilizes a tool called JumboMem, described in Section 8. It enabled running of large instances of Smith-Waterman-type alignment while storing the matrix of computations completely in memory.

### Section 3

### Parallel Computing Models

The main parallel model used to develop and extend Smith-Waterman sequence alignment is the ASsociative Computing (ASC) (Potter et al., Computer, 27(11):19-25, 1994). Efficient parallel versions of the Smith-Waterman algorithm are described herein. This model and one other model are described in detail in this section.

### 3.1 Models of Parallel Computation

Some relevant vocabulary is defined here. Two terms of interest from Flynn's Taxonomy of computer architectures are MIMD and SIMD, two different models of parallel computing. A cluster of computers, classified as a multiple-instruction, multiple-data (MIMD) model is used as a proof-of-concept to overcome memory limitations in extremely large-scale alignments. Section 8 describes usage of the MIMD model. An extended data-parallel, single-instruction multiple-data (SIMD) model known as ASC is also described.

### 3.1.1 Multiple Instruction, Multiple Data (MIMD)

The multiple-data, multiple-instruction model or MIMD model describes the majority of parallel systems currently available, and include the currently popular cluster of computers. The MIMD processors have a full-fledged central processing unit (CPU), each with its own local memory (Quinn, Parallel Computing: Theory and Practice, 2nd ed., New York: McGraw-Hill, 1994). In contrast to the SIMD model, each of the MIMD processors stores and executes its own program asynchronously. The MIMD processors are connected via a network that allows them to communicate but the network used can vary widely, ranging from an Ethernet, Myrinet, and InfiniBand connection between machines (cluster nodes). The communications tend to employ a much looser communications structure than SIMDs, going outside of a single unit. The data is moved along the network asynchronously by individual processors under the control of their individual program they are executing. Typically, communication is handled by one of several different parallel languages that support message-passing. A very common library for this is known as the Message Passing Interface (MPI). Communication in a “SIMD-like” fashion is possible, but the data movements will be asynchronous. Parallel computations by MIMDs usually require extensive communication and frequent synchronizations unless the various tasks being executed by the processors are highly independent (i.e. the so-called “embarrassingly parallel” or “pleasingly parallel” problems). The work presented in Section 8 uses an AMD Opteron cluster connected via InfiniBand.

Unlike SIMDs, the worst-case time required for the message-passing is difficult or impossible to predict. Typically, the message-passing execution time for MIMD software is determined using the average case estimates, which are often determined by trial, rather than by a worst case theoretical evaluation, which is typical for SIMDs. Since the worst case for MIMD software is often very bad and rarely occurs, average case estimates are much more useful. As a result, the communication time required for a MIMD on a particular problem can be and is usually significantly higher than for a SIMD. This leads to the important goal in MIMD programming (especially when message-passing is used) to minimize the number of inter-processor communications required and to maximize the amount of time between processor communications. This is true even at a single card acceleration level, such as using graphics processors or GPUs.

Data-parallel programming is also an important technique for MIMD programming, but here all the tasks perform the same operation on different data and are only synchronized at various critical points. The majority of algorithms for MIMD systems are written in the Single-Program, Multiple-Data (SPMD) programming paradigm. Each processor has its own copy of the same program, executing the sections of the code specific to that processor or core on its local data. The popularity of the SPMD paradigm stems from the fact that it is quite difficult to write a large number of different programs that will be executed concurrently across different processors and still be able to cooperate on solving a single problem. Another approach used for memory-intensive but not compute-intensive problems is to create a virtual memory server, as is done with JumboMem, using the work presented in Section 8. This uses MPI in its underlying implementation.

### 3.1.2 Single Instruction, Multiple Data (SIMD)

The SIMD model consists of multiple, simple arithmetic processing elements called PEs. Each PE has its own local memory that it can fetch and store from, but it does not have the ability to compile or execute a program. As used herein, the term “parallel memory” refers to the local memories, collectively, in a computing system. For example, a parallel memory can be the collective of local memories in a SIMD computer system (e.g., the local memories of PEs), the collective of local memories of the processors in a MIMD computer system (e.g., the local memories of the central processing units) and the like. The compilation and execution of programs are handled by a processor called a control unit (or front end) (Quinn, Parallel Computing: Theory and Practice, 2nd ed., New York: McGraw-Hill, 1994). The control unit is connected to all PEs, usually by a bus.

All active PEs execute the program instructions received from the control unit synchronously in lockstep. “In any time unit, a single operation is in the same state of execution on multiple processing units, each manipulating different data” (Quinn, Parallel Computing: Theory and Practice, 2nd ed., New York: McGraw-Hill, 1994), at page 79. While the same instruction is executed at the same time in parallel by all active PEs, some PEs may be allowed to skip any particular instruction (Baker, SIMD and MASC: Course notes from CS 6/73301: Parallel and Distributed Computing—power point slides, (2004)2004). This is usually accomplished using an “if-else” branch structure where some of the PEs execute the if instructions and the remaining PEs execute the else part. This model is ideal for problems that are “data-parallel” in nature that have at most a small number of if-else branching structures that can occur simultaneously, such as image processing and matrix operations.

Data can be broadcast to all active PEs by the control unit and the control unit can also obtain data values from a particular PE using the connection (usually a bus) between the control unit and the PEs. Additionally, the set of PE are connected by an interconnection network, such as a linear array, 2-D mesh, or hypercube that provides parallel data movement between the PEs. Data is moved through this network in synchronous parallel fashion by the PEs, which execute the instructions including data movement, in lockstep. It is the control unit that broadcasts the instructions to the PEs. In particular, the SIMD network does not use the message-passing paradigm used by most parallel computers today. An important advantage of this is that SIMD network communication is extremely efficient and the maximum time required for the communication can be determined by the worst-case time of the algorithm controlling that particular communication.

The remainder of this section is devoted to describing the extended SIMD ASC model. ASC is at the center of the algorithm design and development for this discussion.

### 3.2 Associative Computing Model

The ASsocative Computing (ASC) model is an extended SIMD based on the STARAN associative SIMD computer, designed by Dr. Kenneth Batcher at Goodyear Aerospace and its heavily Navy-utilized successor, the ASPRO.

Developed within the Department of Computer Science at Kent State University, ASC is an algorithmic model for associative computing (Potter et al., Computer, 27(11):19-25, 1994) (Potter, Associative Computing: A Programming Paradigm for Massively Parallel Computers, Plenum Publishing, 1992). The ASC model grew out of work on the STARAN and MPP, associative processors built by Goodyear Aerospace. Although it is not currently supported in hardware, current research efforts are being made to both efficiently simulate and design a computer for this model.

As an extended SIMD model, ASC uses synchronous data-parallel programming, avoiding both multi-tasking and asynchronous point-to-point communication routing. Multi-tasking is unnecessary since only one task is executed at any time, with multiple instances of this task executed in lockstep on all active processing elements (PEs). ASC, like SIMD programmers, avoid problems involving load balancing, synchronization, and dynamic task scheduling, issues that must be explicitly handled in MPI and other MIMD cluster paradigms.

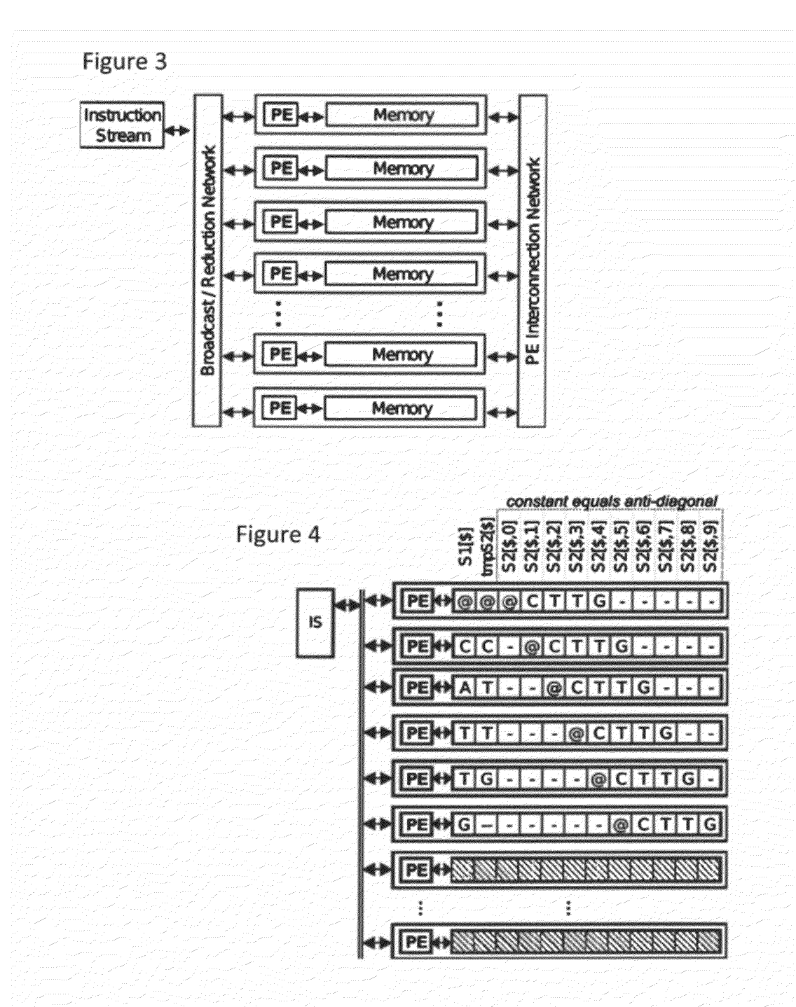

FIG. 3 shows a conceptual model of an ASC computer. There is a single control unit, also known as an instruction stream (IS), and multiple processing elements (PEs), each with its own local memory. The control unit and PE array are connected through a broadcast/reduction network and the PEs are connected together through a PE data interconnection network.

As seen in FIG. 3, a PE has access to data located in its own local memory. The data remains in place and responding (active) PEs process their local data in parallel. The reference to the word associative is related to the use of searching to locate data by content rather than memory addresses. The ASC model does not employ associative memory, instead it is an associative processor where the general cycle is to search-process-retrieve. An overview of the model is available in (Potter et al., Computer, 27(11):19-25, 1994).

The tabular nature of the algorithm lends itself to computation using ASC due to the natural tabular structure of ASC data structures. Highly efficient communication across the PE interconnection network for the lockstep shifting of data of the north and northwest neighbors, and the fast constant time associative functions for searching and for maximums across the parallel computations are well utilized by SWAMP and SWAMP+.

The associative operations are executed in constant time (Jin et al., 15th International Parallel and Distributed Processing Symposium (IPDPS'01) Workshops, San Francisco, p. 193, 2001), due to additional hardware required by the ASC model. These operations can be performed efficiently (but less rapidly) by any SIMD-like machine, and has been successfully adapted to run efficiently on several SIMD hardware platforms (Yuan et al., Parallel and Distributed Computing Systems (PDCS), Cambridge, M A, 2009; Trahan et al., J. of Parallel and Distributed Computing (JPDC), 2009). SWAMP+ and other ASC algorithms can therefore be efficiently implemented on other systems that are closely related to SIMDs including vector machines, which is why the model is used as a paradigm.

The control unit fetches and decodes program instructions and broadcasts control signals to the PEs. The PEs, under the direction of the control unit, execute these instructions using their own local data. All PEs execute instructions in a lockstep manner, with an implicit synchronization between instructions. ASC has several relevant high-speed global operations: associative search, maximum/minimum search, and responder selection/detection. These are described in the following section.

### 3.2.1 Associative Functions

The functions relevant to the SWAMP algorithms are discussed below. Associative Search

The basic operation in an ASC algorithm is the associative search. An associative search simultaneously locates the PEs whose local data matches a given search key. Those PEs that have matching data are called responders and those with non-matching data are called non-responders. After performing a search, the algorithm can then restrict further processing to only affect the responders by disabling the non-responders (or vice versa). Performing additional searches may further refine the set of responders. Associative search is heavily utilized by SWAMP+ in selecting which PEs are active within a parallel act within a diagonal.

### Maximum/Minimum Search

In addition to simple searches, where each PE compares its local data against a search key using a standard comparison operator (equal, less than, etc.), an associative computer can also perform global searches, where data from the entire PE array is combined together to determine the set of responders. The most common type of global search is the maximum/minimum search, where the responders are those PEs whose data is the maximum or minimum value across the entire PE array. The maximum value is used by SWAMP+ in every diagonal it processes to track the highest value calculated so far. Use of the maximum search occurs frequently, once in a logical parallel act, m+n times per alignment.

### Responder Selection/Detection

An associative search can result in multiple responders and an associative algorithm can process those responders in one of three different modes: parallel, sequential, or single selection. Parallel responder processing performs the same set of operations on each responder simultaneously. Sequential responder processing selects each responder individually, allowing a different set of operations for each responder. Single responder selection (also known as pickOne) selects one, arbitrarily chosen, responder to undergo processing. In addition to multiple responders, it is also possible for an associative search to result in no responders. To handle this case, the ASC model can detect whether there were any responders to a search and perform a separate set of actions in that case (known as anyResponders. In SWAMP+, multiple responders that contain characters to be aligned are selected and processed in parallel, based on the associative searches mentioned above. Single responder selection occurs if and when there are multiple values that have the exact same maximum value when using the maximum/minimum search.

### PE Interconnection Network

Most associative processors include some type of PE interconnection network to allow parallel data movement within the array. The ASC model itself does not specify any particular interconnection network and, in fact, many useful associative algorithms do not require one. Typically associative processors implement simple networks such as 1D linear arrays or 2D meshes. These networks are simple to implement and allow data to be transferred quickly in a synchronous manner. The 1D linear array is sufficient for the explicit communication between PEs in the SWAMP+ algorithms.

### Section 4

### Smith-Waterman Using Associative Massive Parallelism (SWAMP)

### 4.1 Overview

While implementations of the S-W exist for several SIMDs (Guinand, ISThmus 2000 Conference on Research and Development for the Information Society, Poznan, Poland, 2000; Singh et al., Comput Appl in the Biosciences (CABIOS), 12(3):191-196, 1996; Di Blas et al., IEEE Transactions on Parallel and Distributed Systems, 16(1):80-92, 2005), clusters (Zhang et al., Fifth International Conference on Algorithms and Architectures for Parallel Processing, 2002, Proceedings, pp. 162-169, 2002; Strumpen, Software Practice and Experience, 25(3):291-304, 1995), and hybrid clusters (Schmidt et al., First International Workshop on High Performance Computational Biology, Parallel and Distributed Processing Symposium, International, Fort Lauderdale, Fla., 2002; Rognes and Seeberg, Bioinformatics, 16(8):699-706, 2000), they do not directly correspond to the associative model used in this research. These algorithms assume architectural features that are different from those of the associative ASC model.

Before the work presented herein, there has been no development for the associative model in the bioinformatics domain. The associative features described in the previous section are used to speedup and extend the Smith-Waterman algorithm to produce more information by providing additional alignments. The technologies disclosed herein allow researchers and users to drill down into the sequences with an accuracy and depth of information not heretofore available for parallel Smith-Waterman sequence alignment.

Any solution that uses the ASC model to solve local sequence alignment has been dubbed Smith-Waterman using Associative Massive Parallelism (SWAMP). The SWAMP algorithm presented here is based an earlier associative sequence alignment algorithm (Steinfadt et al., IASTED's Computational and Systems Biology (CASB 2006), Dallas, Tex., pp. 38-43, 2006). It has been further developed and parallelized to reduce its running time. Some of the changes from that prior report to the work presented here include:
Parallel input (usually a bottleneck in parallel machines) has been greatly reduced.
Data initialization of the matrix has been parallelized

Also described herein is a comparative analysis between the different parallel versions, as well as a comparative analysis between different worst-case file sizes.

### 4.2 ASC Emulation

The initial development environment used is the ASC emulator. The parallel programming language and emulator share the name of the model in that it too is called ASC. Both the compiler and emulator are available for download from the Kent State University Parallel and Associative Computing Laboratory website. Throughout the SWAMP description, the ASC convention to include [$] after the name of all parallel variables is used, as seen in FIG. 4.

### 4.2.1 Data Setup

SWAMP retains the dynamic programming approach of (Gotoh, J Mol Biol, 162(3), 705-708, 1982) with a two-dimensional matrix. Instead of working on one element at a time, a matrix column is executed in parallel. However, it is not a direct sequential-to-parallel conversion. Due to the data dependencies, north, west and northwest neighbors need to be computed before that matrix element can be computed. If directly mapped onto ASC, the data dependencies would force a completely sequential execution of the algorithm.

One of the challenges this algorithm presented was to store anti-diagonals, such as the one highlighted in FIG. 4 as a single parallel ASC variable (column). The second challenge was to organize the north, west, and northwest neighbors to be the same uniform distance away from the matrix cells for the D, I, and C values for the uniform SIMD data movement.

To align the values along an anti-diagonal, the data is shifted within parallel memory so that the anti-diagonals become columns. This shift allows for the data-independent values along each anti-diagonal to be processed in parallel, from left to right. First the two strings S1 and S2 are read in as input into S1[$] and tempS2[$]. The tempS2[$] values are what is shifted via a temporary parallel variable and copied into the parallel S2[$] array so that it is arranged in the manner shown in FIG. 4. Instead of a matrix that is m×n, the new two-dimension ASC “matrix” has the dimensions m×(m+n). There are the m number of PEs used each requiring (m+n) memory elements for each local copy of D, I, and C for the Smith-Waterman matrix values.

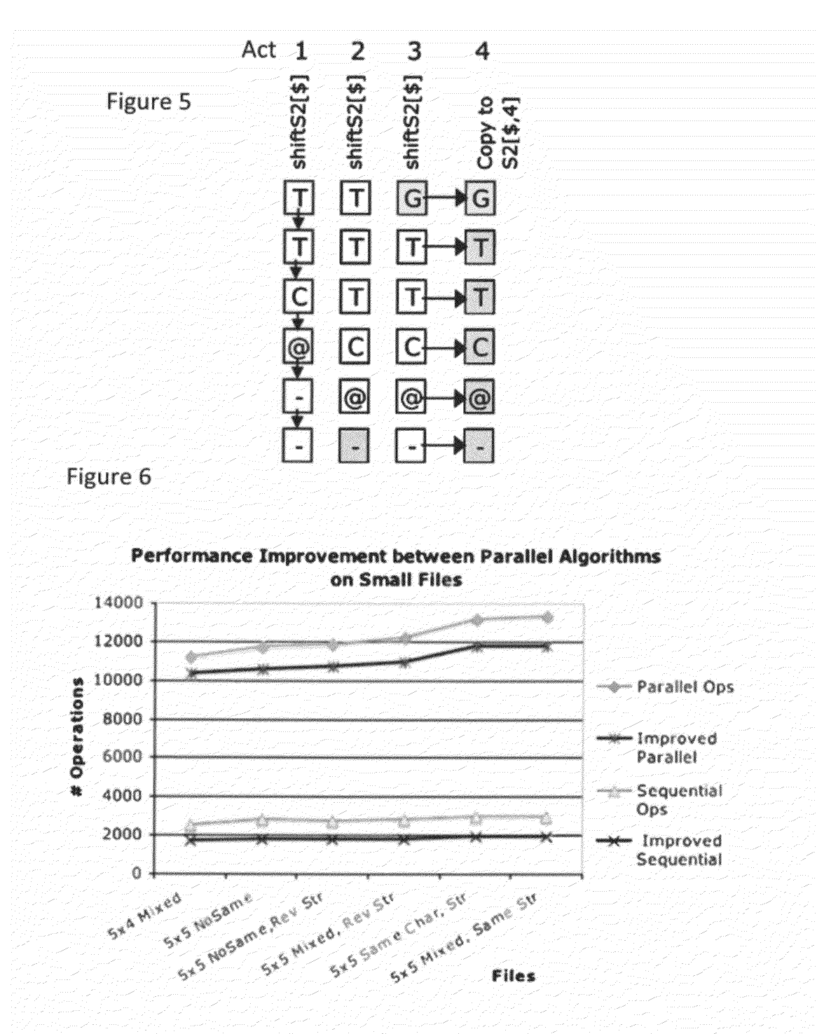

A specific example of the data shifting is shown in FIG. 5. Here, the shifting in the fourth anti-diagonal from FIG. 4 shown in detail. To initialize this single column of the two-dimension array, S2[$,4], the temporary parallel variable shiftS2[$] acts as a stack. Active PEs replicate their copy of the 1-D shiftS2[$] variable down to their neighboring PE in a single ASC act utilizing the linear PE Interconnection Network (Act 1). Data elements in shiftS2[$] that are out of range and have no corresponding S2 value are set to the placeholder value. The remaining character of S2 that is stored in tmpS2[$] is “pushed” on top (copied) to the first PEs value for shiftS2[$] (Act 3). Then active PEs perform a parallel copy of shiftS2[$] into their local copy of the ASC 2-D array S2[$, 4] (Act 4).

Again, this parallel shifting of S2 aligns anti-diagonals within the parallel memory so that an anti-diagonal can be concurrently computed. In addition, the shifting of S2 removes the parallel I/O bottleneck from algorithm in (Steinfadt et al., IASTED's Computational and Systems Biology (CASB 2006), Dallas, Tex., pp. 38-43, 2006). This new algorithm reads in the two strings, S1 and S2 instead of reading an m×(m+n) matrix in as input. From there, the setup of the matrix is done in parallel inside the ASC program, instead of being created sequentially outside of the ASC program as was done in the initial SWAMP development for (Steinfadt et al., IASTED's Computational and Systems Biology (CASB 2006), Dallas, Tex., pp. 38-43, 2006).

### 4.2.2 SWAMP Algorithm Outline

A quick overview of the algorithm is that the parallel initialization described in Section 4.2.1 shifts S2 throughout the matrix. The algorithm then iterates through the anti-diagonals to compute the matrix values of D, I and C. As it does this, the algorithm also finds the index and the value of the local (column) maximum using the ASC MAXDEX function.

This SWAMP pseudocode, shown in Listing 4.1 below, is based on a working ASC language program. Since there are m+n+1 anti-diagonals, they are numbered 0 through (m+n). The notation [$, a-d] indicates that active PEs in a given anti-diagonal (a_d), process their array data in parallel. For review, m and n are the length of the two strings being aligned without the added null character used in the traceback process.

### Listing 4.1: SWAMP Local Alignment Algorithm

Listing 4.1 SWAMP Local Alignment Algorithm

| | |
|---|---|
| 1 | Read in S1 and S2 |
| 2 | In Active PEs (those with valid data values in S1 or S2): |

| | |
|---|---|
| 3 | Initialize the 2-D variables D[$], I[$], C[$] to 0. |
| 4 | Shift string S2 as described in Emulation Data Setup Section |
| 5 | For every a_d from 1 to m + n do in parallel { |

| | |
|---|---|
| 6 | if S2[$,a_d] neq “@” and S2[$,a_d] neq “−” then { |

| | |
|---|---|
| 7 | Calculate score for deletion for D[$,a_d] |
| 8 | Calculate score for an insertion for I[$,a_d] |
| 9 | Calculate matrix score for C[$,a_d]} |

| | |
|---|---|
| 10 | localMaxPE=MAXDEX(C[$,a_d]) |
| 11 | if C[localMaxPE, a_d] > maxVal then { |

| | |
|---|---|
| 12 | maxPE = localMaxPE |
| 13 | maxVal = C[localMaxPE, a_d])} } |

| | |
|---|---|
| 14 | return maxVal, maxPE |

The pseudocode at lines 3 and 4 iterate through every anti-diagonal from zero through (m+n). Line 5 controls the iterations for the computations of D, I, and C from anti-diagonals numbered 1 through (m+n). Typically, the computations begin starting at diagonal 2. It is an optimization, since PEs that are active for diagonals 0 and 1 can be initialized to zero values previously. The pseudocode at line 6 masks off non-responders including the first “buffer” row and column in the matrix. Lines 7-9 are based on the recurrence relationships defined in Equations 1, 2 and 4, respectively. Line 10 uses the ASC MAXDEX function to track the value and location of the maximum value in the pseudocode at lines 12 and 13.

### 4.3 Performance Analysis 4.3.1 Asymptotic Analysis

Based on an analysis of the pseudocode from Section 4.2.2, there are three loops that execute for each anti-diagonal θ(m+n) times in lines 3-5. The pseudo code at line 4 and each sub-act of lines 7-9 require communication between PEs. The communication is with direct neighbors, one PE to the north. Using a linear array without wraparound, this can be done in constant time for ASC. Line 10 finds the PE index of the maximum value or MAXDEX in constant time as described in Section 3.2.1.

Given this analysis, the overall time complexity is θ(m+n) using m+1 PEs. The extra PE handles the border placeholder (the “@” in the example in FIG. 4).

This is asymptotically the same as the algorithm presented in (Steinfadt et al., IASTED's Computational and Systems Biology (CASB 2006), Dallas, Tex., pp. 38-43, 2006).

### 4.3.2 Performance Monitor Result Analysis

Where the performance diverges is through comparisons based on the number of actual operations completed in the ASC emulator.

Performance is measured by using ASC's built-in performance monitor. It tracks the number of parallel and sequential operations. The only exception is that input and output operations are not counted.

Improvements to the code include the parallelization of the initial data import discussed in Section 4.2.1, moving the initialization of D, I, and C outside of a nested loop, and changes in the order of matrix calculations for C's value when finding its max among D, I and itself.

The files used in the evaluation are all very small with most sizes of S1 and S2 equal to five. Even with the small file size, an average speedup factor of 1.08 for the parallel operations and an average 1.54 speedup factor for sequential operations was achieved over the first initial implementation. The impact of these improvements is greater as the size of the input strings grows.

To test the impact on the ASC code, several different organizations of data were explored, as seen along the x-axis in FIG. 6. The type of data in the input files also impacts the overall performance. For instance, the “5×4 Mixed” file has the two strings CATTG and CTTG. This input creates the least amount of work of any of the files, partly due to its smaller size (m=5 and n=4) but also because not all of the characters are the same, nor do they all align with one another. The file that used the highest number of parallel operations is the “5×5 Mixed, Same Str.” This file has the input string CATTG twice. This had slightly higher number of parallel operations than the two strings of AAAAA from “5×5 Same Char, Str” file.

The lower factor speedup of 1.08 in parallel operations is due to the matrix computations. This is the most compute-intensive section of the code and no parallelization changes were made to that section of code. Its domination can be seen in FIG. 6, even with these unrealistically small files sizes.

The improvement for parallelizing the setup of the parallel data (i.e. the “shift” into the 2-D ASC array) is shown in FIG. 6.

What is not apparent and cannot be seen in FIG. 6 is the huge reduction in parallel I/O. This is because the performance monitor is automatically suspended for I/O operations. The m(m+n) shifted S2 data values are no longer read in. Instead, only the character strings of S1 and S2 are input from a file. When this algorithm is moved outside of the ASC emulator and onto hardware, the input and output (I/O) bottleneck is a serious consideration that is taken into account. As systems increase to massively parallel scales, it has been noted that the Input/Output operations per second (IOPs) matter more than the achievable Floating Point Operations per second (FLOPs). This algorithm greatly reduces the parallel input from m(m+n) or O(m²) down to O(max(m, n)).

### 4.3.3 Predicted Performance as S1 and S2 Increase in Length

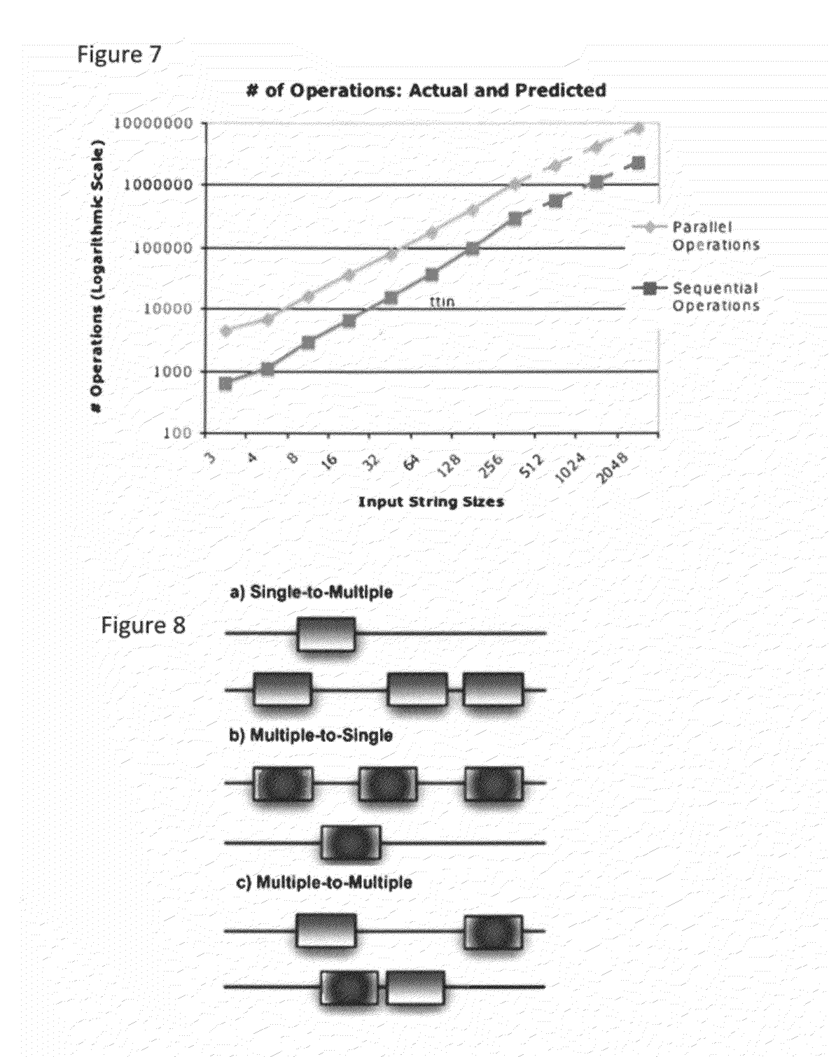

The level of impact of the different types of input was unexpected. After making the improvements to the algorithm and the code, performance was measured using the worst-case input: two identical strings of mixed characters. The two strings within a file were made the same length and were a subset of a GenBank nucleotide entry DQ328812 (Ursus arctos haplotype). SWAMP was tested with m and n set to lengths 3, 4, 8, 16, 32, 64, 128 and 256. Emulator constraints limited string lengths to 256. String lengths larger than 256 are performance predictions obtained using linear regression and the least squares method. These predictions are indicated with a dashed line in FIG. 7.

FIG. 7 demonstrates that as the size of the strings increases the number of operations growth is linear, matching the asymptotic analysis. Note that the y-axis scale is logarithmic since the file sizes are doubling at each data point beyond size 4. These predictions assume that there are |S1| or m PEs available.

### 4.3.4 Additional Avenues of Discovery

In looking at the difference in the number of operations based on the type of input in FIG. 6, it would be interesting to run a brief survey on the nature of the input strings. Since highly similar strings are likely the most common input, further improvements can be made to reduce the number of operations for this current worst case. Rearranging a section of the code would not change the worst-case number of operations, but it would change the frequency of worst-case occurring.

Another consideration is to combine the three main loops at lines 3-5 of this algorithm. Instead of subroutine calls for the separate actions (initialization, shifting S2, computing D, I and C), they can be combined into a single loop and the performance measures re-run.

### 4.3.5 Comments on Emulation

Further parallelization helped to reduce the overall number of operations and improve performance. The average number of parallel operations improved by a factor of 1.08, and the sequential operations by an average factor of 1.53 with extremely small file sizes of only 5 characters in each string. The greater impact of the speedup will be obvious when using string sizes that are several hundred or several thousands of characters long.

Awareness about the impact of the different file inputs was raised through the different tests. The difference in the number of operations for such small file sizes was unexpected. In all likelihood, the pairwise comparisons are between highly similar (biologically homologous) sequences and therefore the inputs are highly similar. This prompts further investigation of how to modify the algorithm structure to change when worst-case number of operations occurs. It may prove beneficial to switch the worst case from happening when the input strings are highly similar to when the strings are highly dissimilar, a more unlikely data set for SWAMP.

Parallel input was greatly reduced to avoid bottlenecks and performance degradation. This is important for the migration of SWAMP to the ClearSpeed Advance X620 board described in Section 6.

Overall, the algorithm and implementation is better designed and faster running than the earlier ASC alignment algorithm. In addition, this stronger algorithm makes for a better transition to the ClearSpeed and NVIDIA parallel acceleration hardware.

4.4 SWAMP with Added Traceback

The traceback section for SWAMP was later added in the emulator version of the ASC code. A pseudocode explanation of the SWAMP algorithm is given below, with lines 14 and higher devoted to tracing back the alignment and outputting the actual alignment information to the user. The “$” symbol indicates all active PEs' values are selected for a particular parallel variable.

Listing 4.2: SWAMP Local Alignment Algorithm with Traceback

| | |
|---|---|
| 1 | Read in S1 and S2 |
| 2 | In Active PEs (those with valid data values in S1 or S2): |

| | |
|---|---|
| 3 | Initialize the 2-D variables D[$], I[$], C[$] to zeros. |
| 4 | Shift string S2 as described in ASC Emulation Section above |
| 5 | For every a_d from 1 to m + n do in parallel { |

| | |
|---|---|
| 6 | if S2[$,a_d] neq “@” and S2[$,a_d] neq “−” then { |

| | |
|---|---|
| 7 | Calculate score for deletion for D[$,a_d] |
| 8 | Calculate score for an insertion for I[$,a_d] |
| 9 | Calculate matrix score for C[$,a_d]} |

| | |
|---|---|
| 10 | localMaxPE=MAXDEX(C[$,a_d])} } |
| 11 | if C[localMaxPE, a_d] > maxVal then { |

| | |
|---|---|
| 12 | maxPE = localMaxPE |
| 13 | maxVal = C[localMaxPE, a_d])} } |

| | |
|---|---|
| 14 | start at max_Val, max_PE // get row and col indicies |
| 15 | diag = max_col_id |
| 16 | row_id = max_id |
| 17 | Store very last 2 characters that are aligned for output |
| 18 | While (C[$,diag] >0) and traceback_direction!= “x” { |

| | |
|---|---|
| 19 | if traceback_direction == “c” { |
| 20 | diag = diag − 2; |
| 21 | row_id = row_id − 1; |
| 22 | Add S1[row_id], S2[diag − row_id] to output strings} |
| 23 | if traceback_direction == “n” { |
| 24 | diag = diag − 1; |
| 25 | row_id = row_id − 1; |
| 26 | Add S1[row_id] and ‘−’ to output strings} |
| 27 | if traceback_direction == “w” { |
| 28 | diag = diag − 1; |
| 29 | row_id = row_id;} |
| 30 | Add ‘−’ and S2[diag − row_id] to output strings} |
| 31 | Output C[row_id, diag], |
| 32 | S1[row_id, and S2[row_id, diag]} |

The pseudocode at lines 15 and 16 use the stored values max_PE and max_Val, obtained by using ASC's fast maximum MAXDEX operation in line 10.

The loop in line 18 is predicated on the fact that the computed values are greater than zero and there are characters remaining in alignment to be output. The variable traceback_direction stores which of its three neighbors had the maximum computed value, its northwest or corner neighbor (“c”), the north neighbor (“n”), or the west (“w”). The directions come from the sequential Smith-Waterman representation, not the “skewed” parallel data moved for the ASC SWAMP algorithm. The sequential variables diag (for anti-diagonal) and row_id calculations line up to form a logical row and column index into the skewed S2 associative data (lines 23-30).

4.4.1 SWAMP with Traceback Analysis

The original SWAMP algorithm presented in Section 4.2.2 has an asymptotic running time of O(m+n) using m+1 PEs. The newly added traceback section is inherently sequential, starting at the largest or right-most anti-diagonal that contains the maximum computed value across the matrix and traces back from right to left, across the matrix until a zero value is reached. The maximum number of iterations the loop in line 18 can complete is m+n, the width of the computed matrix. This is asymptotically no longer than the computation section which is a factor of m+n or 2n when m=n. Removing the coefficient, as should be done when using the asymptotic notation, this 2n becomes O(n) and therefore only adds to the coefficient to maintain an O(n) running time.

In SWAMP, only one subsequence alignment is found, just like in Smith-Waterman. The adaptation for a rigorous local alignment algorithm that provides multiple local non-overlapping, non-intersecting regions of similarity is discussed in the next section, calling the work SWAMP+. Discussed herein are parallel versions along the lines of SIM (Huang and Miller, Adv. Appl. Math., 12(3):337-357, 1991) and LALIGN (Pearson and Lipman, PNAS U.S.A, 85(8):2444-2448, 1988) that are rigorous algorithms that provide multiple regions of similarity, but they are sequential with slow running times similar to the sequential Smith-Waterman.

Another ASC algorithm of special interest is an efficient pattern-matching algorithm (Esenwein and Baker, IASTED International Conference on Parallel and Distributed Computing and Systems, pp. 69-74, 1997). Preliminary work shows that (Sellers, SIAM J Appl Math, 26(4):787-793, 1974) could be a strong basis for an associative parallel version of a nucleotide search tool that uses spaced seeds to perform hit detection similar to MEGABLAST (Zhang, et al., J. of Computational Biol., 7(1-2):203-214, 2000) and PatternHunter (Ma et al., Bioinformatics, 18(3):440-445, 2002).

This full implementation of the Smith-Waterman algorithm in the ASC language using the ASC emulator is important for two reasons. The first is that it is a proof-of-concept that the SWAMP algorithm is able to be implemented and executed in a fully associative manner on the model it was designed for.

The second reason is that the code can be run to verify the correctness of the ASC code in the emulator. In addition, it has been used to validate the output from the implementations on the ClearSpeed hardware discussed in Section 7.

### Section 5

### Extended Smith-Waterman Using Associative Massive Parallelism (SWAMP+)

### 5.1 Overview

This section introduces three extensions for exact sequence alignment algorithms on the parallel ASC model. The three extensions introduced allow for a highly sensitive parallelized approach that extends traditional pairwise sequence alignment using the Smith-Waterman algorithm and help to automate knowledge discovery. As used herein, the term “sensitivity” means an algorithm's ability to deterministically find the highest scoring alignment. Algorithms that do not employ heuristics or approximations generally have a higher sensitivity. While using several strengths of the parallel ASC model, the new extensions produce multiple outputs of local subsequence alignments between two sequences. This is the first parallel algorithm that provides multiple non-overlapping, non-intersecting subsequence alignments with the accuracy of the Smith-Waterman algorithm. The parallel alignment algorithms extend the existing Smith-Waterman using Associative Massive Parallelism (SWAMP) algorithm (Steinfadt et al., IASTED's Computational and Systems Biology (CASB 2006), Dallas, Tex., pp. 38-43, 2006; Steinfadt and Baker, IEEE International Symposium on Parallel and Distributed Processing, pp. 1-8, 2008) and this work is dubbed SWAMP+.

The innovative approaches used in SWAMP+ quickly mask portions of the sequences that have already been aligned, as well as to increase the ratio of compute to input/output time, vital for parallel efficiency and speedup when implemented on additional commercial hardware. SWAMP+ also provides a semi-automated approach for the in-depth studies that require exact pairwise alignment, allowing for a greater exploration of the two sequences being aligned. No tweaking of parameters or manual manipulation of the data is necessary to find subsequent alignments. It maintains the sensitivity of the Smith-Waterman algorithm in addition to providing multiple alignments in a manner similar to BLAST and other heuristic tools, while creating a better workflow for the users.

This section introduces three new variations for pairwise sequence alignment that allow multiple local sequence alignments between two sequences. This is not sequence comparison between three or more sequences often referred to as “multiple sequence alignment.” These variations allow for a semi-automated way to perform multiple, alternate local sequence alignments between same two sequences without having to intervene to remove already aligned data by hand. These variations take advantage of the masking capabilities of the ASC model.

### 5.2 Single-to-Multiple SWAMP+Algorithm

This first extension is designed to find the highest scoring local sequence alignment between the query sequence and the “known” sequence. Once it finds the best local subsequence between the two strings, it then repeatedly mines the second string for additional local alignments, as shown in FIG. 8a.

When running the algorithm, the output from the first alignment is identical to SWAMP, which is the same output as Smith-Waterman. In the following k or fewer iterations, the Single-to-Multiple alignment (s2m) will repeatedly search and output the additional local alignments between the first, best local region in S1 with other non-intersecting, non-overlapping regions across S2. The parameter k is input or configurable by a user and is referred to herein as a subsequent alignment count.

The following discussion references the pseudocode for the Single-to-Multiple Local Alignment or s2m code. The changes and additions from SWAMP have a double star (**) in front of them.

### 5.2.1 Algorithm

Listing 5.1: SWAMP+ Single-to-
Multiple Local Alignment Algorithm (s2m)

| | |
|---|---|
| 1 | Read in S1 and S2 |
| 2 | In Active PEs (those with data values for S1 or S2): |
| 3 | Initialize the 2-D variable D[$], I[$], C[$] to zeros. |
| 4 | Shift string S1 |
| 5 | For every diag from 1 to m+n do in parallel { |
| 6 | Steps 4 - 9 Compute SWAMP matrix and max vals |

| | |
|---|---|
| 7 | Start at max_Val, max_PE // obtain the row and col indicies |
| 8 | diag = max_col_id |
| 9 | row_id = max_id |
| 10 | Output the vary last two characters that are aligned |
| 11 | While {C[$,diag]>0) and traceback_direction!= “x”{ |

| | |
|---|---|
| 12 | if traceback_direction == “c” then { |
| 13 | diag = diag − 2; row_id = row_id − 1 |
| 14 | **S1_in_tB[row_id] = TRUE |
| 15 | **S2_in_tB[diag − PEid] = TRUE} |
| 16 | if traceback_direction == “n” { |

| | |
|---|---|
| 17 | diag = diag − 1; row_id = row_id − 1 } |

| | |
|---|---|
| 18 | if traceback_direction == “w” { |

| | |
|---|---|
| 19 | diag = diag − 1; row_id = row_id } |

| | |
|---|---|
| 20 | Output C[row_id, diag], S1[row_id], S2[row_id, diag]} |
| 21 | **if S1_in_tB[$] = FALSE then { S1[$] = “Z”} |
| 22 | **if S2_in_tB[$] = TRUE then { S2[$] = “O”} |
| 23 | **Go to Step 2 while # of iterations < k or |

| | |
|---|---|
| 24 | maxVal < δ * overall_maxVal |

Algorithmically, the same initializing, calculating, and traceback are performed as in the SWAMP algorithm. Lines 8 and 9 use the stored values max-PE and max_Val, obtained by using ASC's fast maximum operation (MAXDEX) in the earlier SWAMP computation.

The loop in line 11 is predicated on the fact that the computed values are greater than zero and there are characters remaining in alignment to be output. As in SWAMP, the variable traceback_direction stores which of its three neighbors had the maximum computed value, its northwest or corner neighbor (“c”), the north neighbor (“n”), or the west (“w”). The directions come from the sequential Smith-Waterman representation, not the “skewed” parallel data moved for the ASC SWAMP algorithm. The sequential variables diag (for anti-diagonal) and row_id calculations line up to form a logical row and column index into the skewed S2 associative data (lines 12-18).

The first major change is at the traceback in line 12. When two residues are aligned, i.e. the traceback-direction =“c,” those characters in S1[row_id] and S2[diag-PEid] are masked as belonging to the traceback. The reason for the index manipulation in S2 is that S2 has been turned horizontally and copied into active PEs. Thus, which actual character of the second string is part of the alignment needs to be calculated and marked (line 12). For instance, if the last active PE in FIG. 3 matches the “G” in S1 to the “G” in S2, the string S1[5] is marked as being part of the alignment and S2[diag-PEid]=S2[9−5]=S2[4] are marked as well. Marking sequences while conducting a traceback allows the SWAMP+ to know which sequences to reset for masking purposes.

After the traceback completes, line 21 resets parts of S1 such that characters that are not in the initial (best) traceback will be changed (or reset) to the character “Z” which does not code for any DNA nor an amino acid; generically, such a character can be referred to as an excluded character—a character that does not appear in the set of characters found in S1 or S2. That way it essentially disables those positions from being aligned with S2. A similar action is taken to disable the region that has already been matched in S2, using the character “O” since that does not encode for an amino acid (another example of an excluded character). The characters in S2 that have been aligned are replaced by “O”s so that other alignments with a lower score can be discovered. The character “X” has been avoided because that is commonly used as a “Dont Know” character in genomic data. By not used the character “X,” incidental alignments with that character are avoided.

For the second through k^{th} iterations of the algorithm, S1 and S2 now contain “do not match to” or excluded characters. While S1 is directly altered in place, S2 is more problematic, since PEs holds a slightly shifted copy of S2. The most efficient way to handle the changes to S2 is to reinitialize the parallel array S2[$,0] through S2[$,m+n]. The technique used for efficient initialization, discussed in detail in (Steinfadt and Baker, IEEE International Symposium on Parallel and Distributed Processing, pp. 1-8, 2008), is to utilize the linear PE interconnection network available between the PEs in ASC and a temporary parallel variable named shiftS2[$]. This is the basic re-initialization of the S2[$,x] array, done for subsequent runs. By re-initializing, back propagation and then forward propagation actions are avoided.

The number of additional alignments is limited by two different parameters. The first input parameter is k, a subsequent alignment count, which indicates the number of additional local alignments sought. The second input parameter is a maximum degradation factor, δ. If the overall maximum local alignment score degrades too much, the program can be stopped by the multiplicative δ. When δ=0.5, the s2m loop will stop running when a subsequent new alignment score is 50% or lower than the initial (highest) alignment score. This control is implemented at line 23 to limit the number of additional alignments to those of interest and to reduce the time by not searching for undesired alignments.

### 5.3 Multiple-to-Single SWAMP+Algorithm

The Multiple-to-Single (m2s) alignment, demonstrated in FIG. 8b, will repeatedly mine the first input sequence for multiple local alignments against the strongest local alignment in the second string. One way to achieve this m2s output is to simply use the Single-to-Multiple variation but swapping the two input strings prior to the initialization of the matrix values at line 3 of the original SWAMP algorithm.

### 5.4 Multiple-to-Multiple SWAMP+ Algorithm

This is a complex and interesting extension of the SWAMP algorithm. The Multiple-to-Multiple, or m2m, will search for non-overlapping, non-intersecting local sequence alignments, as show in FIG. 8c. Again, this is not multiple sequence alignment with three or more sequences, but an in-depth investigative tool that does not require hand editing the different sequences. It allows for the precision of the Smith-Waterman algorithm, returning multiple, different pairwise alignments, similar to the results returned by BLAST, but without the disadvantages of using a heuristic.

The changes are marked by a** in the pseudocode. The main difference between the s2m and the m2m is when and how the excluded characters are masked off. First, to avoid overlapping regions once a traceback has begun, any residues involved, even if they are part of an indel, are marked so that they will be removed and not included in later alignments.

The other change is in Line 21. Values of the first string that are in an alignment should not be included in later alignments. Therefore, characters marked as TRUE are replaced with the “Z” non-matching character. This is the inverse set of excluded characters described for the Single-to-Multiple alignments. This allows for multiple local alignments to be discovered without human intervention and data manipulation. The goal is to allow for a form of automation for the end user while providing the “gold-standard” of alignment quality using the Smith-Waterman approach.

### 5.4.1 Algorithm

Listing 5.2: SWAMP+ Multiple-to-
Multiple Local Alignment Algorithm (m2m)

| | |
|---|---|
| 1 | Read in S1 and S2 |
| 2 | In Active PEs (those with data values for S1 or S2): |
| 3 | Initialize the 2-D variables D[$], I[$], C[$] to zeros. |
| 4 | Shift string S2 |
| 5 | For every diag from 1 to m+n do in parallel { |
| 6 | Steps 4 - 9 Compute SWAMP matrix and max vals |
| 7 | Start at max_Val, max_PE // obtain row and col indicies |

| | |
|---|---|
| 8 | diag = max_col_id |
| 9 | row_id = max_id |
| 10 | Output the very last two characters that are aligned |
| 11 | While (C[$,diag]>0) and traceback_direction!= “x”{ |

| | |
|---|---|
| 12 | **S1_in_tB[row_id] = TRUE |
| 13 | **S2_in_tB[diag − PEid] = TRUE |
| 14 | If traceback_direction == “c” then { |

| | |
|---|---|
| 15 | diag = diag − 2; row_id = row_id − 1} |

| | |
|---|---|
| 16 | if traceback_direction == “n” { |

| | |
|---|---|
| 17 | diag = diag − 1; row_id = row_id − 1 } |

| | |
|---|---|
| 18 | if traceback_direction == “w” { |

| | |
|---|---|
| 19 | diag = diag − 1; row_id = row_id } |

| | |
|---|---|
| 20 | Output C[row_id, diag], S1[row_id], S2[row_id, diag] |
| 21 | **if S1_in_tB[$] = TRUE then { S1[$] = “Z”} |
| 22 | If S2_in_tB[$] = TRUE then { S2[$] = “O”} |
| 23 | **Go to Step 2 while # of iterations < k |

| | |
|---|---|
| 24 | or maxVal < δ * overall_maxVal |

### 5.4.2 Asymptotic Analysis

The first analysis is using asymptotic computational complexity analysis based on the pseudocode and the actual SWAMP with traceback code.

As previously stated, the SWAMP algorithm presented in Section 4.2.2 runs in O(m+n) actions using m+1 PEs. A single traceback in the worst case would be the width of the computed matrix, m+n. This is asymptotically no longer than the computation and therefore only adds to the coefficient, maintaining a O(m+n).

The variations of Single-to-Multiple, Multiple-to-Single, and Multiple-to-Multiple would take the time for a single run times the number of desired runs for each sub-alignment, or k*O(m+n). The size of k is limited in that k can be no larger than the minimum(m, n) because there cannot be more local alignments than the number of residues. This worst case would only occur if every alignment is a single base long, where every other base being a match with an indel. This worst-case would results in an n*(m+n), and when m=n, a O(n²) algorithm.

This algorithm is designed for use on homologous sequences with affine gap penalties. The likelihood of the worst-case where every other base being a match with an indel is unlikely and undesirable in biological terms. Additionally, with the use of the δ parameter to limit the degree of score degradation, it is very remote that the worst case would occur since the local alignments of homologous sequences will be greater than a length of one, otherwise this algorithm should not be applied.

### 5.5 Further Embodiments

Alternatively, the algorithms and implementations would include the option to allow or disallow for overlap of the local alignments. This would entail reusing residues that are part of indels in the multiple-to-multiple variation. The reverse option would also be available for the single-to-multiple and multiple-to-single to disallow overlapping alignments. This can be relevant for searching regulatory regions. The capabilities to repeatedly mine m2m alignments can be combined, looking for multiple sub-alignments from the non-overlapping, non-intersecting regions of interest, as several biologists expressed interest in this. The idea is run a version of m2m followed by a special partitioning where s2m is run on one or more of the subsequences found in the initial m2m alignment. One embodiment of an m2m followed by an s2m is discussed in detail in the section below.

### 5.6 Multiple-to-Multiple Followed by Single-to-Multiple

In one embodiment of identifying multiple alignments in a pair of sequences, a first alignment between sequences S1 and S2, and additional sequences between sequences S1 and S2 can be produced, using a multiple-to-multiple algorithm as described herein. One such m2m method is described in Section 15. For one or more alignments produced by an m2m algorithm, additional alignments between S1 subsequences produced by the m2m algorithm and the S2 sequence. For respective of the S1 subsequences produced by the m2m algorithm for which a s2m analysis is to performed, the D, I and C values for the 2-D matrix are computed in parallel, wherein the 2-D matrix has been reinitialized such that respective of the columns of the 2-D matrix store characters corresponding to an anti-diagonal of the Smith-Waterman (S-W) matrix, but with the characters of the S1 and S2 sequences associated with the respective alignment reset to one or more excluded characters. This is done to mask the sequence characters included in the respective m2m alignment from the s2m alignment algorithm.

After the D, I and C values have been computed, a traceback of the 2-D matrix is conducted starting from a highest computed C value to produce a first subsequent alignment between characters in the S1 and S2 sequences. Then, characters in the S2 sequence are masked out based on the first subsequent alignment.

The computing and the conducting a traceback are then repeated at least one time to produce at least one additional subsequent alignment between the S1 and S2 sequences that does not overlap or intersect with the first subsequent alignment.

In some embodiments, the 2-D matrix is reinitialized for the respective alignments. In some embodiments, the S2 sequence characters can be masked out after production of an additional subsequent alignment to prevent those characters from being included in further alignments. In various embodiments, the first and additional subsequent alignments can be output to an output device of a computing system or stored on one or more computer-readable media.

In some embodiments, the s2m algorithm can be performed with the sequences switched. That is, the s2m algorithm can look for additional subsequences in the S1 sequence that aligns with S2 subsequences included in alignments produced by the m2m algorithm. Alternations to the above-described s2m algorithm further include masking characters of the S2 sequence rather than S1 sequence characters based on the first and additional subsequent s2m alignments.

### 5.6 ClearSpeed Implementation

SWAMP and SWAMP+ have been implemented on real, available hardware, an accelerator board from ClearSpeed. The hardware choice and rationale are discussed in the next section with a full description and analysis of the ClearSpeed implementation presented in Section 7 and the computer program listings incorporated herein by reference above.

### Section 6

### Hardware Survey for the Associative SWAMP Implementation

### 6.1 Overview

Since there is no commercial associative hardware currently available, ASC algorithms can be adapted and implemented on other hardware platforms.

The idea to use other types of computing hardware for Smith-Waterman sequence alignment has been developed in recent years for several platforms including: graphics cards (Liu et al., IEEE Transactions on Parallel and Distributed Systems, 18(9):1270-1281, 2007; Liu et al., BMC Research Notes, 2(1):73, 2009; Manayski and Valle, BMC Bioinformatics, 9(Suppl 2):S10, 2008; Nickolls et al., Queue, 6(2):40-53, 2008; Liu, et al., BMC Res Notes 3(93), 2010; Ligowski, et al., GPU Computing Gems, Emerald Edition, Morgan Kaufmann, pp. 155-157, 2011), the IBM Cell processor (Farrar, 2008; Szalkowski et al., BMC Res. Notes, 1(1):107, 2008; Rudnicki, et al., Fund Inform. 96, pp. 181-194, 2009), and on custom hardware such as the Parcel's GeneMatcher and the Kestrel Parallel processor (Di Blas et al., IEEE Transactions on Parallel and Distributed Systems, 16(1):80-92, 2005), and Convey's hybrid computing system (announced 5/2010). While useful, the technologies disclosed herein relate to the massively parallel associative model and optimization for that platform.

To allow for the migration of ASC algorithms, including SWAMP, onto other computing platforms, the associative functions specific to ASC have to be implemented. In the code provided herein, emulating the associative functionality allows for practical testing with full-length sequence data. The functions are: associative search, maximum search, and responder selection and detection as discussed in detail in 3.2.1-3.2.1. Another important factor is the communication available between processing elements.

Originally presented in Steinfadt and Schaffer (Ohio Collaborative Conference for Bioinformatics (OCCBIO), Case Western Reserve University, Cleveland, Ohio, 2009), a brief description of the four parallel architectures considered for ASC emulation are: IBM Cell Processors, field-programmable gate arrays (FPGAs), NVIDIA's general-purpose graphics processing units (GPGPUs), and the ClearSpeed CSX 620 accelerator. Preliminary work was completed for the Cell processor and FPGAs. A more in-depth study with specific mappings of the associative functionality specific to GPGPUs and the Clear Speed hardware are presented herein.

### 6.2 IBM Cell Processor

Developed by IBM and used in Sony's PlayStation 3 game console, the Cell Broadband Engine is a hybrid architecture that consists of a general-purpose PowerPC processor and an array of eight synergistic processing elements (SPEs) connected together through an element interconnect bus (EIB). Cell processors are widely used, not only in gaming but as part of computation nodes in clusters and large-scale systems such as the Roadrunner hybrid-architecture supercomputer. The Roadrunner was developed by Los Alamos National Lab and IBM (Barker et al., Proceedings of the 2008 ACM/IEEE Conference on Supercomputing (SC), vol. Austin, Tex. Piscataway, N.J., USA: IEEE Press, pp. 1-11, 2008) and listed as the number one fastest computer, as listed on Top500.org, November 2008 and in June 2009. The Cell has been used for several other bioinformatics algorithms including sequence alignment by (Farrar, 2008), SWPS3 by Szalkowski, et al. (BMC Res Notes 1(1):107, 2008) and CBESW by Wirawan, et al. (BMC Bioinformatics 9 (377) 2008), and Rudnicki, et al. (Fund Inform. 96, 181-194, 2009).

### 6.3 Field-Programmable Gate Arrays—FPGAs

A field-programmable gate array or FPGA is a fabric of logic elements, each with a small amount of combinational logic and a register that can be used to implement everything from simple circuits to complete microprocessors. While generally slower than traditional microprocessors, FPGAs are able to exploit a high degree of fine-grained parallelism.

FPGAs can be used to implement SWAMP+ in one of two ways: pure custom logic or softcore processors. With custom logic, the algorithm can be implemented directly at the hardware level using a hardware description language (HDL) such as Verilog or VHDL. This approach would result in the highest performance as it takes full advantage of the parallelism of the hardware. Other sequence alignment algorithms have been successfully implemented on FPGAs using custom logic and shown significant performance gains (Oliver et al., FPGA '05: Proceedings of the 2005 ACM/SIGDA 13th international symposium on Field-programmable gate arrays, vol. Monterey, Calif., USA. New York, N.Y., USA: ACM, pp. 229-237, 2005; Li et al., BMC Bioinformatics, 8: 185, 2007; Nawaz et al., Field-Programmable Technology (FPT), Beijing, pp. 454-459, 2010).

An alternative to pure custom logic is a hybrid approach using softcore processors. A softcore processor is a processor implemented entirely within the FPGA fabric. Softcore processors can be programmed just like ordinary (hardcore) processors, but they can be customized with application-specific instructions. These special instructions are then implemented with custom logic that can take advantage of the highly parallel FPGA hardware. Two companies, Mitrionics and Convey, currently support using FPGAs in this capacity. In May 2010, Convey announced its “hybrid-core computing architecture” implementation of Smith-Waterman with a 688 billion cell updates per second (GCUPS) benchmark for sequences short enough to fit in their on-board memory. This work is designed to overcome the necessity for a short sequence length by the high-throughput implementations.

### 6.4 Graphics Processing Units—GPGPUs

Another hardware platform to map the ASC model to is on graphics cards. The advent of higher and higher powered graphics cards that contain their own processing units, known as graphics processing units or GPUs, has led to many scientific applications being offloaded to GPUs. The use of graphics hardware for non-graphics applications has been dubbed General-Purpose computation on Graphics Processing Units or GPGPU.

The graphics card manufacturer NVIDIA released the Compute Unified Device Architecture (CUDA). It provides three key abstractions that provide a clear parallel structure to conventional C code for one thread of the hierarchy (Nickolls et al., Queue, 6 (2):40-53, 2008).

CUDA is a computing architecture, but also consists of an application programming interface (API) and a software development kit (SDK). CUDA provides both a low level API and a higher level API. The introduction of CUDA allowed for a real break from the graphics pipeline, allowing multithreaded applications to be developed without the need for stream computing. It also removed the difficult mapping of general-purpose programs to parts of the graphics pipeline. The conceptual decoupling allowed GPU programmers to no longer have values referred to as “textures” or to specifically use rasterization hardware. It also allows a level of freedom and abstraction from the hardware. One drawback with the relatively young CUDA SDK (initial release in early 2007) is that the abstraction and optimization of code is not as fully decoupled from the hardware as one might want. This causes optimization problems that can be difficult to detect and correct.

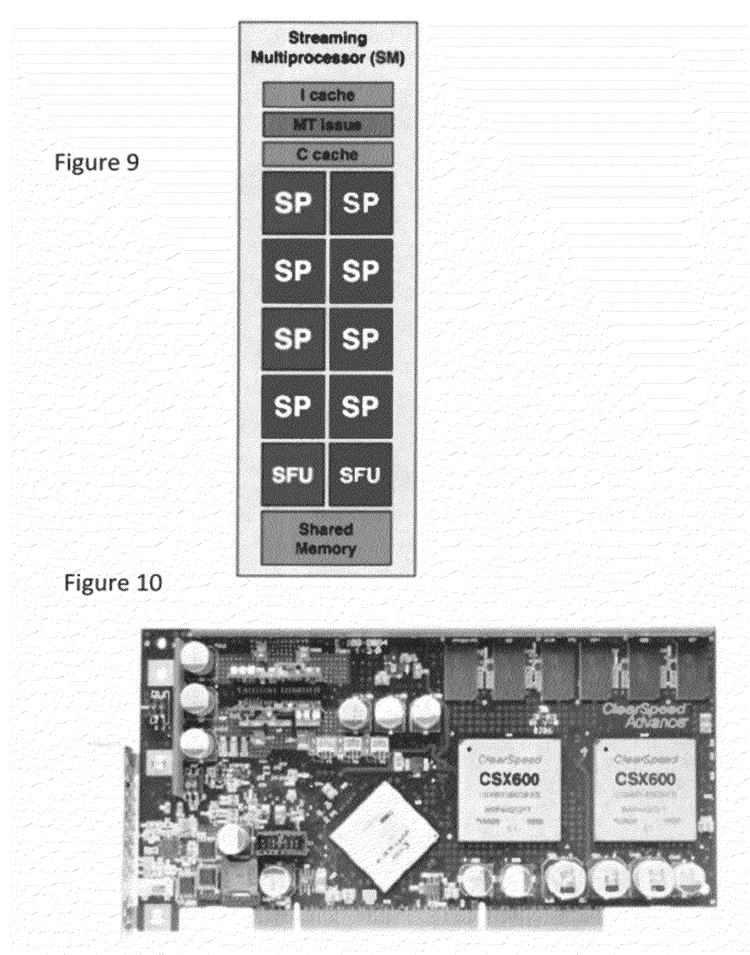

The GPGPUs have multiple levels of parallelism and rely on massive multithreading. Each thread has its own local memory, used to express fine-grained parallelism. Threads are organized in blocks that communicate through shared memory and are used for coarse-grained (cluster-like) parallelism (Fatica, Tutorial Slides presented at ACM/IEEE Conf. Supercomputing (SC), Austin, Tex., 2008). Every thread is stored within a streaming processor (SP), and every SP can handle 128 threads. Eight SPs are contained within each streaming multiprocessor (SM), shown in FIG. 9. While the number of SMs is scalable across the different types and generations of NVIDIA graphics cards, the underlying SM layout remains the same. This scalability is ideal as graphics cards change and are updated.

The specific compute-heavy GPGPU card with no graphics output is known as the Tesla series of cards. The Tesla T10 has 240 SP processors that each handle 128 threads. This means that there could be a maximum of 30,720 lightweight threads processed in parallel at one time (Fatica, Tutorial Slides presented at ACM/IEEE Conf. Supercomputing (SC), Austin, Tex., 2008). Another CUDA-enabled card may have only 128 SPs, but it can run the same CUDA code, only slower due to less parallelism.

Their overall organization is a single program (kernel), multiple data or SPMD model of computing, the same classification as MPI-based cluster computing.

Graphics cards have been used for years not only for the graphics pipeline to create and output graphics, but for other types of general-purpose computation, including sequence alignment (Manayski and Valle, BMC Bioinformatics, 9(Suppl 2): S10, 2008; Jung, BMC Bioinformatics 10(Suppl 7):A3, 2009; Ligowski and Rudnicki, in Proceedings of the 2009 IEEE International Symposium on Parallel Distributed Processing: IEEE Computer Society, pp. 1-8, 2009; Liu et al., BMC Research Notes, 2:73, 2009; Liu et al., BMC Research Notes, 3:93, 2010; Ligowski, et al., GPU Computing Gems, Emerald Edition, Morgan Kaufmann, pp. 155-157, 2011). Given the MPI-based computing approach, these cited methods focus on coarse-grained parallelism using multiple sequence databases to compare against.

### 6.4.1 Implementing ASC on GPGPUs

In view of their low cost and high availability, graphic cards or General Purpose Graphic Processing Unit programming (GPGPU) were carefully explored. The initial development hardware was on two NVIDIA Tesla C870 computing boards obtained through an equipment grant from NVIDIA. To map the ASC model onto CUDA, every PE would be mapped to a single thread. Due to the communication between PEs and the lockstep data movement common to SIMD and associative SIMD algorithms, communication between threads is necessary. This means that the threads need to be contained within the same logical thread block structure to emulate the PE Interconnection Network. Explicit synchronization and deadlock prevention is a necessary and difficult task for the programmer.

A second factor that limits an ASC algorithm to a single block is due to the independence requirement between blocks, where blocks can be run in any order. A thread block is limited in size to 512 threads, prematurely cutting short the level of parallelism that can be achieved on a GPGPU, effectively removing any power of scalability.

Mapping the ASC functions to CUDA is a more difficult than mapping ASC to the ClearSpeed CSX chip due to the multiple layers of hierarchy and multithreading involved. Also, the onus of explicit synchronization is on the programmer to manage.

Regardless of the difficulties, a successful and efficient mapping of the associative functions onto the NVIDIA GPGPU hardware would be ideal. GPUs are very affordable and massively parallel. The hardware has a low cost with many current computers and laptops containing CUDA-enabled graphics cards already, and the software tools are free. This could make the SWAMP+ suite available to millions with no additional hardware necessary. While a CUDA implementation for the Smith-Waterman algorithm is described in (Manayski and Valle, BMC Bioinformatics, 9(Suppl 2):S10, 2008) and extended in (Liu et al., BMC Research Notes, 2(1):73, 2009), SWAMP+ differs greatly from the basic Smith-Waterman algorithm and is not really comparable to (Manayski and Valle, BMC Bioinformatics, 9(Suppl 2):S10, 2008) and (Liu et al., BMC Research Notes, 2(1):73, 2009).

### 6.5 ClearSpeed SIMD Architecture

After the exploration and evaluation of the different hardware, ClearSpeed was chosen for transitioning SWAMP+ to commercially available hardware because it is a SIMD-like accelerator. It is the most analogous to the ASC model, therefore the associative functions were implemented for ClearSpeed's language Cⁿ.

This accelerator board, shown in FIG. 10 connects to a host computer through a PCI-X interface. This board can be used as a co-processor along with the CPU, or it can be used for the development of embedded systems that will carry the ClearSpeed processors without the board. Any algorithms developed on this board can, in theory, become part of an embedded system. Multiple boards can be connected to the same host in order to scale up the level of parallelism, as necessary for the application.

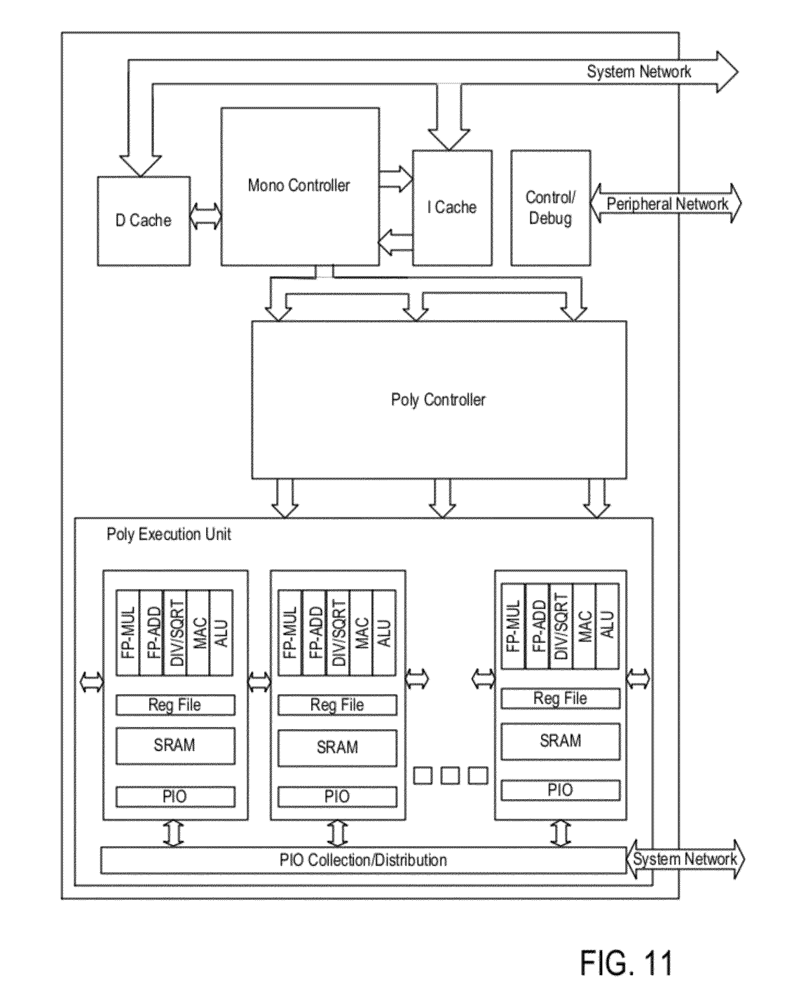

The ClearSpeed CSX family of processors is a family of SIMD co-processors designed to accelerate data-parallel portions of application code. Information on the ClearSpeed CSX processor family can be found on the ClearSpeed website. The CSX600 processor is based on ClearSpeed's MTAP or single instruction Multi-Threaded Array Processor, shown in FIG. 11. This is a SIMD-like architecture that consists of two main components: a control unit (called the mono execution unit) and an array of PEs (called the poly execution unit).

The two CSX600 co-processors on the board each contain 96 PEs for an overall total of 192 PEs. Every multi-threaded poly unit (PE) contains a 6 KB of SRAM local memory, superscalar 64-bit FPU, its own ALU, integer MAC, 128 byte register file, and I/O ports. The chips operate at 250 MHz, yielding a total of 33 GFLOPs DGEMM performances with an average power dissipation of 10 watts.

Algorithms are written in an extended C language, called Cⁿ. Close to C, Cⁿ has an important extension—the parallel data type poly. This allows the built-in C types and arrays to be stored and manipulated in the local PE memory. The software development kit includes ClearSpeed's extended C compiler, assembler, and libraries, as well as a visual debugger. More details about the architecture are available from the company's website, as well as in the ClearSpeed Technology CSX600 Runtime Software User Guide, also available from the ClearSpeed website.

As a SIMD-like platform, the CSX lacks the associative functions (maximum and associative search) utilized by SWAMP and SWAMP+ that ASC natively supports via the broadcast/reduction network in constant time (Huang and Miller, Adv. Appl. Math., 12(3):337-357, 1991). Associative functionality can be handled at the software level with a small slowdown for emulation. These functions have been written and optimized for speed and efficiency in the ClearSpeed assembly language.

An additional relevant detail about ASC is that the PE interconnection network is not specifically defined. It can be as complex as an Omega or Flip network, a fat tree, or as simple as a linear array. The SWAMP+ suite of algorithms can utilize a linear array to communicate with the northern neighboring PE for the north and northwest values that were computed previously. The ClearSpeed board has a linear network between PEs with wraparound. This is dubbed the swazzle network and is well suited with the needs of SWAMP and SWAMP+. The SWAMP+ algorithms also focus to increase the compute to I/O time ratio, making more use of the compute capabilities of the ClearSpeed. This is useful for overall speedup, amortizing the overall cost of computation and communication.

To reiterate, the ClearSpeed board is used to emulate ASC to allow for the broader use of the SWAMP algorithms and the possibility of running other ASC algorithms on available hardware. The ClearSpeed hardware has been used for associative Air Traffic Control (ATC) algorithms (Yuan et al., Parallel and Distributed Computing Systems (PDCS), Cambridge, M A, 2009; Yuan, et al., 24th IEEE International Parallel and Distributed Processing Symposium (IPDPS 2010), Atlanta, Ga., 2010), as well as for the SWAMP+ implementation, and results are presented in Section 7.

### Section 7

### SWAMP+Implementation on ClearSpeed Hardware

An implementation of SWAMP was completed on the ClearSpeed CSX620 hardware using the Cⁿ language. The code was then expanded to include SWAMP+ multiple-to-multiple comparisons.

### 7.1 Implementing Associative SWAMP+ on the ClearSpeed CSX

Because ASC is an extended SIMD, mapping ASC to the CSX processor is a relatively straightforward process. The CSX processor and accelerator board already have hardware to broadcast instructions and data to the PEs, enable and disable PEs, and detect whether any PEs are currently enabled (pickOne). This fulfills many of the ASC model's requirements. However, the CSX processor does not have direct support for computing a global minimum/maximum or selecting a single PE from multiple responders.

The CSX processor does have the ability to reduce a parallel value to a scalar using logical AND or OR. With this capability it is possible to use Falkoff's algorithm to implement minimum/maximum search. Falkoff s algorithm (Falkoff, J. of the ACM (JACM), 9 (4): 488-511, 1962) locates a maximum value by processing the values in bit-serial fashion, computing the logical OR of each parallel bitslice, eliminating from consideration those values whose bit does not match the sum. The algorithm is easily adapted to compute a minimum by first inverting all the value bits.

The pickOne operation selects a single PE when there are multiple responders. It can be implemented on the CSX processor by using the minimum/maximum operators provided by Cⁿ. Each PE has a unique index associated with it and searching for the PE with the maximum or minimum index will select a single, active PE.

With the pickOne and the minimum/maximum search operators emulated in software, the CSX processor can be treated as an associative SIMD. In theory, any ASC algorithm, like SWAMP+, can be adapted to run on the ClearSpeed CSX architecture using the emulated associative functions. More information about these functions is available in Appendix listing B.3.

The associative-like functions used in the ClearSpeed code have a slightly different nomenclature:
count—substitute for responder detection (anyResponders)
get_short—a type-specific pickOne operation for short integers
get.char—a type-specific pickOne operation for characters
max_int—maximum search functionality for integers

In many ClearSpeed applications, there are two code bases, one that runs on the host machine that is written in C (.c and .h file extensions) and the code that runs on the CSX processor is written in Cⁿ (.cn file extension). To communicate between the host and the accelerator, an application programming interface or API library is used. This code for the SWAMP+ interface is listed in the Appendix B.2 in the swampm2m.c file. The special functions are prefaced by CSAPI to indicate it is used for the ClearSpeed API. To pass data, two C-structs have been set up in swamp.h. They are explicitly passed between the host and the board using the CSAPI. It is the mono memory that is accessed by both, so that is where the parameters struct is passed into, and the result struct is read from.

The swampm2m.c program sets up the parameters for the Cⁿ program, sets up the connection to the board, writes the parameter struct to mono memory on the board and calls the corresponding swamp.cn program. Once the C program initializes the Cⁿ code, it waits for the board to send a terminate signal before reading the results back from the mono memory.

### 7.2 ClearSpeed Running Results

There are essentially two parts of the SWAMP+ code: the parallel computation of the matrix and the sequential traceback. The analysis first looks at the parallel matrix computation. This is often the only type of analysis that is completed for the parallel Smith-Waterman sequence alignment algorithms. The second half deals with the sequential traceback, reviewing the performance for the SWAMP+ extensions. For a more fair performance comparison between SWAMP with one alignment and SWAMP+ with multiple alignments, SWAMP+ is run with the condition that only a single alignment is desired. This is to compensate for minimal extra bookkeeping introduced in SWAMP+.

### 7.2.1 Parallel Matrix Computation

The logic in swamp.cn is similar to the pseudocode outline presented in Section 5.4. It initializes the data using the concept adapted from the wavefront approach for a SIMD memory layout. This is similar to the ASC implementation, except that the entire database sequence is copied at a time instead of using the stack concept that was utilized for optimization in ASC. This is possible due to the pointers available in Cⁿ, unlike the ASC language.

The computation of the three matrices for the north, west and northwestern values use the poly execution units and memory on a single CSX chip. The logical “diagonals” are processed, similar to the ASC implementation. Instead of being able to access the parallel variables directly in ASC by using the notation to current parallel location $ joined with an addition or subtraction operator followed by an index [$±i], the data must be moved between poly units (PEs) across the swazzle network. The swazzle functions are a bit tricky due to the fact that if something is swazzled out of or into a non-active PE, the values will become garbage. This is true for the utilized swazzle_up function.

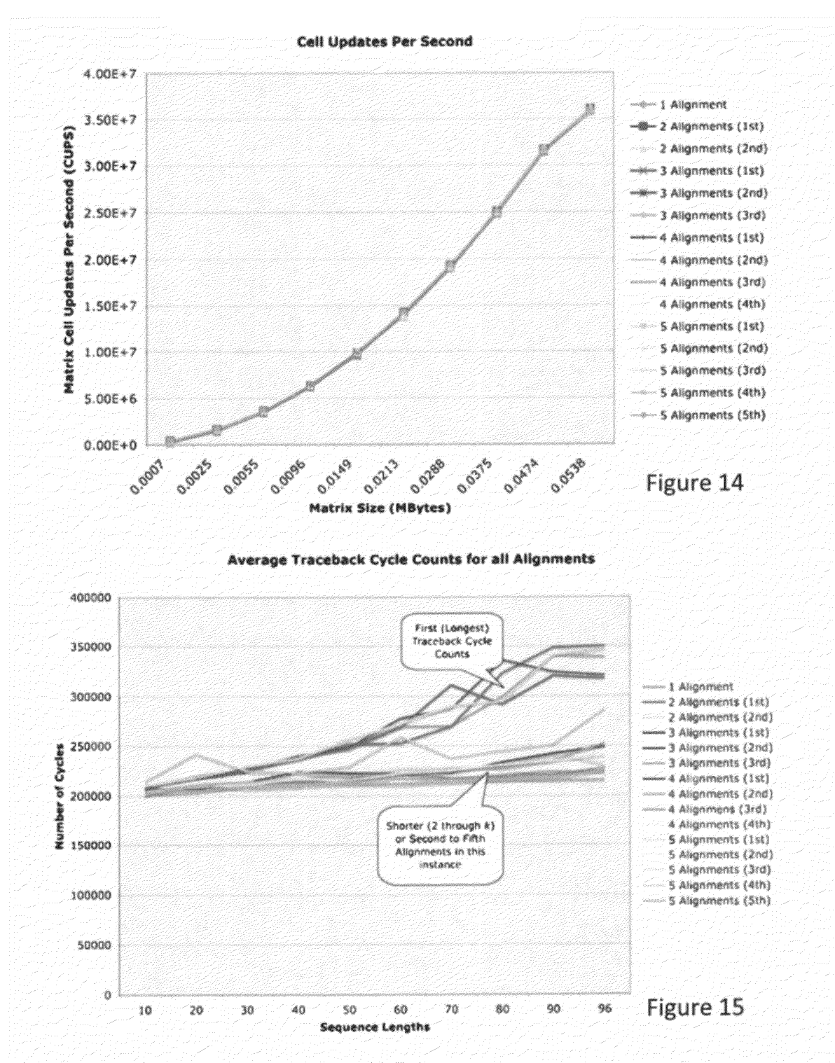

For performance metrics, the number of cycles were counted using the get_cycles( ) function. Running at 250 MHz (250 million cycles per second), timings can be derived, as is done for the throughput CUPS measurement in FIG. 14. The parameters used are suggested by the FASTA (see, FASTA search tutorial (available at the European Bioinformatics Institute web site)) for nucleotide alignments. The affine gap penalties are −10 to open a gap, −2 to extend. A match is worth +5 and the mismatch between bases is −4.

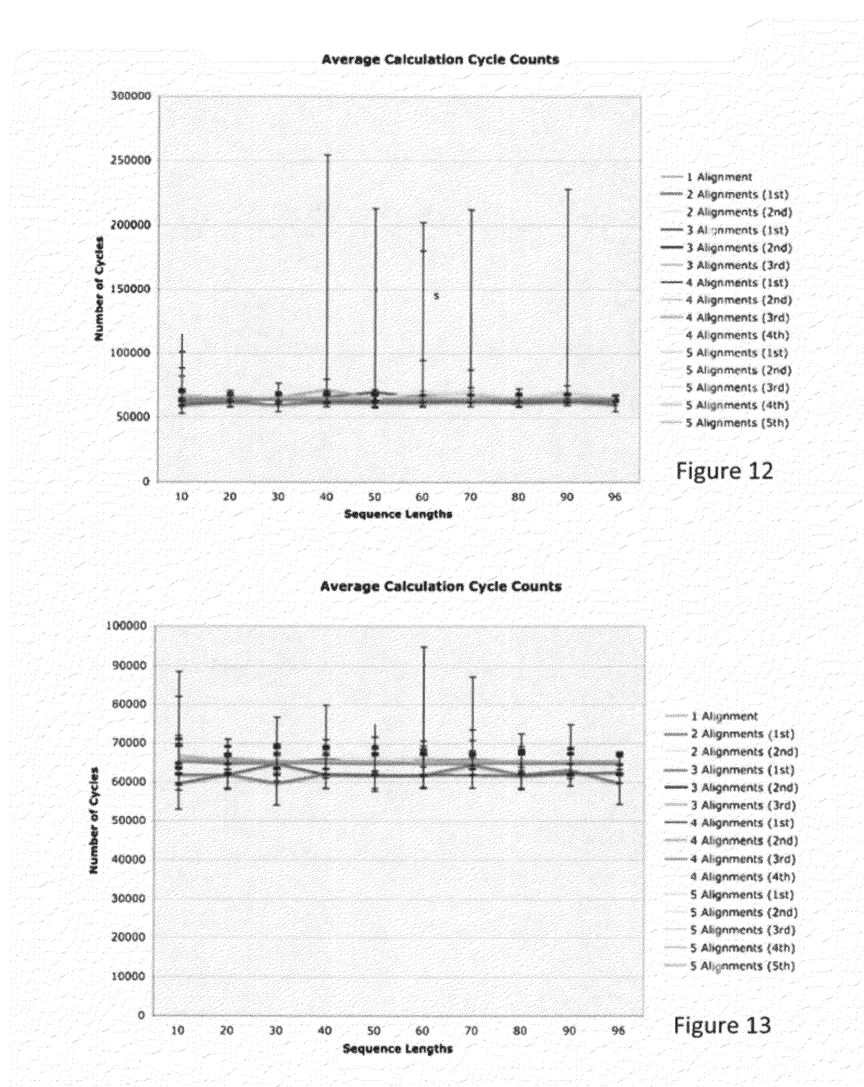

FIG. 12 shows the average number of cycles for computing the matrices. This is a parallel operation, and whether 10 characters or 96 characters are compared at a time, the overall cycle time is the same. This is the major advancement of the SIMD processing, showing that the theoretical optimal parallel speedup is achievable.

Error bars have been included on the first two plots to provide the extreme values since each data point is the arithmetic mean of thirty runs. In looking at the average lines and the y-axis error bars, one can see that there are eight outliers that skew the curves. These outliers are an order of magnitude larger than the rest of the cycle counts for the computation section. This is believed to be due to the nature of the test runs. Output was redirected into files that reside on a remote file server. These high numbers were not observed in tests with no file writing. Eight times out of over 4,500 runs (or 1 in 562.5 alignments) one alignment would have a much larger cycle count. These were not easily or uniformly reproducible.

To give a more clear perspective, the averages have been recomputed with these top eight outliers removed and is shown in FIG. 13. The second highest cycle count is used in the y-error bars. These second highest cycle counts are the same order of magnitude of the remaining 28 runs, pointing out that there is some operating system effect that occasionally affects the board's cycle count behavior.

To use a more standard metric, the cell updates per second or CUPS measurement has been computed. Since the time to compute the matrix for two sequences of length ten or length 96 is roughly the same on the ClearSpeed board with 96 PEs as shown in FIG. 14, the CUPS measurement increases (where higher is better) to the maximum aligned sequence lengths with 96 characters each. This is because the number of updates per second is greater as the length of the sequences grows while the execution time holds. For aligning two strings of 96 characters, the highest update rate is 36.13 million cell updates per second or MCUPS. This is higher than the highest CUPS rate (23.87 MCUPS) reached using a single node for two sequences of length 160 discussed in Section 8.

FIG. 14 shows that all of the CUPS rates are so close across the runs that they overlap in the graph. This performance measurement is often not a part of parallel sequence alignment algorithms. CUPS is a throughput metric, and the SWAMP+ performance is not groundbreaking for two reasons. First, this algorithm was not designed with a goal of optimizing throughput. Second, other algorithms do no traceback at all, let alone multiple sub-alignments. There are much different goals in the design and implementation. Therefore, the CUPS measurement is not the most accurate metric for this work.

Some example CUPS numbers for other implementations that are not equivalent to this work for several reasons including that use the matrix lookups for scoring when the disclosed technologies do not, as well as using an optimization called the “lazy F evaluation” where the computations for the northern neighbors are skipped unless determined later it may influence the final outcome. The numbers are taken from Farrar (Bioinformatics, 23(2):156-161, 2007) with the runs referred to as “Wozniak” (Wozniak, Comput Appl in the Biosciences (CABIOS),13(2):145-150, 1997), “Rognes” (Rognes and Seeberg, Bioinformatics, 16(8):699-706, 2000) and “Farrar” (Farrar, Bioinformatics, 23(2):156-161, 2007) looking at the average CUPS numbers.

In a case where the majority of northern neighbors had to be calculated using the BLOSUM62 scoring matrix, a gap opening penalty of 10 and a gap-extension penalty of 1, the average CUPS for Wozniak was 351 MCUPS, Rognes with 374 MCUPS and Farrar screaming in at 1817 MCUPS. Both Rognes and Farrar include a “lazy F evaluation.” Using the BLOSUM62 scoring matrix with the same penalties as before, more of the northern neighbors can be ignored, hence less computations per second resulting in a higher CUPS. Wozniak (with no lazy F evaluation) averaged 352 MCUPS, Rognes had 816 MCUPS, and Farrar with an average of 2553 MCUPS to 36.13 MCUPS for SWAMP+.

A full table presenting a more in-depth MCUPS comparison can be found in Hughey (Comput Appl in the Biosciences (CABIOS), 12:473-479, 1996) and (Rognes BMC Bioinformatics 12 (221), 2011).

### 7.2.2 Sequential Traceback

The second half of the code deals with actually producing the alignments, not just finding the terminal character of that alignment. Traceback is often overlooked or ignored by other parallel implementations such as described in: Farrar (Bioinformatics, 23(2):156-161, 2007), Farrar (“Optimizing smith-waterman for the cell broadband engine” 2008), Li et al. (BMC Bioinformatics, 8:185, 2007), Manayski and Valle (BMC Bioinformatics, 9(Suppl 2):S10, 2008), Rognes and Seeberg (Bioinformatics, 16(8):699-706, 2000), Szalkowski et al. (BMC Res. Notes, 1(1):107, 2008) and Wozniak (Comput Appl in the Biosciences (CABIOS),13(2):145-150, 1997). Innovative approaches described herein use the power of the associative search as well as reducing the compute to I/O time for finding multiple, non-overlapping, non-intersecting subsequence alignments.

The nature of starting at the maximum computed value in matrix of C values and backtracking from that point to the beginning of the subsequence alignment, including any insertions and deletions, is a sequential process. Therefore, the amount of time taken for each alignment depends on the actual length of the match. FIG. 15 shows that the first alignment takes the largest amount of time. This is because the initial alignment is the best possible alignment with a given set of parameters. The second through k^{th} alignments are shorter, therefore require less time.

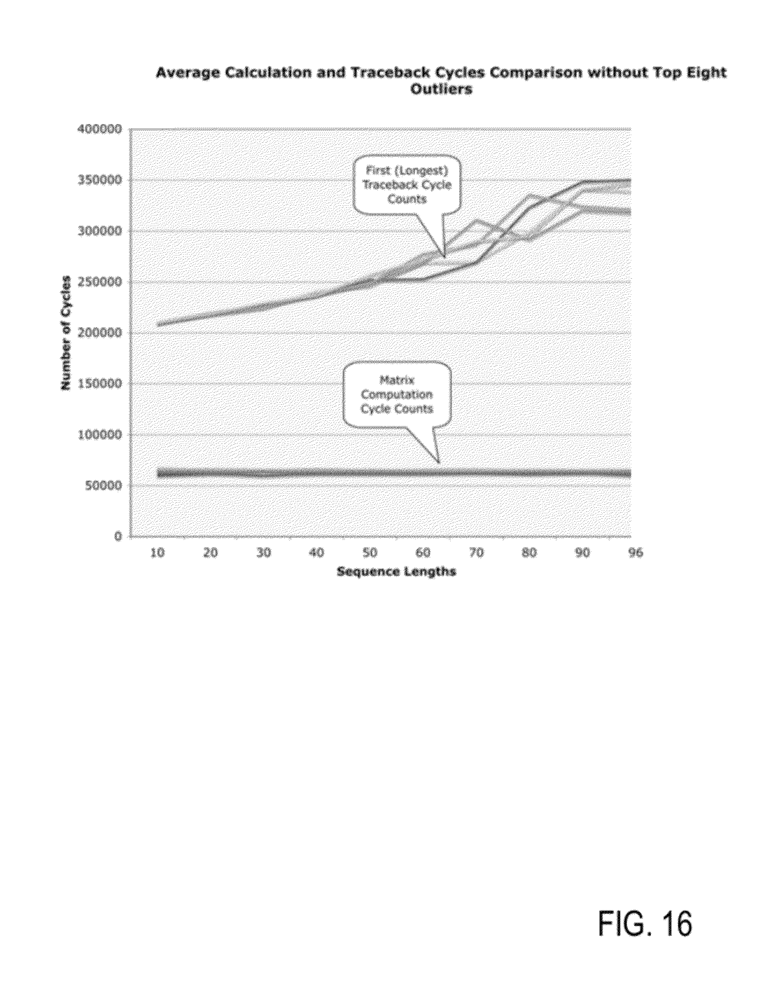

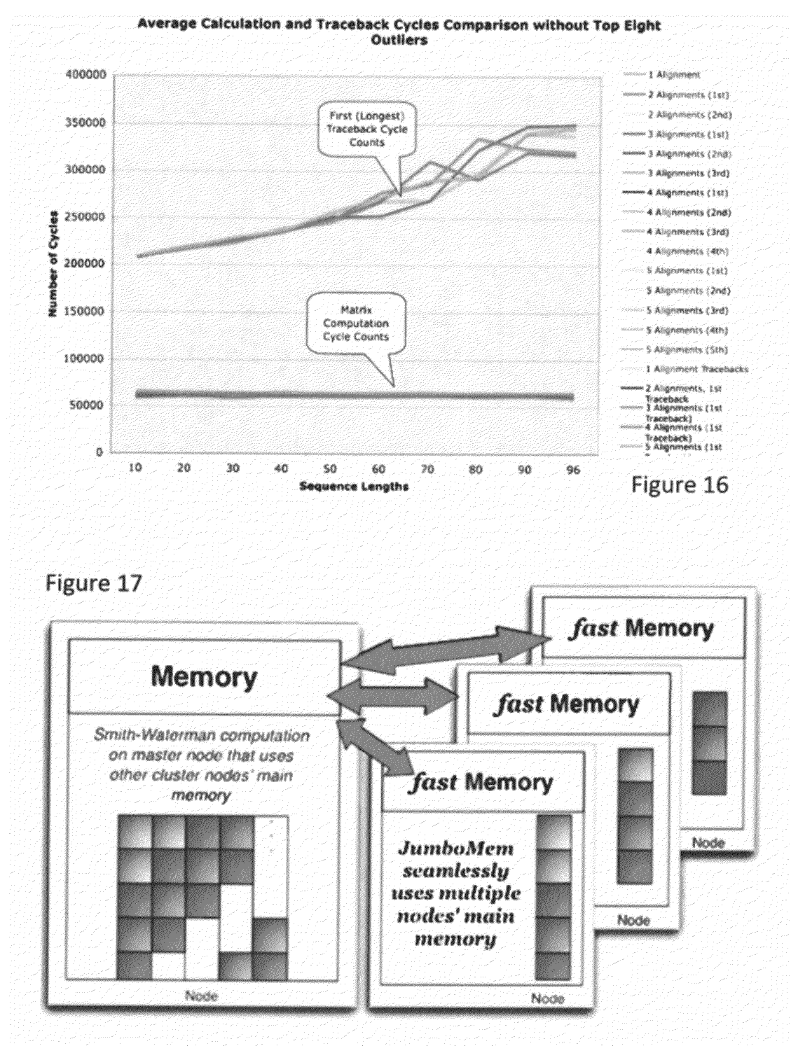

The trend shows that the overall time of the alignments given in cycle counts grow linearly with the size of the sequences themselves. These numbers confirm the expected performance of the ClearSpeed implementation that is based on the SWAMP+ASC algorithms. To get a better sense of how the two sections of Smith-Waterman performances compare, they are combined and shown in FIG. 16.

### 7.3 Conclusions

This section shows that the SWAMP and SWAMP+ algorithms can be successfully implemented, run and tested on hardware. The ClearSpeed hardware was able to provide up to a 96× parallel speedup for the matrix computation section of the algorithms while providing a fully implemented, parallel Smith-Waterman algorithm that was extended to include the additional sub-alignment results. The optimal parallel speedup possible was achieved.

### Section 8

### Smith-Waterman on a Distributed Memory Cluster System

### 8.1 Introduction

Since data-intensive computing is pervasive in the bioinformatics field, the need for larger and more powerful computers is ever present. With genome sizes of rice over 390 million and humans over 3.3 billion characters long, large data sets in sequence analysis are a fact of life.

A rigorous parallel approach generally fails due to the O(n²) memory constraints of the Smith-Waterman sequence alignment algorithm. (Optimizations that use only linear memory exist (see, e.g., Huang and Miller, J. Mol. Biol. 147(1):195-197, 1981) but the simple O(m*n) or O(n²) sized matrices are used to push the memory requirements for this work.)

The ability to use the Smith-Waterman sequence alignment algorithm with extremely large alignments, on the order of a quarter of a million characters and larger for both sequences, was investigated. Single alignments of the proposed large scale using the exact Smith-Waterman algorithm have previously been infeasible due to the intensive memory and high computational costs of the algorithm. Another advantage to the herein described approach is that it includes the traceback without later recomputation of the matrix. Traceback is often overlooked or ignored by other parallel implementations (e.g., Farrar, 2008; Li et al., BMC Bioinformatics, 8:185, 2007; Manayski and Valle, BMC Bioinformatics, 9(Suppl 2):S10, 2008; Rognes and Seeberg, Bioinformatics, 16(8):699-706, 2000; Szalkowski et al., BMC Res. Notes, 1(1):107, 2008, Wozniak, Comput Appl in the Biosciences (CABIOS), 13(2):145-150, 1997), but it would be infeasible in the envisioned problem-size domain. Whereas other optimization techniques have focused on throughput and optimization for a single core or single accelerator (Cell processors and GPGPUs), the boundaries of what can be aligned with a fully-featured Smith-Waterman, including the traceback, is pushed herein.

Large-scale is defined here as 250,000+ base pairs. For alignments this large, a full traceback requires an amount of memory far beyond a single computer. To avoid a drastic slowdown with paging to disk and some memory segmentation faults, JumboMem (Pakin and Johnson, Proceedings of the 2007 IEEE International Conference on Cluster Computing, IEEE Computer Society, 1545153 249-258, 2007) was used.

In the previous section, optimal speedup was achieved for the Clear-Speed implementation. A drawback is that the hardware is a limiting factor on the data sizes that could be run. The number of characters and values that fit within a single PE is limited to 6 KB of RAM. With a width of m+n for the character array and the number of data values for D, I and C to store, the memory limitation for the S2 string is limited to 566 characters with the current variables used. The other primary limitation is the number of PEs. If S1 is larger than 96, the number of PEs on a chip, one approach is to “double up” on the work that a single PE handles. This would allow up to 192 characters in S1. At the same time, it cuts the memory per PE available for the S2 values and computations in half, while increasing the complexity of the code with bookkeeping since there is no PE virtualization as was available on other parallel platforms such as the Wavetracer and Zephyr machines.

This limitation of sequence sizes to be aligned exists in recent cluster implementations. In October, 2010, SGI and Pervasive Software announced a Smith-Waterman implementation utilizing the Pervasive DataRush platform to scale across an SGI Altix UV 1000 with 384 cores to achieve a sustained throughput of 986 GCUPS.

DRC Computer Corporation announced in February, 2011 its benchmarks of a reconfigurable computing hardware claiming 9.4 trillion CUPS (TCUPS) achieved running 200 base-pair DNA reads against a 650,000,000 nucleotides database on a clustered server operating as a cloud computing environment. This implementation is limited to short enough sequences, as well as only using nucleotides and not proteins. Instead of focusing on throughput, this work focuses on achieving a larger single alignment, with an eye towards genome-to-genome alignment and subalignments. Using a cluster of computers and the SWAMP (or SWAMP+) algorithm(s), extremely large pairwise alignments have been performed, larger than would be possible on a single machine's main memory. The largest alignment run was roughly 330,000 by 330,000 characters, resulting in a completely in-memory matrix size of 107,374,182,400 elements. The initial results show good scaling and a promising scalable performance as larger sequences are aligned.

The following section reviews JumboMem, a program to enable unmodified sequential programs to access all of the memory in a cluster as though it were on a local machine. Presented are the results of using the Smith-Waterman algorithm with JumboMem, and introduce a discussion of future work for a hierarchical parallel Smith-Waterman approach that incorporates JumboMem along with Intel's SSE intrinsics and POSIX threads. A brief description of the MIMD parallel model is available in Section 3.1.1.

### 8.2 JumboMem

JumboMem (Pakin and Johnson, Proceedings of the 2007 IEEE International Conference on Cluster Computing, IEEE Computer Society, 1545153 249-258, 2007) allows an entire MIMD cluster's memory to look like local memory with no additional hardware, no recompilation, and no root access. This means that clusters and existing programs can be used in a larger scale manner with no additional development time or hassle.

The use of JumboMem is extensible to many large-scale data sets and programs that need verification. Using a rapid prototyping approach, a script can be used across a cluster without explicit parallelization. Combined with existing programs it can be remarkably useful to validate and verify results with large data sets, such as sequence assembly algorithms.

The motivation is to overcome the memory constraints of a fully working sequence alignment algorithm that includes the traceback for extreme-scale sequence sizes, as well as to avoid the time and effort to parallelize program code. Parallelizing code can and does act as a bar against using high-performance parallel computing. Researchers that do not have programmer support or already use executable code that is not designed for a cluster(s) can now run on a cluster using JumboMem without explicit parallelization. JumboMem is a tool to increase the feasible-to-run problem size and encouraging rapid and simplified verification of bioinformatics software.

JumboMem software gives a program access to memory spread across multiple computers in a cluster, providing the illusion that all of the memory resides within a single computer. When a program exceeds the memory in one computer, it automatically spills over into the memory of the next computer. This takes advantage of the entire memory of the cluster, not just within a single node. A simplified example of this is shown in FIG. 17.

JumboMem is a user-level alternative memory server. This is ideal when a user does NOT have administrative access to a cluster with a need to analyze large volumes of data without having to specifically parallelize the code, or even have access to the program codes (for instance, only an executable is available). In rapid prototyping and quick validation of results, improving or parallelizing the low-use scripts is not feasible. For all of those cases, the JumboMem tool can be invaluable.

One note is that JumboMem does not support programs that use the fork( ) command. A full description of JumboMem is outlined in (Pakin and Johnson, Proceedings of the 2007 IEEE International Conference on Cluster Computing, IEEE Computer Society, 1545153 249-258, 2007). The software and supporting documentation is available for download at the JumboMem sourceforge website.

To demonstrate how powerful this model is, the Smith-Waterman sequence alignment algorithm is used with JumboMem to align extreme-scale sequences.

### 8.3 Extreme-Scale Alignments on Clusters

The approaches described herein facilitates the alignment of very large data sizes via a rapid prototyping approach to allow the use of a cluster without explicit reprogramming for that cluster. Extremely large pairwise alignments have been performed on a cluster of computers than possible than on a single machine. The initial results show good scaling and a promising scalable performance as even larger sequences are aligned.

TABLE 1
PAL Cluster Characteristics

| Category | Item | Value |
|---|---|---|
| CPU | Type Cores Clock rate | AMD Opteron 270 2 |
| | | 2 GHz |
| Node | CPU sockets | 2 |
| | Count | 256 |
| | Motherboard BIOS | Tyan Thunder K8SRE (S2891) |
| | | LinuxBIOS |
| Memory | Capacity/node | 4 GB |
| | Type | DDR400 (PC3200) |
| Local disk | Capacity | 120 GB |
| | Type | Western Digital Caviar |
| | Cache size | 120 GB RE (WD1200SD) 8 MB |
| Network | Type | InfiniBand |
| | Interface Switch | Mellanox Infinihost III Ex (25218) |
| | | HCAs with MemFree firmware |
| | | v5.2.0 Voltaire ISR9288 288-port |
| Software | Operating system OS | Linux 2.6.18 Debian 4.0 (Etch) Open |
| | distribution Messaging | MPI 1.2 Slurm |
| | layer Job launch | |

### 8.3.1 Experiments

A cluster of dual-core AMD Opteron nodes has been used as the development platform. The details of the cluster are listed in Table 1.

A simple sequential implementation of the Smith-Waterman algorithm has been implemented in C, Python, and Python using the NumPy library. The C code was found to outperform the Python code in execution time, although the use of arrays through the NumPy library did improve the execution speed of the Python code considerably. Because the C version outperforms the Python versions, it is the focus the result discussion.

The C code uses malloc to allocate a block of memory for the arrays at the start of the program, after the sizes of the two strings are read in from a file. The sequential code creates the dynamic programming matrix to record the scores and output that maximum value. A second generation of testing did use affine gap penalties with the full traceback, returning the aligned, gapped subsequences.

Again, this code is not written for a cluster. It is a sequential C code, designed for a single machine. To run this code using the cluster's memory, JumboMem is used. That program is invoked, specifying the number of processor nodes to use followed by the call to the program code and any parameters that the program code requires. An example call is:
jumbomem -np 27./sw 163840.query.txt 163840.db.txt

This will run using 27 cluster nodes, the node where the code actually executes plus 26 memory “servers” for the two 163,840-element query and database strings. The second part of the call: ./sw 163840.query.txt 163840.db.txt is the call to the Smith-Waterman executable with the normal parameters for the sw program. The parameters to a sequential program remain unchanged when using JumboMem.

### 8.3.2 Results

Due to the nature of JumboMem, a large memory allocation at one time in the program versus a series of small allocations allows JumboMem to detect and “distribute” the values to other nodes' main memory more efficiently.

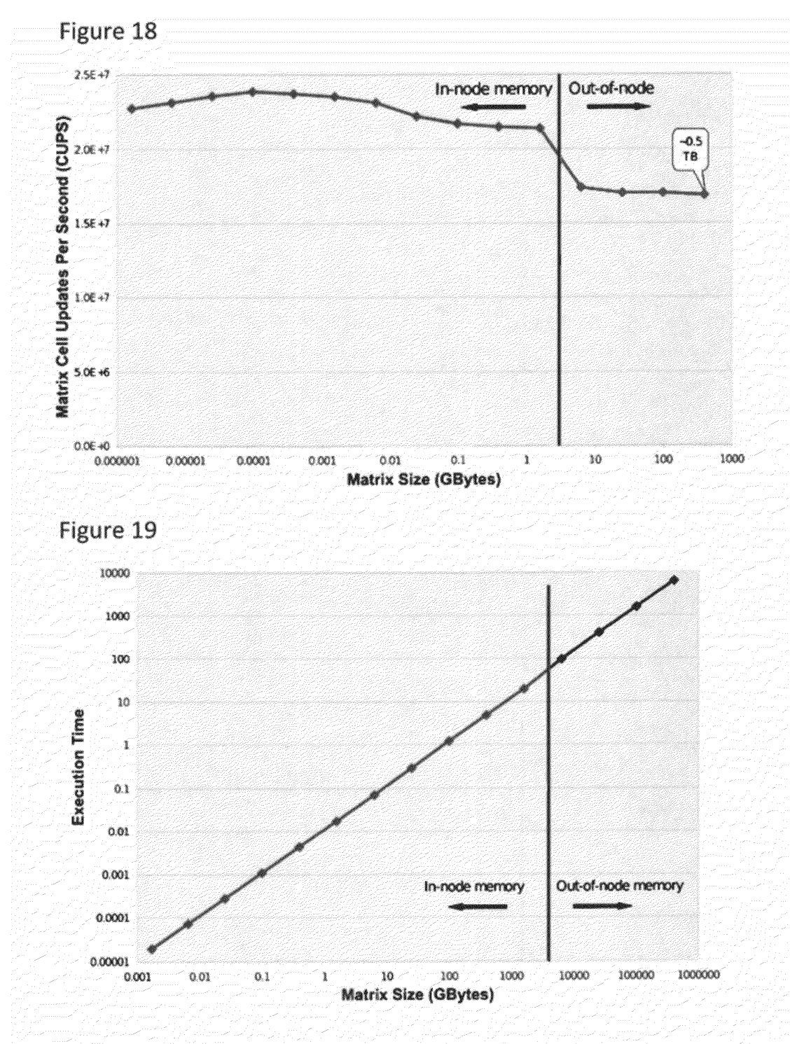

For the runs discussed herein, the total number of nodes used for the out-of-node memory ranged from 2 to 106 since not all of the nodes in the cluster were available for use. As shown in FIG. 18, there is a slight drop in the cell updates per second (CUPS) throughput metric once other nodes' memory starts being used. The drop in CUPS performance is less dramatic than it would be if the individual node had to page the Smith-Waterman matrices' values to the hard drive instead of passing it off to other nodes' memory via the network. Using JumboMem shows a performance improvement and enables larger runs using multiple nodes. In the present case, segmentation faults occurred when attempting to run the larger data sizes on a single node.

There is no upper limit to the memory size that JumboMem can use. The only limit is the available memory on the given cluster and the number of nodes within that cluster that it is run on. The largest Smith-Waterman sequence alignment run was with two strings approximately 330,000 characters long, resulting in a with a matrix of 330,000² (107,374,182,400) elements. There is over a half terabyte of memory used to run the last instance of the Smith-Waterman algorithm on the PAL cluster. This is believed to be one of the largest instances of the algorithm run, especially with no optimizations, such as the linear memory usage for the matrix storage.

The execution times for the C code are shown in FIG. 19. As the memory requirements grow beyond the size of one node, JumboMem is used. The execution times do not noticeably increase with JumboMem, whereas they would increase more with disk paging. Therefore, JumboMem helps to reduce the execution time, while allowing a larger problem instance to be run that may have otherwise failed with a segmentation fault since there was an insufficient amount of memory allocated, as was experienced.

Unlike many other parallel implementations of Smith-Waterman, this version provides the full alignment via the traceback section of the algorithm. Not only does it execute the traceback, it is designed to provide the full alignment between two sequences of extreme-scale.

The other advantage is that JumboMem allows an entire cluster's memory to look like local memory with no additional hardware, no recompilation, and no root access. This means that clusters and existing programs can be used in a larger scale manner with no additional development time.

This can be an invaluable tool for validating many large-scale programs such as sequence assembly algorithms, as well as to perform non-heuristic, in-depth, pairwise studies between two sequences. A script or existing program can be used on a cluster with no additional development. This is a powerful tool of itself, and combined with existing programs, it can be remarkably useful.

### 8.4 Conclusion

Using JumboMem on a cluster of computers, extremely large sequences using the exact Smith-Waterman approach were aligned. A full Smith-Waterman sequence alignment with two strings, each string approximately 330,000 characters long with a matrix containing roughly 107,374,182,400 elements was performed. This is considered to be one of the largest instances of the algorithm run while held completely in memory.

The combination of existing techniques and technology to enable the possibility of working with massive data sets is exciting and vital. JumboMem allows an entire cluster's memory to look like local memory with no additional hardware, no recompilation, and no root access. Existing non-parallel programs and rapidly developed scripts in combination with JumboMem on a cluster can enable program usage on a scale that was previously impossible. It can also serve as a platform for verification and validation of many algorithms with large data sets in the bioinformatics domain, including sequence assembly algorithms, such as Velvet (Zerbino and Birney, Genome Res, 18(5):821-829, 2008), SSAKE (Warren et al., Bioinformatics, 23(4):500-501, 10.1093/bioinformatics/bt1629, 2007), and Euler (Mulyukov and Pevzner, Pacific Symposium on Biocomputing (PSB), Hawaii, pp. 199-210, 2002) as well as for Alignment and Polymorphism Detection for applications such as BFAST (Horner et al., Bioinformatics, 10(1), 2009) and Bowtie (Langmead et al., Biol., 10(3):R25, 2009). This means that clusters and existing programs can be used in an extreme scale manner with no additional development time.

### Section 9

### Additional Embodiments

This section introduces a hierarchical parallelization for extreme-scale Smith-Waterman sequence alignment that uses Intel's Streaming SIMD extensions (SSE2), POSIX threads, and JumboMem in a “wavefront of wavefronts” approach to speed up and extend the alignment capabilities that are a growth from the work described in Section 8.

### 9.1 Hierarchical Parallelism for Smith-Waterman Incorporating JumboMem

The earlier section presented relatively easy, node-level parallelism through the use of JumboMem. This is a powerful tool to allow many programs and scripts to be used on data sets of huge sizes. While useful, the benefit may be incremental compared to fully parallelized code.

This is a discussion of current and future work where the goal is to create a scalable solution for Smith-Waterman that matches the increasing core counts and handles very large problem sizes. The desire is to be able to process full genome-length alignments quickly and accurately, including the traceback and returning the actual alignment. Approaches include parallelization at multiple levels: within a core, between multiple cores, and then between multiple nodes.

### 9.1.1 Within a Single Core

The first level of parallelization is within a single core. The dynamic programming matrix creates dependencies that limit the level of achievable parallelism, but using a wavefront approach can still lead to speedup.

The SSE intrinsics work is the first level of the multiple-level parallelism for extreme-scale Smith-Waterman alignments. In a multiple core system, each core uses a wavefront approach similar to (Wozniak, Comput Appl in the Biosciences (CABIOS), 13(2):145-150, 1997) to align its subset of the database sequence (S2). This takes advantage of the data independence along the minor diagonal.

### 9.1.2 Across Cores and Nodes

It is possible to combine the SSE wavefront approach over multiple cores. Within a single core, the SSE wavefront approach is used with the second level of parallelism using Pthreads to distribute and collect the sub-alignment across the multiple cores.

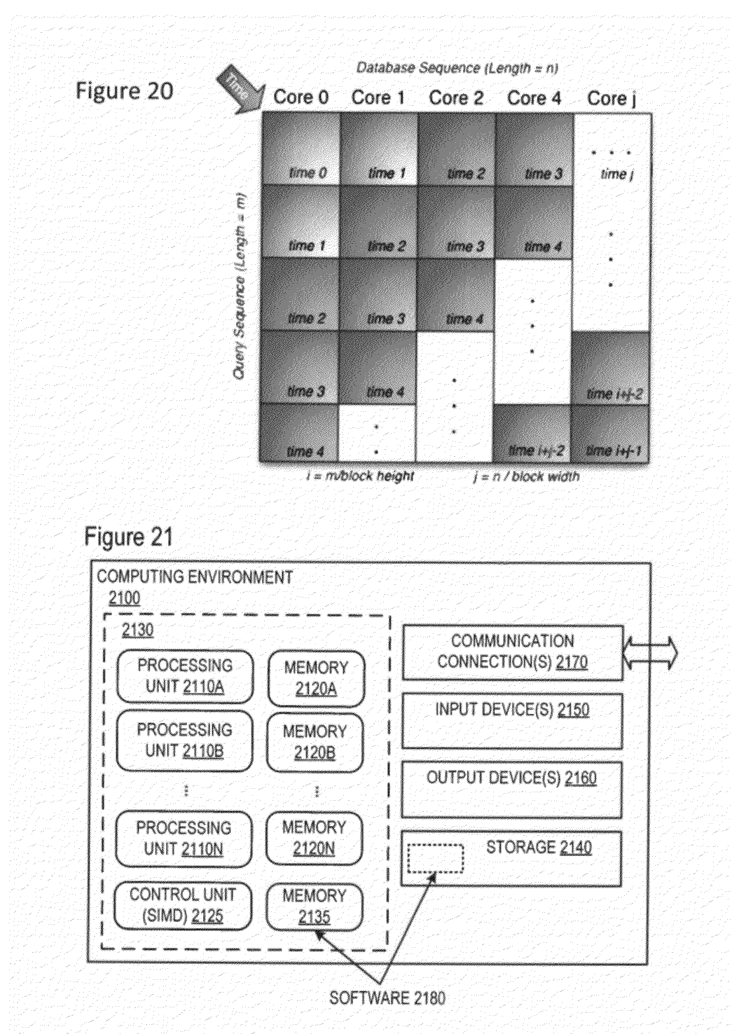

The approach is termed a “wavefront of wavefronts” and abstractly represented in FIG. 20. The first core (Core 0) computes and stores its values in a parallel wavefront. Once the first core completes its first subset of the query sequence block, the data on the boundaries is exchanged via the shared cache with Core 1. Core 1 has the data it needs to begin its own computation. Concurrently, Core 0 continues with its second block, computing the dynamic programming matrix for its subset of the sequence alignment. To share and synchronize data, POSIX Threads (Pthreads) are used between the cores.

Shown in FIG. 20, the cores are represented as columns and a “block” represents a partial piece of the overall matrix computed in a given time interval. Looking at the pattern, blocks across the different cores are computed in parallel (concurrently) along the larger, cross-core wavefront or minor diagonal. This is where the term a “wavefront of wavefronts” originates. It is of interest to look at the scalability of both sequence sizes and the growing number of available cores in this developmental system.

In an exemplary method of a “wavefront of wavefront” method of aligning sequences in a multi-core computer system, computing in parallel deletion values (D values), insertion values (I values) and match values (C values) are computed in parallel for a plurality of blocks of a 2-D matrix storing characters corresponding to portions of anti-diagonal of a Smith-Waterman (S-W) matrix formed from sequences S1 and S2, respective of the sequences S1 and S2 representing information sequences comprising strings of at least two characters. The blocks are arranged in a 2-D block matrix, the computing in parallel is performed by one or more processing cores of a computing system, the one or more processing cores arranged logically adjacent to one another in a left-to-right manner. Respective of the processing cores are configured to compute in parallel the D, I and C values for one block at a time, and, upon completing the computing for one of the blocks, passing the computed D, I and C values for the upper-most column of the respective core to the processor to the respective processor's logical right for use as seed values, and using the computed values in the lowest row of the respective core as seed values for processing its upper row when processing the next block. Respective of the blocks successively process blocks belonging to a column of the 2-D matrix in a top-to-bottom manner. The blocks are processed one anti-diagonal of the 2-D block matrix at a time in order from the upper left to the lower right of the 2-D block matrix, the blocks belonging to an anti-diagonal of the 2-D block matrix being processed simultaneously by the one or more processing cores.

After the D, I and C values have been computing for the 2-D matrix, a traceback analysis of the 2-D matrix is conducted starting from the highest computed C value, to produce a first alignment between characters in the sequences S1 and S2. Proposed extensions include using the striped access method from (Farrar, Bioinformatics 23(2):156-161, 2007) termed “lazy F evaluation” of the north neighbor, as well as to use linear space matrices O(n) space requirements over the full matrix of O(n²), such as those presented in (Huang and Miller, Adv. Appl. Math., 12(3):337-357, 1991) and referenced in (Hughey, Comput Appl in the Biosciences (CABIOS), 12:473-479, 1996); Nawaz et al., Field-Programmable Technology (FPT), Beijing, pp. 454-459, 2010). This is also highly relevant to the SWAMP+ in ASC and on ClearSpeed as well.

Both ParAlign (Saebo et al., Nuc Acids Res, 33(suppl 2):W535-W539, 2005) and this work use SSE and Pthreads, but the first level of parallelism differ. At the SSE level, (Saebo et al., Nuc Acids Res, 33(suppl 2):W535-W539, 2005) does not use a wavefront approach. Another aspect that is very different is ParAlign uses the cluster parallelism to handle multiple, different query sequences, not parts of a single large sequence as the wavefront of wavefronts approach does.

The possibility of a multiple-level parallelism with a “wavefront of wavefronts” approach that is a feasible design for faster Smith-Waterman quality extreme-scale sequence alignments using multiple cores and multiple nodes.

This work is related to other wavefront algorithms, such as Sweep3D (Wasserman, “ASCI SWEEP3D readme file” (1999)), a radiation particle transport application that exhibits similar data dependencies to Smith-Waterman. This work is valuable in its own right and may be applicable the particle physics modeling.

### 9.2 Further SWAMP+Work

As stated at the end of Section 5, there are two aspects of continuing and future work. The first is to combine the Multiple-to-Multiple (m2m) SWAMP+ extension with the Single-to-Multiple (s2m) extension. This enables an in-depth study of the repeating regions, looking for multiple sub-alignments from non-overlapping, non-intersecting regions of interest. This asks where the sections of interest are and will look to see if they in fact repeat.

The second item for future work is to evaluate another hardware platform for implementing SWAMP+ on. NVIDIA's Fermi architecture seems to have similarities to ClearSpeed's MTAP architecture. Success of the ClearSpeed implementation of ASC algorithms, including SWAMP+ encourages exploration of the associative functions and adaptation of SWAMP+ for wider availability.

### Section 10

### Concluding Discussion

The ASC model is a powerful paradigm for algorithm development. With low overhead cost, ASC can be emulated on multiple parallel hardware platforms. These strengths, combined with its tabular nature, led to the development of the associative version for the dynamic programming Smith-Waterman sequence alignment algorithm known as SWAMP.

Contributions include the ground-up design and implementation of SWAMP using the ASC model, programming language, and emulator. From this work, a SWAMP+ suite of algorithms were created to discover non-overlapping, non-intersecting sub-alignments for ASC with three options: single-to-multiple, multiple-to-single, and multiple-to-multiple sub-alignment discovery. The initial idea was to reuse the data and computations in conjunction with associative searching for finding the sub-alignments. While the later design of SWAMP+ requires recalculation of the matrices, it still takes advantage of the massive parallelism and fast searching with responder detection and selection features.

Since ASC is a model and does not exist as fully-featured hardware, possible current parallel hardware for ASC emulation was surveyed. After choosing the Clear-Speed CSX600 chip and accelerator board as the best platform for emulating ASC, SWAMP and SWAMP+ were implemented as a proof-of-concept using Clear-Speed's Cⁿ programming language. The result is an optimal speedup of up to 96 times for the parallelized matrix computations using 96 PEs. SWAMP+ provides a full parallel Smith-Waterman algorithm that was extended to include the additional non-overlapping, non-intersecting sub-alignment results of three different flavors.

To address the challenge of data- and memory-intensive computing that is so pervasive in the bioinformatics field, an innovative use of clusters was explored. Desiring to overcome the memory constraints of a fully-working, highest-quality sequence alignment with the traceback in extreme-scale sequence sizes, a cluster of computers' memory was made to look like a single large virtual memory. The tool used is called JumboMem. It transparently utilized multiple cluster node memory to allow extremely large sequence alignment. These tests are believed to be among the largest non-optimized versions of Smith-Waterman ever to run, all while in memory.

Overall, this work developed new tools shown to work for bioinformatics. These massively parallel approaches for sequence alignment have the potential to be applied in other fields, including particle physics and text searching.

### Section 11

### First Exemplary Computing Environment

FIG. 21 illustrates a generalized example of a first exemplary computing environment 2100 in which the described techniques can be implemented. The parallel computing environment 2100 is not intended to suggest any limitation as to scope of use or functionality, as the technologies may be implemented in diverse general-purpose or special-purpose computing environments. A mainframe environment will be different from that shown, but can also implement the technologies and can also have computer-readable media, one or more processors, and the like.

With reference to FIG. 21, the computing environment 2100 includes at least two parallel processing units 2110A and 2110B (through optional parallel processing unit 2110N) and parallel memories 2120A and 2120B (through optional memory 2120N). Collectively, the parallel memories 2120A-2120N comprise a parallel memory. The computing environment 2100 can be, for example, a SIMD environment in which the processing units 2110A-2110N are processing elements (PEs). In general, a PE is an arithmetic processing element that can fetch and store data from an associated local memory (e.g., memory 2120A, 2120B) but typically does not have the ability to compile or execute a program. In other embodiments, the computing environment 2100 can be an MIMD environment in which the processing units 2110A-2110N are general purpose processors configured to compile and execute a program and having access to an associated local memory. In SIMD embodiments, the computing environment 2100 further comprises a control unit 2125 configured to handle the compiling and executing of programs executed by the PEs. In FIG. 21, this basic configuration 2130 is included within a dashed line. The processing units 2110A-2210N execute computer-executable instructions and may be real or virtual processors. In a multi-processing computing system, such as a SIMD or MIMD system, the multiple processing units execute computer-executable instructions to increase processing power. The memories 2120A, 2120B . . . 2120N can store data that is acted upon by the processing units 2110A-211N. A separate memory 2135 can store software 2180 implementing any of the technologies described herein. The memories 2120A, 2120B . . . 2120N, and 2135 can be volatile memory (e.g., registers, cache, RAM), non-volatile memory (e.g., ROM, EEPROM, flash memory, etc.), or some combination of the two.

In SIMD environments, the control unit 2135 provides an instruction stream to the processing elements via a broadcast/reduction network, and the memories 2120A-2120N are connected via a PE interconnection network, such as a linear array, a 2-D mesh, or hyper cube that provides parallel data movement between the PEs. The broadcast/reduction network and the PE interconnection network are not shown in FIG. 21, but the logical relationship between these elements can be better understood with reference to FIG. 3.

A computing environment in which the technologies described herein can be implemented may have additional features. For example, the computing environment 2100 includes storage 2140, one or more input devices 2150, one or more output devices 2160, and one or more communication connections 2170. An interconnection mechanism (not shown) such as a bus, controller, or network interconnects the components of the computing environment 2100. Typically, operating system software (not shown) provides an operating environment for other software executing in the computing environment 2100, and coordinates activities of the components of the computing environment 2100.

The storage 2150 can be removable or non-removable, and includes magnetic disks, magnetic tapes or cassettes, CD-ROMs, CD-RWs, DVDs, or any other computer-readable media which can be used to store information and which can be accessed within the parallel computing environment 2100. The storage 2140 can store software 2180 containing instructions for any of the technologies described herein.

The input device(s) 2150 may be a touch input device such as a keyboard, mouse, pen, or trackball, a voice input device, a scanning device, or another device that provides input to the computing environment 2100. For audio, the input device(s) 2150 may be a sound card or similar device that accepts audio input in analog or digital form, or a CD-ROM reader that provides audio samples to the computing environment. The output device(s) 2160 may be a display, printer, speaker, CD-writer, or another device that provides output from the computing environment 2100.

The communication connection(s) 2170 enable communication over a communication mechanism to another computing entity, such as other computing environments to increase the parallel processing capabilities of the computing environment 2100. The communication mechanism conveys information such as computer-executable instructions, audio/video or other information, or other data. By way of example, and not limitation, communication mechanisms include wired or wireless techniques implemented with an electrical, optical, RF, infrared, acoustic, or other carrier.

The computing environment 2100 can be implemented as one or more physical computing devices. In one embodiment, the computing environment 2100 can be a computing system comprising the components shown in FIG. 21 (i.e. the processing elements 2110A-N, the memories 2120A-2120N, input devices 2150, output 2160 and the storage 2140, and, if the system is a SIMD system, the control unit 2125). In other embodiments, the parallel computing environment comprises multiple physically separate computers connected by communication connections. For example, the processing units 2110A-2110N and associated memories 2120A-2120N can be distributed across the physically separate computers. In a SIMD system, the control unit 2125 in one of the computers control the behavior of PEs located in multiple remote computers.

The techniques herein can be described in the general context of computer-executable instructions, such as those included in program modules, being executed in a computing environment on a target real or virtual processor. Generally, program modules include routines, programs, libraries, objects, classes, components, data structures, etc., that perform particular tasks or implement particular abstract data types. The functionality of the program modules may be combined or split between program modules as desired in various embodiments. Computer-executable instructions for program modules may be executed within a local or distributed computing environment.

### Section 12

### Second Exemplary Computing Environment

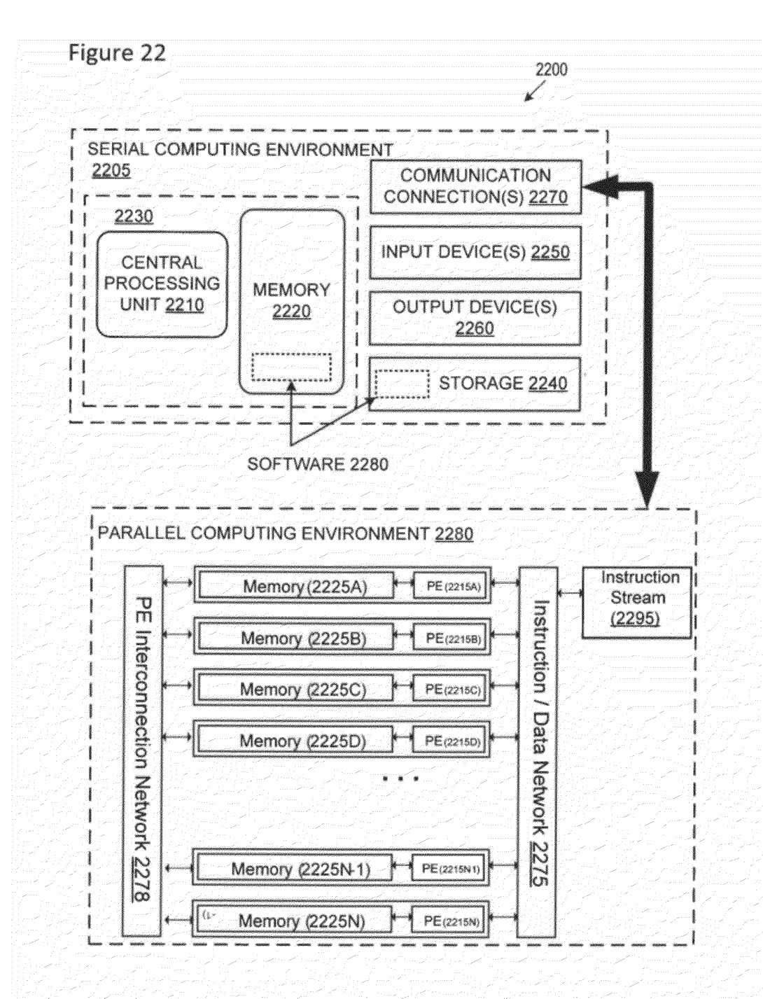

FIG. 22 is a conceptual view of a second exemplary parallel computing environment 2200 comprising a serial computing environment 2205 and a parallel computing environment 2280. The serial computing environment 2205 is similar to the computing environment 2100 except that the serial computing environment 2205 is not configured for parallel processing and comprises a single central processing unit 2210 and an associated memory 2220. The serial computing environment is connected to the parallel computing environment 2280 using communication connections 2270. In some embodiments, the parallel computing environment 2280 is a parallel accelerator that works as a hardware addition to the classic serial computing environment 2205. Program instructions and data can be moved from the serial computing environment 2205 to the parallel computing environment 2280.

The parallel computing environment 2280 can be parallel acceleration hardware connected to the system, and can be a SIMD system as shown in FIG. 22. That is, the parallel computing environment 2280 can comprise a plurality of processing elements (PEs) 2215A-2215N with associated local memories 2225A-2225N. That PEs can execute an instruction stream 2295 provided by a control unit (not show), and provided to the PEs via a responder/reduction network 2275. The memories can communicate via a PE interconnection network 2278. Instructions are executed in parallel by processing elements 2215A-N and results are returned to the serial computing environment 2205 for further processing, user display and/or long-term storage.

### Section 13

### First Exemplary Method of Aligning Sequences Using the SWAMP+Algorithm

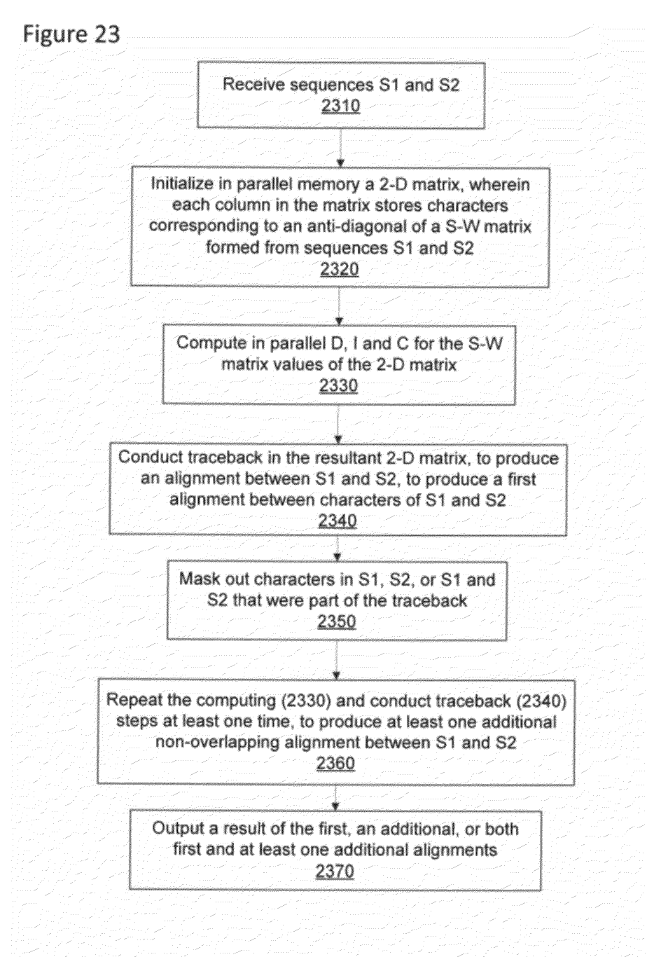

FIG. 23 is a flow chart of a first exemplary method of aligning sequences according to the SWAMP+ algorithm. Two strings (a.k.a. sequences, e.g., S1 and S2) are input (2310) and then a staggered 2-D matrix across the PE's individual memories is initialized with the second string's data in parallel (2320). In a wavefront, or anti-diagonal fashion, the values of D, I and C are computed for the matrix in parallel (2330). The traceback is performed (2340) across the computed values in PE's memory from 2330. Characters are masked off (2350) to allow for the continued analysis of two strings. This allows for additional, non-overlapping, non-intersecting alignments to be discovered (2360). Through masking and re-alignment, an automated process has been created to remove the need for doing altering the strings by hand to produce further sequences of interest. Optionally, the result of at least one of the alignments is outputted, for instance in a form of display or print.

### Section 14

### Exemplary Method of Aligning Sequences to Produce a Single Alignment Using the SWAMP Algorithm

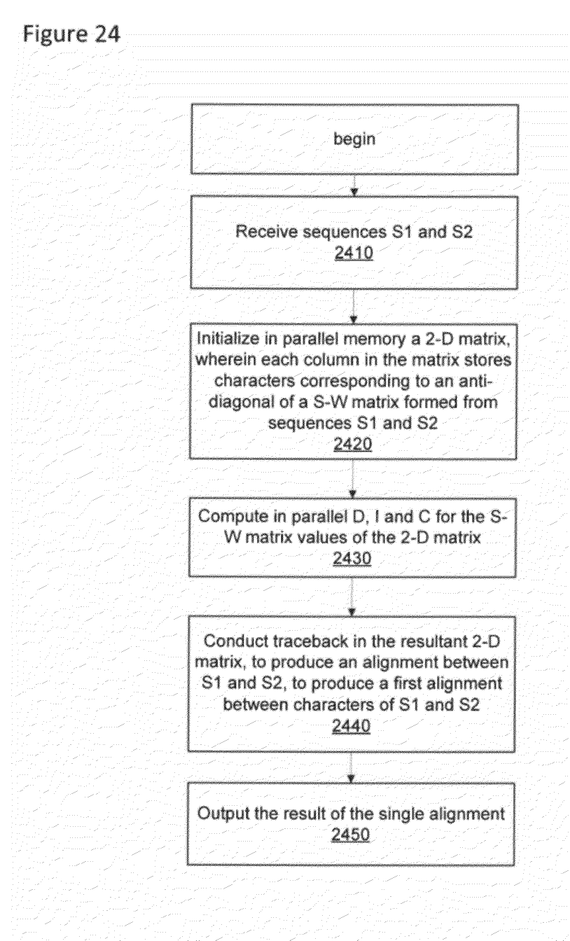

FIG. 24 is a flow chart of an exemplary embodiment of aligning sequences to produce a single alignment using the SWAMP algorithm. The illustrated method is a parallel algorithm that produces a single alignment. With the same input and parameters (2410), this algorithm will return the same results as the original Smith-Waterman and Gotoh algorithms where the underlying computation organization (2420) has been altered to allow for parallel computations and improved performance. The parallel shifting of data and computations in 2420 allow what was an anti-diagonal or wavefront in the original algorithm. The D, I and C matrices for the Smith-Waterman matrix are then solved (2430), a traceback is conducted (2440) to produce an alignment between the received sequences, and the alignment is output (2450). In some embodiments of the method illustrated in FIG. 24, the initializing (2420) and the computing (2430) are tailored for an associative SIMD model and comprise data distribution and an order of computations unique to the SWAMP algorithm.

### Section 15

### Second Exemplary Method of Aligning Sequences Using the SWAMP+Algorithm

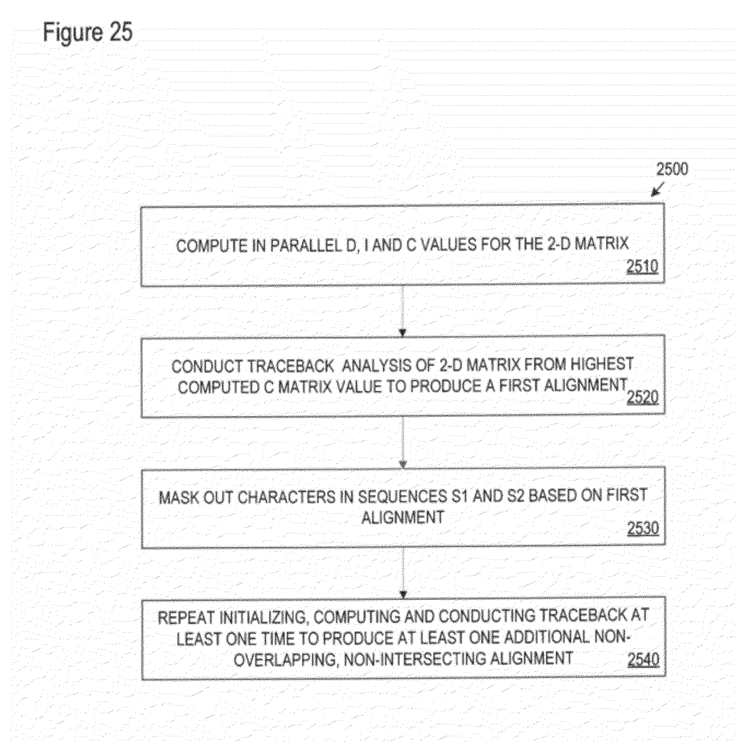

FIG. 25 is a flow chart illustrating a second exemplary second method of aligning sequences according to the SWAMP+ algorithm.

At process block 2510, deletion values (D values), insertion values (I values), and match values (C values) are computed in parallel for a 2-D matrix stored in a parallel memory of the computing system, respective of the columns in the 2-D matrix storing characters corresponding to an anti-diagonal of a Smith-Water (S-W) matrix formed from sequences S1 and S2, respective of the sequences S1 and S2 representing information sequences comprising strings of at least two characters. The anti-diagonals can be computed in parallel, one anti-diagonal at a time in a sequential manner. Computation of the D, I and C values can be based in part on D, I and C values previously computed.

At process block 2520, a traceback of the 2-D matrix is conducted, starting from the highest computed C value, to produce a first alignment between characters in the sequences S1 and S2. The traceback can comprise marking characters in the S1 and S2 sequences for masking so that the marked characters are excluded from subsequent alignments.

At process block 2530, characters in the S1 and S2 sequences are masked out based on the first alignment. The characters in the S1 and S2 sequences can be reset to exclude characters so that they are not included in subsequent alignments.

At process block 2540, the initializing, the computing and the conducting a traceback are repeated at least one time, to produce at least one additional alignment between the sequences S1 and S2 that does not overlap or intersect with the first alignment. The characters in the S1 and S2 sequences included in the additional alignments can be masked for exclusion from subsequent alignments.

In some embodiments, the method 2500 can further comprise initializing the parallel memory. The initialization can comprise shifting in parallel, data from a copy of the S1 or S2 sequence stored in the parallel memory to a column of the parallel memory so that the column stores an anti-diagonal of the S-W matrix. The initialization can further comprise performing the shifting for one or more columns of the 2-D matrix, the contents of the copy of the S1 or S2 sequence stored in the parallel memory being shifted between shiftings of the copy of the S1 or S2 sequence into columns of the 2-D matrix.

### Section 16

### Exemplary Method of Aligning Sequences with Parallel Initialization of a Parallel Memory

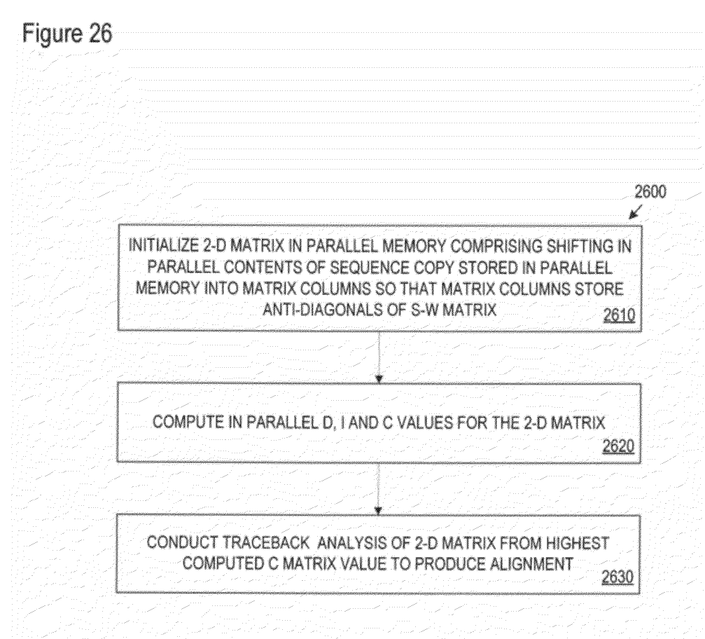

FIG. 26 is a flow chart illustrating an exemplary method 2600 of aligning sequences according with parallel initialization of a parallel memory. At a process block 2610, a 2-D matrix is initialized in parallel memory wherein respective of the columns in the 2-D matrix store characters corresponding to an anti-diagonal of a Smith-Waterman (S-W) matrix formed from sequences S1 and S2 representing information sequences comprising a string of at least two characters. The initializing comprises shifting, in parallel, data from a copy of the S1 or S2 sequence stored in the parallel memory to columns of the 2-D matrix such that the columns store anti-diagonals of the S-W matrix. The contents of the copy of the S1 or S2 sequence being are shifted between shiftings of the copy of the S1 or S2 sequence into the columns of the 2-D matrix.

In some embodiments, upon completion of the initializing, the 2-D matrix stores m+n+1 anti-diagonals of the S-W matrix, wherein m and n are the number of characters in the S1 and S2 sequences, respectively, and the anti-diagonals are arranged in the 2-D matrix in an order that the anti-diagonals are arranged in the S-W matrix, from the upper left of the S-W matrix to the lower right of the 2-D matrix.

After initialization of the 2-D matrix, deletion values (D values), insertion values (I values), and match values (C values) for the 2-D matrix are computed in parallel and a traceback of the 2-D matrix is conducted starting from the highest computed C value, to produce an alignment between characters in the sequences S1 and S2.

### Storing in Computer-Readable Media

Any of the storing actions described herein can be implemented by storing in one or more computer-readable media (e.g., computer-readable storage media or other tangible media).

Any of the things described as stored can be stored in one or more computer-readable media (e.g., computer-readable storage media or other tangible media).

### Methods in Computer-Readable Storage Media and Devices

Any of the disclosed methods can be implemented as computer-executable instructions or a computer program product. Such instructions can cause a computer to perform any of the disclosed methods. The computer-executable instructions or computer program products as well as any data created and used during implementation of the disclosed embodiments can be stored on one or more computer-readable storage media (e.g., non-transitory computer-readable storage media, such as one or more optical media discs (such as DVDs or CDs), volatile memory components (such as DRAM or SRAM), or nonvolatile memory components (such as flash memory or hard drives)) and executed on a computer (e.g., any commercially available computer, including smart phones or other computing devices that include computing hardware). Computer-readable storage media does not include propagated signals. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are known in the art are omitted. For example, it is to be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, and infrared communications), electronic communications, or other such communication means.

Any of the methods described herein can be implemented by computer-executable instructions stored in one or more computer-readable storage devices (e.g., hard disk drives, floppy disk drives, memory integrated circuits, memory modules, solid state drives and other devices comprising computer-readable storage media). Such instructions can cause a computer to perform the method.

### ALTERNATIVES

The disclosed methods, apparatuses and systems should not be construed as limiting in any way. Instead, the present disclosure is directed toward all novel and nonobvious features and aspects of the various disclosed embodiments, alone and in various combinations and subcombinations with one another. The disclosed methods, apparatuses, and systems are not limited to any specific aspect or feature or combination thereof, nor do the disclosed embodiments require that any one or more specific advantages be present or problems be solved.

Theories of operation, scientific principles or other theoretical descriptions presented herein in reference to the apparatuses or methods of this disclosure have been provided for the purposes of better understanding and are not intended to be limiting in scope. The technologies from any section above can be combined with the technologies described in any one or more of the other sections. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the following claims. I therefore claim all that comes within the scope and spirit of these claims.

I claim:

1. A method, implemented at least in part by a computing system, the method comprising:
computing, in parallel, deletion values (D values), insertion values (I values), and match values (C values) for a 2-D matrix stored in a parallel memory of the computing system, respective of the columns in the 2-D matrix storing characters corresponding to an anti-diagonal of a Smith-Waterman (S-W) matrix formed from sequences S1 and S2, respective of the sequences S1 and S2 representing information sequences comprising strings of at least two characters;
conducting a traceback of the 2-D matrix starting from a highest computed C value, to produce a first alignment between characters in the sequences S1 and S2;
masking out one or more characters in the sequences S1 and S2 based on the first alignment; and
repeating the computing and the conducting a traceback at least one time, to produce at least one additional alignment between the sequences S1 and S2, the first alignment and the at least one additional alignment being non-overlapping, non-intersecting alignments.

2. The method of claim 1, further comprising initializing the parallel memory with the 2-D matrix, the initializing comprising shifting, in parallel, data from a copy of the S2 sequence stored in the parallel memory to a column of the 2-D matrix such that the column stores an anti-diagonal of the S-W matrix.

3. The method of claim 2, wherein the initializing further comprises performing the shifting for one or more columns of the 2-D matrix, the contents of the copy of the S2 sequence stored in the parallel memory being shifted between shiftings of the copy of the S2 sequence into columns of the 2-D matrix.

4. The method of claim 1, wherein the masking out one or more characters comprises resetting all characters in the S1 and S2 sequences included in the first alignment to one or more excluded characters.

5. The method of claim 4, wherein the one or more excluded characters are “Z”, “O” or both.

6. The method of claim 1, further comprising masking out the one or more characters of the sequences S1 and S2 included in additional alignments to one or more excluded characters prior to repeating the computing and the conducting a traceback.

7. The method of claim 1, wherein the conducting a traceback comprises marking characters of the sequences S1 and S2 as characters to be masked.

8. The method of claim 1, wherein the at least one additional alignment comprises k or fewer alignments, wherein k is a subsequent alignment count, a highest computed C value in respective of the at least one alignments being not less than the highest computed C value from the first alignment multiplied by a maximum degradation factor.

9. The method of claim 1, further comprising, for respective of one or more alignments of the first alignment and the at least one additional alignments:
computing, in parallel the D, I and C values for the 2-D matrix, wherein the 2-D matrix has been reinitialized such that respective of the columns of the 2-D matrix store characters corresponding to an anti-diagonal of the Smith-Waterman (S-W) matrix, but with the characters of the sequences S1 and S2 associated with the respective alignment reset to one or more excluded characters;
conducting a traceback of the 2-D matrix starting from a highest computed C value, to produce a first subsequent alignment between characters in the sequences S1 and S2;
masking out the characters in the S2 sequence based on the first subsequent alignment; and
repeating the computing and the conducting a traceback at least one time to produce at least one additional subsequent alignment between sequences S1 and S2, the first subsequent alignment and the at least one additional subsequent alignment being non-overlapping, non-intersecting alignments.

10. The method of claim 1, further comprising masking out the characters of the sequences S1 and S2 included in additional subsequent alignments to one or more excluded characters prior to repeating the computing and the conducting a traceback.

11. The method of claim 1, wherein the computing in parallel is carried out simultaneously in a plurality of processing elements (PEs), respective of the PEs corresponding to one row in the 2-D matrix.

12. The method of claim 11, wherein the PEs are components of a Single Instruction, Multiple Data (SIMD) computing system or an emulation thereof comprising an associative search function, a maximum/minimum search function and a responder selection/detection function, and a PE interconnect network.

13. The method of claim 1, wherein the D values, the I values, and the C values for the 2-D matrix are calculated using Equations 1-4.

14. The method of claim 1, wherein the computing in parallel is carried out simultaneously in a plurality of separate processing elements (PEs), respective of the PEs corresponding to one row in the 2-D matrix.

15. The method of claim 1, wherein the computing, in parallel, the D, I and C values comprises computing, in parallel, the D, I and C values for a column of the 2-D matrix at least in part on the D, I and C values previously computed in parallel for one or more other columns of the 2-D matrix, the columns of the 2-D matrix being processed sequentially.

16. The method of claim 1, further comprising storing a result of at least one of the first alignment and the at least one additional alignment on one or more computer-readable media.

17. The method of claim 1, further comprising outputting a result of at least one of the first alignment and the at least one additional alignment at an output device of the computing system.

18. One or more computer-readable storage media storing computer-executable instructions for causing a computer system to perform the method of claim 1.

19. A method, implemented at least in part by a computing system, the method comprising:
initializing in a parallel memory of the computing system a 2-D matrix wherein respective of the columns in the 2-D matrix store characters corresponding to an anti-diagonal of a Smith-Waterman (S-W) matrix formed from sequences S1 and S2 representing information sequences comprising a string of at least two characters, the initializing comprising shifting, in parallel, data from a copy of the S2 sequence stored in the parallel memory to columns of the 2-D matrix such that the columns store anti-diagonals of the S-W matrix, the contents of the copy of the S2 sequence being shifted between shiftings of the copy of the S2 sequence into the columns of the 2-D matrix;
computing, in parallel, deletion values (D values), insertion values (I values), and match values (C values) for the 2-D matrix; and
conducting a traceback analysis of the 2-D matrix starting from a highest computed C value, to produce an alignment between characters in the sequences S1 and S2.

20. The method of claim 19, wherein, upon completion of the initializing, the 2-D matrix stores m+n+1 anti-diagonals of the S-W matrix, wherein m and n are a number of characters in the S1 and S2 sequences, respectively, and the anti-diagonals are arranged in the 2-D matrix in an order that the anti-diagonals are arranged in the S-W matrix, from the upper left of the S-W matrix to the lower right of the 2-D matrix.

21. A computer system comprising:
a plurality of processing elements (PEs) respective of the plurality of processing elements having local memory, the local memories collectively defining a parallel memory;
a PE interconnection network connecting the plurality of processing elements;
one or more computer-readable storage media storing instruction for causing the computer system to execute a method, the method comprising:
initializing in the parallel memory a 2-D matrix wherein respective of the columns in the 2-D matrix stores characters corresponding to an anti-diagonal of a Smith-Waterman (S-W) matrix formed from sequences S1 and S2, respective of the sequences S1 and S2 representing information sequences comprising strings of at least two characters;
using the plurality of PEs, computing, in parallel, deletion values (D values), insertion values (I values), and match values (C values) for the 2-D matrix;
conducting a traceback of the 2-D matrix from a highest computed C value, to produce a first alignment between characters in the sequences S1 and S2;
masking out characters in the sequences S1 and S2 based on the first alignment;
repeating the initializing, the computing and the conducting traceback at least one time, to produce at least one additional alignment between sequences S1 and S2 that does not overlap or intersect with the first alignment; and
masking out the characters of the sequences S1 and S2 included in additional subsequent alignments to one or more excluded characters prior to repeating the computing and the conducting a traceback.

22. A method, implemented at least in part by a computing system, the method comprising:
computing, in parallel, deletion values (D values), insertion values (I values) and match values (C values) for a plurality of blocks of a 2-D matrix storing characters corresponding to portions of anti-diagonal of a Smith-Waterman (S-W) matrix formed from sequences S1 and S2, respective of the sequences S1 and S2 representing information sequences comprising strings of at least two characters;
wherein the blocks are arranged in a 2-D block matrix;
wherein the computing in parallel is performed by one or more processing cores of a computing system, the one or more processing cores arranged logically adjacent to one another in a left-to-right manner;
wherein respective of the one or more processing cores are configured to compute in parallel the D, I and C values for one block at a time, and, upon completing the computing for one of the blocks, passing the computed D, I and C values for an upper-most column of the block processed by the respective core to the processor to the respective processor's logical right for use in processing the lowest column in the block stored in the processor to the respective processor's logical right, and using the computed values for the lowest row of the respective core for processing its upper row when processing the next block;
wherein respective of the blocks successively process blocks belonging to a column of the 2-D matrix in a top-to-bottom manner; and
wherein the blocks are processed one anti-diagonal of the 2-D block matrix at a time in order from the upper left to the lower right of the 2-D block matrix, the blocks belonging to an anti-diagonal of the 2-D block matrix being processed simultaneously by the one or more processing cores; and
conducting a traceback analysis of the 2-D matrix starting from a highest computed C value, to produce a first alignment between characters in the sequences S1 and S2.

23. A computing system comprising:
a means for computing, in parallel, deletion values (D values), insertion values (I values), and match values (C values) for a 2-D matrix stored in a parallel memory of the computing system, respective of the columns in the 2-D matrix storing characters corresponding to an anti-diagonal of a Smith-Waterman (S-W) matrix formed from sequences S1 and S2, respective of the sequences S1 and S2 representing information sequences comprising strings of at least two characters;
a means for conducting a traceback of the 2-D matrix starting from a highest computed C value, to produce a first alignment between characters in the sequences S1 and S2;
a means for masking out one or more characters in the sequences S1 and S2 based on the first alignment; and
a means for repeating the computing and the conducting a traceback at least one time, to produce at least one additional alignment between the sequences S1 and S2, the first alignment and the at least one additional alignment being non-overlapping, non-intersecting alignments.

24. A method, implemented at least in part by a computing system, the method comprising:
initializing in a parallel memory of the computing system a 2-D matrix wherein respective of the columns in the 2-D matrix store characters corresponding to an anti-diagonal of a Smith-Waterman (S-W) matrix formed from sequences S1 and S2 representing information sequences comprising a string of at least two characters, the initializing comprising shifting, in parallel, data from a copy of the S2 sequence stored in the parallel memory to columns of the 2-D matrix such that the columns store anti-diagonals of the S-W matrix, the contents of the copy of the S2 sequence being shifted between shiftings of the copy of the S2 sequence into the columns of the 2-D matrix, wherein, upon completion of the initializing, the 2-D matrix stores m+n+1 anti-diagonals of the S-W matrix, wherein m and n are a number of characters in the S1 and S2 sequences, respectively, and the anti-diagonals are arranged in the 2-D matrix in an order that the anti-diagonals are arranged in the S-W matrix, from the upper left of the S-W matrix to the lower right of the 2-D matrix;
computing, in parallel, deletion values (D values), insertion values (I values), and match values (C values) for the 2-D matrix;
conducting a traceback of the 2-D matrix starting from a highest computed C value, to produce a first alignment between characters in the sequences S1 and S2;
masking out one or more characters in the sequences S1 and S2 based on the first alignment;
repeating the computing and the conducting a traceback at least one time, to produce at least one additional alignment between the sequences S1 and S2, the first alignment and the at least one additional alignment being non-overlapping, non-intersecting alignments; and
masking out the one or more characters of the sequences S1 and S2 included in additional alignments to one or more excluded characters prior to repeating the computing and the conducting a traceback.


SEQUENCE LISTING (2 sequences)

SEQ ID NO: 1 - DNA, 16 bp, Artificial Sequence
  Synthetic hypotehtical sequence
agctacgtacactacc

SEQ ID NO: 2 - DNA, 15 bp, Artificial Sequence
  Synthetic hypotehtical sequence
agctatcgtactagc